(19) United States
(12) Patent Application Publication
(10) Pub. No.: US 2025/0268784 A1
(43) Pub. Date: Aug. 28, 2025

(54) CAPACITIVE CELL BASED DEFORMATION SENSING STRUCTURE

(71) Applicant: ZOLL Medical Corporation, Chelmsford, MA (US)

(72) Inventors: Evan Lane, Stoneham, MA (US); Paolo Giacometti, North Grafton, MA (US)

(73) Assignee: ZOLL Medical Corporation, Chelmsford, MA (US)

(21) Appl. No.: 18/857,884

(22) PCT Filed: Apr. 21, 2023
(86) PCT No.: PCT/US2023/019346

§ 371 Date: Oct. 18, 2024

Related U.S. Application Data
(60) Provisional application No. 63/363,321, filed on Apr. 21, 2022.

(51) Int. Cl. A61H 31/00; A61B 5/00; A61B 5/107; A61B 17/132; G01B 7/28; G01D 5/24

(52) U.S. Cl. CPC A61H 31/005; A61B 5/1077; A61B 5/6823; A61B 5/6832; A61B 5/7203; A61B 5/7267; G01B 7/28; G01D 5/24; A61B 17/132; A61B 2560/0223; A61B 2562/164; A61H 2201/107; A61H 2230/06; A61H 2230/42

(57) ABSTRACT

Apparatuses, systems and methods are provided for providing assistance or corrective feedback relating to a medical treatment provided to a patient. A flexible structure, including capacitive cells, may be configured to be applied to the patient's body. A computerized system, coupled with the flexible structure, may be configured to receive signals associated with capacitance values corresponding to at least a portion of the capacitive cells. The computerized system may be further configured to, based at least in part on the received signals, estimate a change over a period of time during the medical treatment in a three dimensional shape of the flexible structure or track the three dimensional shape of the flexible structure. The computerized system may be further configured to determine data or provide output for use in providing the assistance or corrective feedback relating to the medical treatment.

### BACKGROUND

In applications from entertainment, such as movies, virtual reality and animation, to biomechanics, such as in modeling human movement, techniques have been used that include detection of body movement and shape changes (e.g., curling of the fingers, bending of the arm, flexing and bulging of a muscle). Various existing techniques have been used, but have various limitations and disadvantages.

Camera based techniques have been used, including for motion capture, but have disadvantages such as, for example, requiring line of sight to the modeled body area and generally requiring substantial set up and infrastructure (e.g., a studio or lab setting). As an alternative to camera based techniques, various existing types of sensing based techniques, which may include body worn or body applied sensors, have been used, including to detect skeletal movements. Existing techniques and applications have various limitations, however, including, for example, with regard to uses, practicality and accuracy.

### SUMMARY

One example of a system for use in providing cardiopulmonary resuscitation (CPR) chest compressions to a patient comprises: a flexible structure comprising a plurality of capacitive cells, the flexible structure configured to be positioned on at least a portion of a torso of the patient during the CPR; and at least one computerized system, comprising at least one memory and at least one processor, communicatively coupled with the flexible structure and configured to: receive signals associated with a plurality of capacitance values corresponding to at least a portion of the plurality of capacitive cells; based at least in part on the received signals, estimate a change in a three dimensional shape of the flexible structure over a period of time during the providing of the CPR chest compressions to the patient; and based at least in part on the estimated change, provide output, comprising at least one of: visual output and audio output, for use in providing corrective feedback to the care provider relating to the CPR chest compressions, the output relating to at least one parameter associated with the CPR chest compressions.

In some examples, the period of time occurs during a CPR chest compression provided to the patient. In some examples, the plurality of capacitive cells are located on or in the flexible structure in accordance with a repeating polygon horizontal pattern. In some examples, the repeating polygon horizontal pattern comprises a square pattern. In some examples, some of the plurality of capacitive cells are located at a different level along a thickness of the flexible structure than other of the plurality of capacitive cells. In some examples, the at least one computerized system is configured to estimate the change over time in the three dimensional shape of the flexible structure, wherein the change is caused at least in part by a deformation of the flexible structure.

In some examples, the at least one computerized system is configured to estimate the change over time in the three dimensional shape of the flexible structure, wherein the change is caused at least in part by a deformation of the flexible structure, wherein the deformation is caused at least in part by an application of a force to the flexible structure. In some examples, the flexible structure is configured to be at least one of: wrapped around the at least a portion of the torso of the patient, stretched around the at least a portion of the torso of the patient, adhered to a chest of the patient, and adhered to a chest of the patient using an adhesive. In some examples, wherein the at least one computerized system is configured to, for at least some of the at least a portion of the plurality of capacitive cells, determine capacitance values corresponding to individual capacitive cells based at least in part on capacitance values corresponding to groups of capacitive cells.

In some examples, the plurality of capacitive cells are spaced apart throughout the flexible structure. In some examples, the at least one computerized system is configured to, based at least in part on the change, estimate a three dimensional shape of the flexible structure following the change. In some examples, the flexible structure is at least one of: a body worn structure, configured to be positioned over at least a portion of a chest of the patient, configured to be positioned so as to extend partially around the torso of the patient, and configured to be positioned so as to extend completely around the torso of the patient.

In some examples, each of the plurality of capacitive cells comprises a plurality of layers, the plurality of layers comprising: a first conductive layer; a dielectric layer disposed over the first conductive layer; and a second conductive layer disposed over the dielectric layer. In some examples, each of the plurality of capacitive cells is configured such that a capacitance of the capacitive cell is affected by deformation of the capacitive cell relative to an undeformed state of the capacitive cell. In some examples, each of the plurality of capacitive cells is configured such that the capacitance of the capacitive cell is affected by surface area change and compression, the surface area change and the compression being associated with at least a portion of the capacitive cell and being caused by the deformation of the capacitive cell.

In some examples, each of the plurality of capacitance values is determined at least in part based on a capacitive charge time. In some examples, at least one computational model is used in estimating the three dimensional shape. In some examples, the at least one computational model comprises at least one machine learning model. In some examples, the machine learning model utilizes training data comprising a set of data corresponding to each of a plurality of particular times, wherein a three dimensional shape of the flexible structure is different for each of the plurality of particular times, the set of data comprising: capacitance values corresponding to each of at least a portion of the plurality of capacitive cells at the particular time; and data corresponding to an actual three dimensional shape of the flexible structure at the particular time.

In some examples, the training data comprises data relating to the flexible structure in a plurality of deformed states. In some examples, the at least one computational model utilizes at least one of: geometric modeling and polygon modeling. In some examples, the output comprises at least one of chest compression depth, chest compression force, and chest compression angle. In some examples, the at least one computerized system comprises at least one output device configured to provide the output. In some examples, the output comprises a visual presentation on a display of the output device. In some examples, the at least one computerized system is configured to: obtain calibration data comprising capacitance values corresponding to the at least a portion of the plurality of capacitive cells of the flexible structure prior to the change; and utilize the calibration data in estimating the change.

Some examples provide a computer-implemented method for providing assistance to a care provider with a medical treatment provided to a patient, the method comprising: based at least in part on signals obtained from capacitive cells of a structure positioned on a portion of the patient in association with the medical treatment, determining a first set of capacitance values corresponding to each of at least a portion of the capacitive cells at a first time; comparing the first set of capacitance values with a second set of capacitance values corresponding to each of the at least a portion of the capacitive cells at a second time, the second time being previous to the first time; using at least one computational model, based at least in part on the comparison, estimating a change in a three dimensional shape of the structure over time; and based at least in part on the estimated change, determining, and storing in at least one memory, data for use in providing the assistance with the medical treatment.

In some examples, determining the first set of capacitance values, wherein the structure is a flexible structure. In some examples, determining the first set of capacitance values, wherein the capacitive cells are located on or in the structure in accordance with a repeating polygon pattern, wherein the capacitive cells are located at vertices of the repeating polygon pattern. In some examples, estimating the change in the three dimensional shape, wherein the change in the three dimensional shape is caused at least in part by deformation of the structure. In some examples, the method comprises estimating the change in the three dimensional shape, wherein the change in the three dimensional shape is caused at least in part by deformation of the structure, wherein the deformation is caused at least in part by an application of a force to the structure.

In some examples, estimating the change comprises estimating the change in the three dimensional shape of the structure from the second time to the first time. In some examples, estimating a three dimensional shape of the structure at the first time based at least in part on: a three dimensional shape of the structure at the second time; and the estimated change. In some examples, estimating a three dimensional shape of the structure at the first time comprises using polygon modeling. In some examples, the method comprises determining capacitance values for particular capacitive cells based at least in part on capacitance values associated with groups of capacitive cells. In some examples, the method comprises determining the first set of capacitance values, wherein the capacitive cells are spaced apart throughout the structure. In some examples, the method comprises determining the first set of capacitance values, wherein capacitance values are affected by capacitive cell deformation.

In some examples, the method comprises determining the first set of capacitance values, wherein capacitance values are affected by capacitive cell surface area change. In some examples, the method comprises determining the capacitance values corresponding to each of the at least a portion of the capacitive cells based at least in part on capacitive charge times. In some examples, using the signals obtained from the capacitive cells of the mesh structure, wherein the structure is positioned at least one of: over at least a portion of a chest of the patient during CPR provided to the patient, so as to extend partially around a torso of the patient, and so as to extend completely around a torso of the patient. In some examples, the method comprises using the at least one computational model in estimating the change, wherein the at least one computational model comprises at least one machine learning model. In some examples, the method comprises using the at least one computational model in estimating the change, wherein the at least one computational model utilizes polygon modeling.

In some examples, the method comprises based at least in part on the determined data, providing a presentation on at least one output device, the presentation comprising at least one of: a visual presentation and an audio presentation. In some examples, the method comprises providing the presentation, wherein the visual presentation comprises an animated visual presentation. In some examples, the method comprises providing the presentation, wherein the animated visual presentation includes a representation of a changing estimated three dimensional shape of the structure over time. In some examples, the method comprises providing the presentation, wherein the presentation is used in providing instructions for a care provider relating to the medical treatment provided to the patient at least in part by the care provider.

In some examples, the method comprises providing the presentation, wherein the presentation is used in providing instructions for a care provider relating to the medical treatment provided to the patient at least in part by the care provider, and wherein the presentation provides a visualization tool for use by the care provider in connection with one or more aspects of the medical treatment provided to the patient. In some examples, the presentation related to the medical treatment, wherein the medical treatment comprises administering of CPR chest compressions. In some examples, the presentation is used in providing instructions relating to administering of the CPR chest compressions, wherein the instructions relate to at least one of: compression rate, compression depth, compression angle, compression force, and compression location on the patient's chest.

In some examples, the data is used in determining at least one of: an anteroposterior (AP) diameter of the patient's chest, a transverse diameter of the patient's chest, a cross-sectional area of the patient's chest, and compression related remodeling of the patient's chest. In some examples, the presentation is used in providing the instructions relating to the medical treatment, wherein the medical treatment comprises use of ultrasound or administering of defibrillation shocks. In some examples, the method comprises determining a first set of capacitance values, wherein the structure is a flexible structure applied to at least one of: at least a portion of a neck of the patient, at least a portion of an arm of the patient, and at least a portion of a leg of the patient. In some examples, the method comprises determining a first set of capacitance values, wherein the structure is a flexible structure applied to at least a portion of a chest of the patient, and wherein the data is for use in providing instructions relating to providing of CPR chest compressions to the patient.

In some examples, the method comprises determining the data, wherein the data is for use in providing instructions relating to positioning of an ultrasound probe. In some examples, the method comprises determining the data, wherein the data is for use in determining a heart rate of the patient. In some examples, the method comprises determining the data, wherein the data is for use in detecting touch of the patient by a care provider during the medical treatment.

Some examples provide an apparatus, applicable to a portion of a surface of a patient's body, for use in providing assistance to a care provider with a medical treatment provided to the patient, the apparatus comprising: a flexible structure configured to be applied to the portion of the surface of the patient's body; and a plurality of capacitive cells, disposed on, or forming part of, the flexible structure, each of the plurality of capacitive cells comprising a plurality of layers, the plurality of layers comprising: a first conductive layer; a dielectric layer disposed over the first conductive layer; and a second conductive layer disposed over the dielectric layer; wherein the plurality of capacitive cells is configured for use in sending signals to be received by at least one computerized system for allowing the at least one computerized system to: based at least in part on the received signals, estimate a change in a three dimensional shape of the flexible structure over a period of time during the medical treatment provided to the patient; and based at least in part on the estimated change, determine, and store in the at least one memory, data for use in providing the assistance with the medical treatment.

In some examples, the plurality of capacitive cells is configured for use in sending the signals to be received by the at least one computerized system for allowing the at least one computerized system to estimate the change in the three dimensional shape, wherein the change is caused at least in part by a deformation of the flexible structure. In some examples, the plurality of capacitive cells is configured for use in sending the signals to be received by the at least one computerized system for allowing the at least one computerized system to estimate the change in the three dimensional shape, wherein the change is caused at least in part by a deformation of the flexible structure, wherein the deformation of the flexible structure is caused at least in part by an application of a force to the flexible structure.

In some examples, the flexible structure is at least one of: configured to be worn on a chest of the patient, configured to be worn so as to extend partially around a torso of the patient, and configured to be worn so as to extend completely around a torso of the patient. In some examples, each of the first conductive layer, the dielectric layer and the second conductive layer comprises at least one of: an elastomer, silicone, silicone rubber, and a conductive material. In some examples, each of the first conductive layer and the second conductive layer comprises silicone and graphite. In some examples, each of the first conductive layer and the second conductive layer comprises silicone and carbon. In some examples, the flexible structure comprises a first protective layer and a second protective layer, wherein the first conductive layer is disposed over the first protective layer and wherein the second protective layer is disposed over the second conductive layer.

In some examples, each of the first protective layer and the second protective layer is a capacitive cell exterior layer. In some examples, each of the first protective layer and the second protective layer is dielectric. In some examples, each of the first protective layer and the second protective layer comprises silicone. In some examples, each of the first protective layer and the second protective layer comprises silicone rubber. In some examples, each of the first protective layer and the second protective layer is configured to have a greater thickness than any of the first conductive layer, the dielectric layer and the second conductive layer. In some examples, at least one of the first protective layer and the second protective layer is configured to reduce touch-based capacitance changes. In some examples, the plurality of capacitive cells forms at least one of: a geometric pattern, and a polygon based pattern. In some examples, each of the capacitive cells has a thickness of between 0.3 and 0.7 millimeters.

In some examples, each of the first conductive layer and the second conductive layer has a thickness of between 30 and 70 micrometers. In some examples, each of the first protective layer and the second protective layer has a thickness of between 150 and 200 micrometers. In some examples, the dielectric layer have a thickness of between 60 and 120 micrometers. In some examples, the plurality of capacitive cells is configured for use in sending signals to be received by at least one computerized system for allowing the at least one computerized system to: obtain calibration data comprising capacitance values corresponding to the at least a portion of the capacitive cells of the flexible structure prior to the change; and utilize the calibration data in estimating the change.

In some examples, the calibration data is used in data noise rejection. In some examples, the plurality of capacitive cells is configured for use in sending signals to be received by at least one computerized system for allowing the at least one computerized system to: based at least in part on the data, provide output, comprising at least one of: visual and audio output, for providing the assistance to a care provider. In some examples, the plurality of capacitive cells is configured for use in sending signals to be received by at least one computerized system for allowing the at least one computerized system to: based at least in part on the data, provide output, comprising at least one of: visual and audio output, for providing the assistance to a care provider, wherein providing the assistance comprises providing instructions to the care provider relating to the medical treatment provided to the patient.

Some examples provide a system for use in providing assistance to a care provider with a medical treatment provided to a patient, the system comprising: a flexible structure comprising a plurality of capacitive cells, the flexible structure configured to be positioned on a surface of a body of the patient, or at least a portion of a torso of the patient, a during the medical treatment; and at least one computerized system, comprising at least one memory and at least one processor, communicatively coupled with the flexible structure and configured to: for each of a set of different deformed shapes of the flexible structure occurring during the medical treatment, receive signals associated with a plurality of capacitance values corresponding to at least a portion of the plurality of capacitive cells; based at least in part on the received signals, track a three dimensional shape of the flexible structure; and based at least in part on the tracked three dimensional shape of the flexible structure, provide output, comprising at least one of: visual output and audio output, for use in providing the assistance to the care provider with the medical treatment.

In some examples, tracking the three dimensional shape of the flexible structure comprises estimating each of the set of deformed shapes of the flexible structure. In some examples, estimating each of the set of deformed shapes comprises estimating a shape deformation for each of the set of deformed shapes. In some examples, the set of deformed shapes occur at a plurality of successive times during the period of time. In some examples, the medical treatment comprises CPR chest compressions. In some examples, the assistance comprises instructions relating to medical treatment provided to the patient. In some examples, the assistance comprises corrective feedback relating to the medical treatment provided to the patient. In some examples, the at least one computerized system is configured to track the three dimensional shape of the flexible structure over a period of time during the medical treatment.

In some examples, tracking the three dimensional shape of the flexible structure over the period of time comprises estimating the three dimensional shape of the flexible structure at each of a plurality of successive times during the period of time. In some examples, the period of time comprises at least one of: a compression phase of a CPR chest compression provided to the patient, and a release phase of a CPR chest compression provided to the patient. In some examples, the period of time comprises a period of time during which a plurality of CPR chest compressions are provided to the patient. In some examples, each of the plurality of capacitive cells comprises a plurality of layers, the plurality of layers comprising: a first conductive layer; a dielectric layer disposed over the first conductive layer; and a second conductive layer disposed over the dielectric layer.

In some examples, each of the plurality of capacitive cells is configured such that a capacitance of the capacitive cell is affected by deformation of the capacitive cell relative to an undeformed state of the capacitive cell. In some examples, each of the plurality of capacitive cells is configured such that the capacitance of the capacitive cell is affected by surface area change and compression, the surface area change and the compression being associated with at least a portion of the capacitive cell and being caused by the deformation of the capacitive cell. In some examples, each of the plurality of capacitance values is determined at least in part based on a capacitive charge time. In some examples, at least one computational model is used in tracking the three dimensional shape. In some examples, the at least one computational model comprises at least one machine learning model. In some examples, the output comprises at least one of chest compression depth, chest compression force, and chest compression angle. In some examples, the at least one computerized system comprises at least one output device configured to provide the output. In some examples, the output comprises a visual presentation on a display of the output device.

In some examples, the at least one computerized system is configured to: based at least in part on the tracked three dimensional shape of the flexible structure, track a three dimensional shape of at least a portion of the surface of the body of the patient. In some examples, the at least one computerized system is configured to: based at least in part on the tracked three dimensional shape of the at least a portion of the surface of the body of the patient, provide the output. In some examples, signals received from a first one or more of the plurality of capacitive cells are used in improving the accuracy of measurements based on signals received from a second one or more of the plurality of capacitive cells. In some examples, each of the plurality of capacitive cells comprises two conductive portions, and wherein a horizontal layer of the flexible structure comprises each of the two conductive portions.

In some examples, the output relates to providing of ACD chest compressions. In some examples, the output relates to providing of ACD chest compressions comprising use of an ITD. In some examples, the output relates to the providing of chest compressions using at least one of: a band based chest compression system, and a piston based chest compression system. In some examples, the output relates to a ramp up chest compression procedure. In some examples, the at least one computerized system is configured to: based at least in part on signals received from the one or more accelerometers, track the three dimensional shape of the at least a portion of the surface of the body of the patient. In some examples, the at least one computerized system is configured to: based at least in part on the tracked three dimensional shape of the flexible structure, determine that the patient is or may be in PEA.

In some examples, the at least one computerized system is configured to: based at least in part on the tracked three dimensional shape of the flexible structure, determine that the patient is or may be in ROSC. In some examples, the at least one computerized system is configured to track the three dimensional shape of the flexible structure such that movement of the entire flexible structure does not affect tracking of the three dimensional shape of the flexible structure. In some examples, the at least one computerized system is configured to track the three dimensional shape of the at least a portion of the body of the patient such that movement of the entire flexible structure does not affect tracking of the three dimensional shape of the at least a portion of the body of the patient. In some examples, the at least one computerized system is configured to: based at least in part on the tracked three dimensional shape of the flexible structure, determine a pulse rate of the patient. In some examples, the at least one computerized system is configured to: based at least in part on the tracked three dimensional shape of the flexible structure, determine a pulse waveform of the patient.

In some examples, the at least one computerized system is configured to: based at least in part on the tracked three dimensional shape of the flexible structure, determine a ventilation rate of ventilations being delivered to the patient. In some examples, the at least one computerized system is configured to: based at least in part on the tracked three dimensional shape of the flexible structure, determine whether an endotracheal tube that has been connected to the patient is or may be dislodged or disconnected. In some examples, the medical treatment comprises application of a tourniquet to a portion of the body of the patient, and wherein the output relates to the application of the tourniquet.

One example of a system for use in providing assistance to a care provider with a medical treatment provided to a patient comprises: a flexible structure comprising a plurality of capacitive cells, the flexible structure configured to be positioned on a portion of the patient during the medical treatment; and at least one computerized system, comprising at least one memory and at least one processor, communicatively coupled with the flexible structure and configured to: receive signals associated with a set of capacitance values corresponding to at least a portion of the plurality of capacitive cells; based at least in part on the received signals, determine an estimated three dimensional shape of the flexible structure; and based at least in part on the estimated three dimensional shape, provide output for use in providing the assistance to the care provider with the medical treatment.

In some examples, the output comprises at least one of: visual output and audio output. In some examples, the at least one computerized system is configured to: receive the signals associated with the set of capacitance values corresponding to the at least a portion of the plurality of capacitive cells with the flexible structure in a shape corresponding with the estimated three dimensional shape. In some examples, the at least one computerized system is configured to: obtain data specifying an approximated three dimensional shape of the flexible structure, wherein the approximated three dimensional shape is different than the estimated three dimensional shape; obtain data specifying a second set of capacitance values associated with at least a portion of the plurality of capacitive cells, wherein the second set of capacitance values are obtained with the flexible structure in a shape corresponding with the approximated three dimensional shape; and based at least in part on the received signals, the data specifying the approximated three dimensional shape of the flexible structure, and the data specifying the second set of capacitance values, determine the estimated three dimensional shape of the flexible structure.

In some examples, the data specifying the approximated three dimensional shape is obtained based at least in part on three dimensional scanning data obtained from three dimensional scanning of the flexible structure with the flexible structure in the shape corresponding with the approximated three dimensional shape. In some examples, the estimated three dimensional shape is an estimated deformed shape. In some examples, the approximated three dimensional shape is an approximated undeformed shape. In some examples, the approximated three dimensional shape is an approximated deformed shape, wherein the approximated deformed shape is different than the estimated deformed shape. In some examples, determining the estimated three dimensional shape comprises determining an estimated change of shape of the flexible structure from the approximated three dimensional shape to the estimated three dimensional shape.

In some examples, determining the estimated three dimensional shape of the flexible structure comprises computationally applying the determined estimated change of shape to the approximated shape to determine the estimated shape. In some examples, the system comprises at least one motion sensor configured for use in detection of at least one of: rotational and translational movement of the flexible structure in three dimensional space. In some examples, the system comprises at least one accelerometer configured for use in detection of at least one of: rotational and translational movement of the flexible structure in three dimensional space. In some examples, the at least one accelerometer is configured for use in measuring at least one of: rotational and translational movement of the flexible structure in three dimensional space.

In some examples, the accelerometer is at least one of: coupled to the flexible structure, attached to the flexible structure, at least partially embedded within the flexible structure, coupled with the patient, and attached to the patient. In some examples, the medical treatment comprises providing of CPR chest compressions, and wherein the system comprises a defibrillation electrode pad configured for delivery of one or more defibrillation shocks to the patient. In some examples, the accelerometer is at least one of: coupled with the defibrillation electrode pad, attached to the defibrillation electrode pad, and at least partially embedded within the defibrillation electrode pad. In some examples, the medical treatment comprises providing of CPR chest compressions. In some examples, the flexible structure is applied to at least a portion of a chest of the patient, and wherein the least one computerized system is configured to: based at least in part on the estimated three dimensional shape, determine a lateral distance of the chest of the patient and an anterior posterior distance of the chest of the patient.

In some examples, least one computerized system is configured to: based at least in part on a ratio of the anterior posterior distance to the lateral distance, determine whether the chest of the patient is relatively barrel shaped or relatively flat shaped. In some examples, the least one computerized system is configured to: compare the ratio of the anterior posterior distance to the lateral distance to a specified threshold; and determine whether the chest of the patient is relatively barrel shaped or relatively flat shaped based at least in part on the comparison, wherein, if the ratio is at or above the specified threshold, then the patient's chest is determined to be relatively barrel shaped, and if the ratio is below the specified threshold, then the patient's chest is determined to be relatively flat shaped. In some examples, the at least one computerized system comprises at least one output device configured to provide the output. In some examples, the output comprises a visual presentation on a display of the output device.

In some examples, the medical treatment comprises the providing of CPR chest compressions, and wherein the visual presentation includes at least one parameter relating to the providing of the CPR chest compressions. In some examples, the at least one computerized system is configured to: track a three dimensional shape of the flexible structure over a plurality of successive times during a period of time, comprising determining a particular estimated three dimensional shape of the flexible structure at each of the successive times.

One example of a system for use in providing assistance to a care provider with a medical treatment provided to a patient comprises: a flexible structure comprising at least one capacitive cell, the flexible structure configured to be positioned on a surface of a body of a patient during the medical treatment; and at least one computerized system, comprising at least one memory and at least one processor, communicatively coupled with the flexible structure and configured to: receive signals associated with at least one capacitance value corresponding to the at least one capacitive cell; based at least in part on the received signals, estimate a change in a shape of the flexible structure over a period of time during the providing of the medical treatment to the patient; and based at least in part on the estimated change, provide output, comprising at least one of: visual output and audio output, for use in providing corrective feedback to the care provider relating to the medical treatment, the output relating to at least one parameter associated with the medical treatment.

In some examples, estimating the change of shape comprises estimating a displacement in a direction in three-dimensional space. In some examples, the medical treatment comprises the providing of CPR chest compressions to the patient. In some examples, the flexible structure is used in detecting at least one of CPR chest compression depth and CPR chest compression rate. In some examples, the medical treatment comprises the providing of manual or mechanical ventilations to the patient. In some examples, the flexible structure is used in detecting a pulse waveform of the patient.

In some examples, The system 141, the at least computerized system is configured to, based at least in part on the received signals, estimate the change in a shape of the flexible structure over a period of time without capturing artifact movement or displacement of the patient.

### BRIEF DESCRIPTION OF THE DRAWINGS

Various aspects of embodiments of the present disclosure are discussed below with reference to the accompanying figures, which are not intended to be drawn to scale. The figures are included for illustrative purposes and a further understanding of the various aspects and examples. The figures are incorporated in and constitute a part of this specification, but are not intended to limit the scope of the disclosure. In the figures, identical or nearly identical components that are illustrated in various figures may be represented by like numerals. For purposes of clarity, not every component may be labeled in every figure.

FIG. 1A is an illustration of an example emergency care environment including use of a flexible structure during providing of CPR chest compressions to a patient.

FIG. 1B is an illustration of an example emergency care environment including use of a flexible structure and a motion sensor during providing of CPR chest compressions to a patient.

FIG. 1C is an illustration of an example emergency care environment including use of a flexible structure, a defibrillation electrode pad and a motion sensor during providing of CPR chest compressions to a patient.

FIGS. 1D-F illustrate examples of systems including a flexible structure applied to a torso of a patient.

FIG. 2 is an illustration of an example flexible structure applied around a modeled torso, in both an initial shape and a particular deformed shape, such as may exist during providing of CPR chest compressions to a patient.

FIG. 3 is a diagram illustrating an example of use of a computational model in tracking the three dimensional deformed shape of a flexible structure, and uses for results data.

FIG. 4 is a flow diagram illustrating an example method including use of capacitive cell signals from a flexible structure in estimating change in a three dimensional shape of the flexible structure over time, and generating results data.

FIG. 5 is a diagram illustrating an example including use of a machine learning model in tracking a three dimensional shape of a flexible structure, generating results data and presenting associated output.

FIG. 6 is a flow diagram illustrating an example method including use of a computational model in using capacitance values to model an estimated three dimensional shape of a deformed structure.

FIG. 7 is a flow diagram illustrating an example method including use of a machine learning model and training data in estimating a three dimensional shape of a flexible structure.

FIG. 8 is an illustration of an example network of capacitive cells and associated capacitance measurements.

FIG. 9 is a flow diagram illustrating an example method including determination of capacitance values for a network of capacitive cells of a flexible structure.

FIG. 10 is a flow diagram illustrating an example method including use of a machine learning model in determination of an estimated three dimensional shape based on input capacitive cell values.

FIG. 11 is an illustration of an example of determination of displacement of a vertex of a flexible structure, from an undeformed shape to a deformed shape.

FIG. 12 is an illustration of an example of a complete estimated three dimensional shape of a deformed flexible structure including use of a polygon modeling technique.

FIG. 13 is a simplified illustration of example portions of a flexible structure, with and without vertical stacking of capacitive cells.

FIGS. 14-15 are illustrations examples of differently shaped capacitive cells of flexible structures, showing layers thereof.

FIG. 16 is a table illustrating example property changes resulting from increases in the thickness of particular types of capacitive cell layers.

FIG. 17 is an illustration of example capacitive cell shapes and configurations.

FIG. 18 is an illustration of example capacitive cell horizontal orientations within a group of capacitive cells.

FIG. 19 is an illustration of example capacitive cell horizontal arrangement variations of groups of capacitive cells.

FIG. 20 is an illustration of example capacitive cell vertically stacked arrangements and other variations of groups of capacitive cells.

FIG. 21 is an illustration of example capacitive cell groups in an undeformed flexible structure and a deformed flexible structure.

FIGS. 22-23 are illustrations of example types and configurations of flexible structures.

FIG. 24 is block diagram illustrating example presented output, relating to CPR chest compressions, generated based on tracking of change of three dimensional shape of a flexible structure.

FIGS. 25-26 are illustrations relating to displayed CPR chest compression related parameters determined using tracking of change of three dimensional shape of a flexible structure.

FIG. 27 is an illustration relating to example modeled uncompressed and compressed shapes of the torso of a pediatric patient during front and back applied CPR chest compressions.

FIG. 28 is an illustration relating to example modeled uncompressed, compressed and lifted shapes of the torso of a patient during applied CPR chest compressions.

FIG. 29 is an illustration relating to example modeled CPR chest compression depths and angles.

FIG. 30 is an illustration and associated plots relating to detection of chest remodeling, resulting from CPR chest compressions, using techniques according to some embodiments of the present disclosure.

FIG. 31 is an illustration relating to examples of use of modeling of CPR chest compression parameters for providing corrective feedback for optimization of the providing of the CPR chest compressions.

FIG. 32 is an illustration relating to use an example flexible neck applied flexible structure that can be used in detection of pulse using techniques according to some embodiments of the present disclosure.

FIG. 33-34 are illustrations relating to use of techniques according to embodiments of the present disclosure to detect and provide corrective feedback relating to probe positioning during ultrasound imaging.

FIG. 35 illustrates a plot relating to multi-cell detection of a deformation.

FIG. 36 illustrates an example single horizontal conductive layer capacitive cell network.

FIG. 37 illustrates example portions of single horizontal conductive layer capacitive cell networks.

FIG. 38 illustrates simplified examples of single cell flexible structures.

FIG. 39 illustrates plots relating to measured displacements using a cell of a flexible structure and using an accelerometer based system.

FIG. 40 illustrates plots showing measured displacements, by a flexible structure, used in determining CPR chest compression rate.

FIG. 41 illustrates a plot showing CPR chest compression depths as measured using a flexible structure.

FIG. 42 illustrates pulse waveforms, as determined using a flexible structure and using measured oxygen saturation (SpO2).

FIG. 43 illustrates a waveform determined using a flexible structure, which can be used in pulse rate and pulse waveform determination and tracking.

FIGS. 44A-C illustrate waveforms determined using a flexible structure, which can be used in ventilation rate tracking.

FIG. 45 illustrates an example of components of various devices that can be used in accordance with embodiments of the present disclosure.

### DETAILED DESCRIPTION

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It is noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

In some instances, variations of a term may be utilized that may refer to the same or similar concepts, and certain terms may have meanings that are informed by a particular context. Generally, sending, receiving, or transmitting of data may include by wired and/or wireless connection, and/or within one or more wired or wireless networks. Furthermore, sending from a first entity to a second entity, or to be received by the second entity, can include sending from the first entity to the second entity, or to be received by the second entity, directly from the first entity to the second entity, or indirectly via one or more intermediary entities.

Some embodiments described herein allow measurement of shape deformation of a patient's body by use of a flexible structure applied to a portion of the patient's body. The flexible structure may be configured to provide signals that allow estimation of its own three dimensional shape deformation and deformed shape. Since the flexible structure is applied to the patient's body, the estimated deformed shape of the flexible structure may reflect an estimated deformed shape of the portion of the patient's body to which it is applied. In some embodiments, data is stored that reflects an undeformed shape of the flexible structure, which undeformed shape may be, for example, the shape of the flexible structure in a resting shape prior use with a patient. Based on an estimated shape deformation relative to the undeformed shape, the deformed shape of the flexible structure, and of the portion of the patient's body to which it is applied, may be estimated. Each estimation may be generated rapidly, and the series of estimations may be performed rapidly, so that delay relative to current conditions may be on the order of milliseconds. As such, the deformed three dimensional shape of the patient's body may be tracked with very little delay relative to current conditions.

Tracking the deformed shape of a patient's body using a flexible structure provides a number of advantages that have not been previously available with existing technologies in medical care. Once applied to the patient, since the necessary sensing capability for full shape tracking is built into the flexible structure itself, continuous shape tracking requires no further action or device monitoring by the care provider. Additionally, based on the tracked deformed shape of the patient, in various medical care applications as described herein, numerous critical patient related parameters can also be determined and tracked, using the sensing capability of the applied flexible structure alone. For example, existing approaches that utilize a single sensor may be more limited in the set of parameters that can be tracked, whereas full shape tracking, using a single flexible structure, allows continuous tracking of a wide range of patient parameters.

As another example, with a flexible structure, changes of position of portions of the patient's body can be directly tracked, with high accuracy and resolution, across a substantial portion of the surface of the patient's body. In comparison, single sensor based devices may be limited to a particular position, whereas, with a flexible structure, relative movement of various portions of the body of the patient can be tracked directly and simultaneously.

Additionally, by tracking the full three dimensional deformed shape of a portion of a patient's body, various forms of output may be provided to a care provider, as described herein. In some embodiments, displayed textual corrective feedback may be provided, such as to aid the provider in adjusting particular parameters of an ongoing applied treatment (e.g., instructing the care provider to adjust CPR compression depth by increasing or decreasing the depth by a certain amount). Furthermore, three dimensional image based displays can be provided to allow a care provider to see ongoing shape deformations resulting from a treatment as it is being applied. This may be combined with overlaid additional image based displays, which may, for example, show particular parameters along with ideal corrected parameters—e.g., a tracked actual deformation of a particular depth, which may, for example, be too shallow, resulting from an applied CPR chest compression. This may be shown with an overlaid image showing a hypothetical deformed shape of a particular depth that is according to a target range or target set of parameters. From such a visual display, the care provider may be provided with the ability to adjust a parameter in near real time during treatment, such as the depth of subsequent compressions, to approach and meet the ideal depth, for example.

Furthermore, in some embodiments, such as may include the use of fiducials, the positioning of the flexible structure on the patient's body (e.g., the chest) may be accurately tracked, so that the three dimensional deformed shape of the patient's body can be accurately shown and correctly aligned to the patient's body. As such, a deformed shape of a portion of the patient's body may be accurately tracked and displayed, aligned accurately to where it appears on the patient's body (e.g., the area of the patient's chest). This, in turn may allow the care provider to visually observe aspects of provided care that might not be observable uses other existing sensor based approaches. For example, from the placement of the shape deformation on the patient's chest, a CPR chest compressions provider may be able to observe incorrect hand placement on the chest, and correct accordingly, or may be provided with displayed feedback or corrective feedback to correct placement accordingly.

Additionally, since such corrective feedback may be provided in an ongoing fashion, the care provider can immediately see the results of an adjustment, and continue to make further adjustments, as may be needed. In some embodiments, incorporating such displays into an augmented reality display on a headworn device may enhance simplicity and practicality of use.

In some embodiments, a flexible structure may include a number of flexible capacitive cells positioned at various locations on or in the flexible structure. Each capacitive cell may have an associated capacitance that changes as a result of deformation of the capacitive cell. For example, in some embodiments, each flexible capacitive cell may include at least three layers, including two conductive layers with a dielectric layer between them. Upon deformation, the shape and surface area of the capacitive cell may be altered, which may lead to a change in the associated capacitance. As a result, a deformation of the flexible structure may result in deformations of a portion of the capacitive cells thereof. This, in turn, may result in changed capacitance values associated with the portion of the capacitive cells, relative to their capacitance values with the flexible structure in an undeformed shape. In some embodiments, changed capacitance values of a deformed flexible structure, including deformed capacitive cells, are obtained and used in estimating and tracking the deformed shape of the flexible structure. The deformed shape of the flexible structure may reflect the deformed shape of the portion of the surface of the body of the patient to which the flexible structure is applied.

Various computations models, such as may include one or more machine learning models, may be used in estimating the shape of a deformed flexible structure based on data including the changed capacitance values of the deformed capacitive cells. In some embodiments, a machine learning model, which may be trained prior to use with a patient, may be used in this regard, where training data may include data pairs. Each data pair may include data reflecting an actual, particular deformed shape of the flexible structure as well as capacitance values associated with the capacitive cells of the flexible structure, with the flexible structure in the particular deformed shape.

Furthermore, in various embodiments, the one or more computational models may use various particular techniques and algorithms. For example, in some embodiments, polygon modeling is used. Data may be stored that reflects the undeformed shape of the flexible structure. This data may reflect the actual undeformed shape of the flexible structure. The data may be obtained, for example, based on a three dimensional scan of the actual flexible structure in the undeformed shape. The data may be used to reflect the actual undeformed shape using polygon modelling, where the locations of a set of vertices of the undeformed shape are specified, and the vertices are interconnected by two dimensional polygons. In such an example, the vertices do not necessarily correspond to the locations of capacitive cells of the flexible structure. For a particular deformed shape, a machine learning model may first determine specific displacements of each of the vertices of the deformed shape relative to the undeformed shape. By applying these displacements to the locations of each of the vertices of the undeformed shape, a set of estimated vertices locations of the deformed shape can be determined. The displaced vertices are not determined to correspond with capacitive cell locations. By using polygon modeling to interconnect the vertices, a full deformed shape, including the vertices, may be estimated.

In various embodiments, a tracked, changing three dimensional deformed shape can be used is various medical applications. In some embodiments, a deformed shape may be compared to an undeformed shape in determination of various parameters of the shape deformation, such as surface location, surface shape, and depth of the shape deformation. For example, in CPR chest compressions, an applied chest compression results in a shape deformation of a portion of the surface of the chest of the patient, relative to an undeformed shape existing prior to the compression. A CPR chest compression may include a compression phase during which force is applied that causes an increasingly deep deformation of the chest of the patient to a certain maximum depth, at the deepest point, at the end of the compression phase. During the release phase of the CPR chest compression, as the portion of the surface of the patient's chest rises, the maximum depth of the deformation decreases until no compression force is applied. In some embodiments, for example, a deformed shape of the portion of the patient's chest at the end of the compression phase may be estimated. Based on a comparison of this deformed shape to the resting shape existing prior to the compression, various parameters of the deformation can be determined, including its surface shape, surface area, and depth, for example. Additionally, in some embodiments, differences between the undeformed shape and the deformed shape be compared, analyzed, quantified and used in various ways. For example, the surface shape and surface area of the deformation may be indicative of a portion of the hand or hands of the care provider used to apply the compression. Additionally, the shape of the deformation may be used in estimating an angle of the applied compression. This, in turn, may be used in determining feedback, such as corrective feedback, to provide to the care provider, such as to allow correction of the portion of the hand or hands used, the angle or the depth of future compressions, for example.

Another medical care use in which flexible structures and shape tracking may be used is in ventilation, such as may include mechanical ventilation or use of a ventilation bag. For example, the shape differences associated with inhalations and exhalations may be tracked. For example, the maximum vertical lift associated with a delivered breath, relative to the end of an exhaled breath, may be tracked and used to provide corrective feedback regarding the amount of gas delivered for each inhalation to achieve an ideal lift, or a confirmation that a ventilation is being administered. For instance, it may be useful for a caregiver to know that air is being received by the patient when a manual ventilation bag is being squeezed, and may further be used to determine the ventilation rate provided to the patient.

Furthermore, more generally, in various patient care uses, deformations of portions of the surface of a patient's body may be estimated and used in various other ways. For example, in some embodiments, deformed shape profiles may be determined, and particular deformed shapes may be matched with a particular profile. For example, in CPR chest compressions, a deformation profile specifying a particular range of surface area may indicate use of a particular portion of the care provider's hand (e.g., the ball of the hand), whereas a different profile, such as may specify a different surface area.

Some embodiments described herein provide apparatuses, systems and methods for use in providing assistance, such as instructions or corrective feedback, relating to a medical treatment provided to a patient. In some embodiments, a structure, such as a flexible structure including spaced apart capacitive cells, may be configured to be applied to a portion of the surface of the patient's body. A computerized system, communicatively coupled with the flexible structure, may be configured to receive signals associated with capacitance values corresponding to at least a portion of the capacitive cells. The computerized system may be further configured to, based at least in part on the received signals, estimate a change over time in a three dimensional shape of the flexible structure. The computerized system may be further configured to, based at least in part on the estimated change, determine data or provide output for use in providing the assistance or corrective feedback relating to the medical treatment.

In some embodiments, the computerized system may include one or more processors and one or more memories. The computerized system may also include one or more printed circuit boards (PCB) and integrated circuits, which may including one or more capacitive touch sensors, which may be used in measuring capacitances associated with individual or groups of capacitive cells. The one or more touch sensors may be used to measure capacitances associated with deformations. However, in some embodiments, human touch may, or may also, be detected.

In some embodiments, a flexible structure is applied to a portion of the surface of a patient's body. Included with, such as embedded on or within, the flexible structure may be a set of multiple capacitive cells. A change in shape of the flexible structure, such as a shape deformation, such as from application of force to a portion of a surface of the flexible structure, may result in shape deformation of at least some of the set of capacitive cells.

Each capacitive cell may be configured so as to be flexible, and shape deformation of the capacitive cell, relative to an undeformed, shape, may result in a change of capacitance associated the capacitive cell. As such, for example, the capacitance associated with the capacitive cell after deformation of the capacitive cell (such as may result from deformation of the flexible structure) may be different than the capacitance associated with the capacitive cell prior to the deformation of the capacitive cell.

The set of capacitive cells may be electrically coupled to a computerized system. The computerized system may be configured to receive electrical signals from the set of capacitive cells of the flexible structure. Based at least in part on the received signals, capacitance values associated with each or some of the capacitive cells may be determined.

The computerized system may include, stored in a memory, such as may be included within a database, data regarding an undeformed three dimensional shape of the flexible structure, as well as capacitance values associated with each of the capacitive cells, with the flexible structure in the undeformed shape. With the flexible structure in a deformed shape, the computerized system receives signals from the set of capacitive cells and determines and stores capacitance values associated with each of at least a portion of the capacitive cells with the flexible structure in the deformed shape.

Based at least in part on a comparison of the capacitance values associated with each of at least a portion of the capacitive cells with the flexible structure in the undeformed shape with the capacitance values associated with each of the at least a portion of the capacitive cells with the flexible structure in the deformed shape, the computerized system may estimate a change in the three dimensional shape of the flexible structure from the undeformed shape to the deformed shape. In estimating the change of shape of the flexible structure, the computerized system may utilize one or more computational models, which may include one or more mathematical models, machine learning models, artificial intelligence models or neural networks, for example. In some embodiments, neural networks are used that may include, for example, a feedforward neural network or a feedforward neural network with hidden layers, such as two hidden layers. In some embodiments, various types of loss functions may be used, which may include, for example, two dimensional loss functions, three dimensional loss functions, and loss functions that use loss such as normal, chamfer, Laplacian or edge loss.

In various embodiments, various numbers of capacitive cells may be used for a particular flexible structure, such as for a network of capacitive cells of a particular flexible structure. For example, in some embodiments, 50-500 capacitive cells may be used (or, e.g., 10-200, 50-150, 75-125, 90-100, 100-200, 200-500, 500-1,000, 1,000-2,000, 2,000-5,000, or 5,000-10,000). In some embodiments, the number of capacitive cells may be selected based on a variety of factors, including factors associated with characteristics of the flexible structure, expected use(s) or application(s), environmental conditions, needed performance, such as may include estimated deformed shape resolution (spatial resolution), or required noise rejection. In some embodiments, experimentation is performed for heuristic determinations, in these regards.

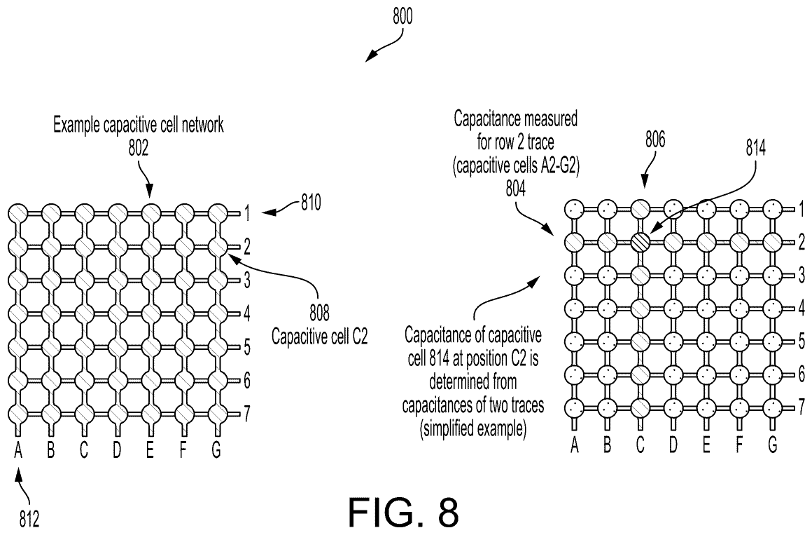

One factor that may favor limiting the number of capacitive cells is that multiplexing (as described, for example, with reference to FIG. 8), to determine capacitances for individual capacitive cells, becomes more difficult as the number of capacitive cells increases. Both the complexity of the multiplexing arrangement and the processing time required in use, where capacitance is measured based on time to charge, rapidly become much greater with increasing numbers of capacitive cells. Additionally, shape resolution may not be improved dramatically even as the number of capacitive cells grows much larger. As such, in some embodiments, the number of capacitive cells may be kept to, for example, 500 or fewer, although much higher amounts may be used in other embodiments. Another factor that may be taken into account is the needed resolution for the particular use. If more shape resolution is needed, then a larger number of capacitive cells may be used. Furthermore, as explained as follows, capacitive cells may be arranged such as that capacitive cell density is higher on portions of the flexible structure where more resolution is needed.

In some embodiments, a greater density of capacitive cells in a particular area (that is, more capacitive cells for per unit of area), such as along a flexible structure, can provide greater measurement sensitivity and consequent shape resolution in the area of greater capacitive cell density. In some embodiments, greater capacitive cell density may be provided on or in areas of the flexible structure in areas where tracking is more critical or requires greater measurement sensitivity. For example, in CPR chest compressions, a greater capacitive cell density may be used along a portion of the flexible structure that will or may be subject to compression force, and the area proximate thereto. This may allow higher resolution shape tracking in those potentially critical areas, which may include areas where shape deformations are expected to occur.

In some embodiments, based at least in part on the estimated shape deformation from an undeformed shape to a deformed shape, the computerized system may estimate the three dimensional shape of the flexible structure in the deformed shape. Since the flexible structure may be applied to a portion of the surface of the patient's body, the shape deformation of the flexible structure may reflect the shape deformation of the portion of the surface of the patient's body.

As such, the estimation of a shape deformation of the flexible structure may be used for, or as, an estimation of a shape deformation of the portion of the surface of the patient's body to which the flexible structure is applied. For example, while the flexible structure is applied to the patient, a force may be applied to the portion of the patient's body to which the flexible structure is applied. More specifically, for example, the flexible structure may be applied to at least a portion of the chest of the patient (which may, in some examples, include being applied to, for example, clothing, material, wrap, or other layering, on the chest of the patient) during CPR chest compressions. For example, the flexible structure may be applied as a wrap, compression wrap, tube or sheet. During the providing of a CPR chest compression, a force may be exerted (e.g., by hand or automatically, such as by an automatic compression device, e.g., a piston based compression device) on a portion of the chest of the patient on which the flexible structure is applied (e.g., via a force applied to the flexible structure applied on the chest of the patient, whether or not the flexible structure might be over or under clothing or other covering). This force may result in a shape deformation of the flexible structure as well as a corresponding shape deformation to the portion of the surface of the chest of the patient to which the flexible structure is applied. As such, for example, in an instance in which the flexible structure as applied to the chest of the patient corresponds with, or approximately corresponds with, an undeformed shape of the flexible structure, the shape deformation of the flexible structure may reflect, or approximately reflect, the shape deformation of the portion of the chest of the patient to which the flexible structure is applied.

According to embodiments described herein, this tracking of the shape deformation of the portion of the patient's body (in this example, a portion of the surface of the patient's chest), such as during a medical treatment, can be used to provide a spectrum of critical or even life-saving applications and advantages in various medical care scenarios. This includes, among other things, emergency and critical care scenarios in which adjustments on scales of fractions of seconds or millimeters can amount to the difference between success or failure, or life or death.

In some embodiments, for example, results data can be determined and stored that is representative of a tracked shape deformation of a portion of the patient's body during a medical treatment. The results data can be used to generate output, such as visual or audio output, that can be presented to a care provider providing the medical treatment, to facilitate or allow optimization of one or more aspects of the provided medical treatment. Furthermore, in some embodiments, such output can be provided in an ongoing fashion during the providing of the medical treatment to the patient.

In various embodiments, any of various types of presentations may be generated and provided, including visual, audio, haptic or others. In some embodiments, for example, one or more images, image based presentations, animated presentations, or video presentations can be provided, such as on an output device. The output device can include, among other things, a non-medical device or a medical device including one or more output components, such as a display screen or speaker, for example. In some embodiments, audio presentations may be provided, such as alert or other sounds, or voice or verbal information or instructions, such as via an output device including a speaker or headphones, e.g., of a medical device or other output device. In some embodiments, a device on which output may be presented may include, for example, a device coupled with a care provider, such as a wrist-worn or head-worn device, or others. Presentations can be used, for example, to provide assistance or corrective feedback to the care provider in connection with a provided medical treatment.

In some embodiments, corrective feedback, such as in the form of an ongoing animated presentation, can assist the care provider by, as the care provider may make particular treatment adjustments (e.g., changes to hand positioning during the providing of CPR chest compressions), allowing the care provider to visually observe the results of the adjustments (e.g., resulting shape difference, or resulting parameter differences). This may, for example, assist the care provider as the care provider may try slight variations of technique to attempt to better optimize particular treatment parameters (e.g., compression angle or force).

Additionally, in some embodiments, virtual or augmented reality based presentations may be generated and provided to a care provider, such as, for example, via a headworn device such as, for example, a Google Glass, Oculus or similar device. In some embodiments, for example, a visual (or, e.g., visual and audio) virtual or augmented reality presentation may be provided that is visually presented proximate to, or partially or completely overlaid on, or semi-transparently overlaid on, a camera or video based depiction of actual visual surroundings. Furthermore, use of fiducials, as described herein, can provide more precise tracking of the shape of the patient's body, and therefore more precise display, such as on a headworn device. For example, such a presentation could be provided as an enhanced reality presentation at least in part on a head-worn device. Furthermore, in some embodiments, with CPR chest compressions, for example, such a presentation could include a real time or almost real time animated depiction of application of CPR chest compressions. The presentation could further include metrics or parameters associated therewith, such as textual, visual or numeric indications of, e.g., compression rate, depth and angle. Furthermore, in some embodiments, overlays may be provided that show flexible structure or chest shapes associated with multiple previous compressions, and may also show characteristics associated with an optimal compression, to aid the care provider in visualizing the progression and needed modifications for upcoming compressions.

In various embodiments, various types of presentations can be provided as applicable to the use, medical treatment, care provider, patient, or other circumstances or conditions. For example, as described in further detail herein, presentations may be provided to help provide corrective feedback to adjust positioning and movement of an ultrasound probe.

Additionally, in some embodiments, one or more flexible structures may be applied to one or more portions of a patient's body to allow shape tracking results data that can be used in determination of a range of patient physiological parameters. This results data, in turn, may be useful in providing output for use in optimizing various aspects of a provided medical treatment. For example, as described in detail herein, in some embodiments, an applied flexible structure can be used to track a patient's respiration rate or heart rate.

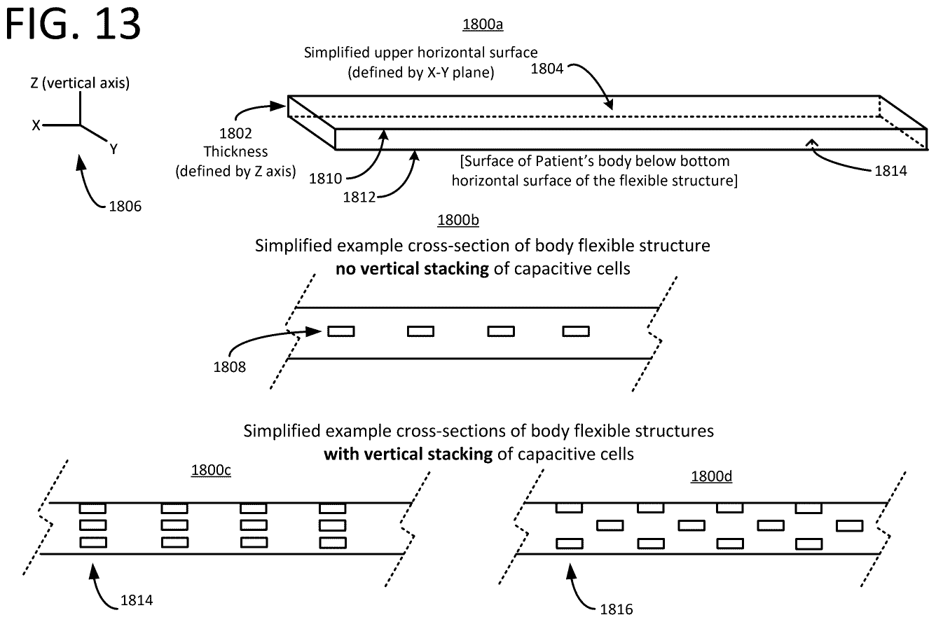

In various embodiments, the set of capacitive cells of a flexible structure may be located in the flexible structure according to various different arrangements. In some embodiments, the capacitive cells are located near the upper horizontal surface of the flexible structure (as described further herein, including with reference to FIG. 13), where the lower horizontal surface of the flexible structure may be applied on the patient (or clothing of the patient, etc.). In various embodiments, the horizontal arrangement of the capacitive cells may be irregular or may be regular, such as in a regular pattern. For example, in some embodiments, the capacitive cells may be arranged according to a polygon based horizontal pattern, in which particular capacitive cells form vertices of the polygons of the pattern. For example, in some embodiments, the capacitive cells may be arranged according to a square pattern, in which capacitive cells may form columns and rows of a square grid pattern, as further described herein.

Furthermore, in some embodiments, the set of capacitive cells of a flexible structure may be arranged or patterned at different vertical levels along a thickness of the flexible structure, with the capacitive cells being spaced apart from each other. For example, in some embodiments, some capacitive cells may be located along an upper horizontal surface of the flexible structure, while other capacitive cells may be located at one or more distances vertically under the upper horizontal surface. Furthermore, in some embodiments, all of the capacitive cells may be located at one or more distances under the upper horizontal surface. Still further, in some embodiments, the set of capacitive cells may be arranged according to a regular pattern relative to vertical level and position, such as a pattern in which some capacitive cells are located directly over others, or a pattern in which capacitive cells are located at different vertical levels according to a horizontally adjacently alternating or repeating pattern. Examples of such arrangements are further described herein. In some embodiments, patterning including both horizontal based and vertical based patterning is used.

In some embodiments, the set of capacitive cells of a flexible structure are electrically coupled with a computerized system. The computerized system may receive signals from the set of capacitive cells. Using the received signals, the computerized system may, in an ongoing and repeated fashion, determine the capacitance associated with each of the capacitive cells. In some embodiments, all of the set of capacitive cells, or each of several groups from the set, are electrically interconnected. In some embodiments, as described herein, capacitances associated with individual capacitive cells may be based on measurement of a capacitance associated with groups of capacitive cells. However, in some embodiments, some or all of the capacitive cells may be individually electrically connected with the computerized system, and the computerized system may use received signals associated with each individual capacitive cell to directly measure the capacitance associated with each individual cell. In some embodiments, various sampling strategies may be used, in connection with measurement of capacitances associated with groups of capacitive cells and use of such in determination of capacitances associated with individual capacitive cells. Furthermore, a network of capacitive cells may be configured with electrical paths between particular groups of capacitive cells.

In some embodiments, determining capacitances associated with capacitive cells based on signals received from groups of capacitive cells may provide advantages, and solve technical problems, relating to determining capacitances associated with individual capacitive cells directly. For example, determining capacitances associated with capacitive cells based on signals received from groups of capacitive cells may allow for greater speed than direct determination of capacitances associated with capacitive cells. However, determining capacitances associated with capacitive cells directly and individually may, in some instances, allow for more accurate measurements. In some embodiments, individual, direct measurement of capacitances of capacitive cells may be used for capacitive cells in areas of particular interest or where increased accuracy is required, such in areas where treatment related deformations are expected. However, capacitance values associated with other capacitive cells may be determined based on capacitance values associated with groups of capacitive cells, for example.

In some embodiments, one or more computational models may be used in determining a change of three dimensional shape of the flexible structure. These may include, for example, one or more mathematical models, one or more machine learning models, one or more artificial intelligence models, or one or more neural networks. A computational model may use data reflecting actual undeformed three dimensional shape of the flexible structure, and capacitance values associated with capacitive cells of the undeformed flexible structure. The model may further use determined capacitance values associated with capacitive cells of the deformed flexible structure. Using this data (and, in some embodiments, having been trained using large amounts of training data, as described further herein), the computational model may be used to estimate a three dimensional shape of the differently shaped or deformed flexible structure.

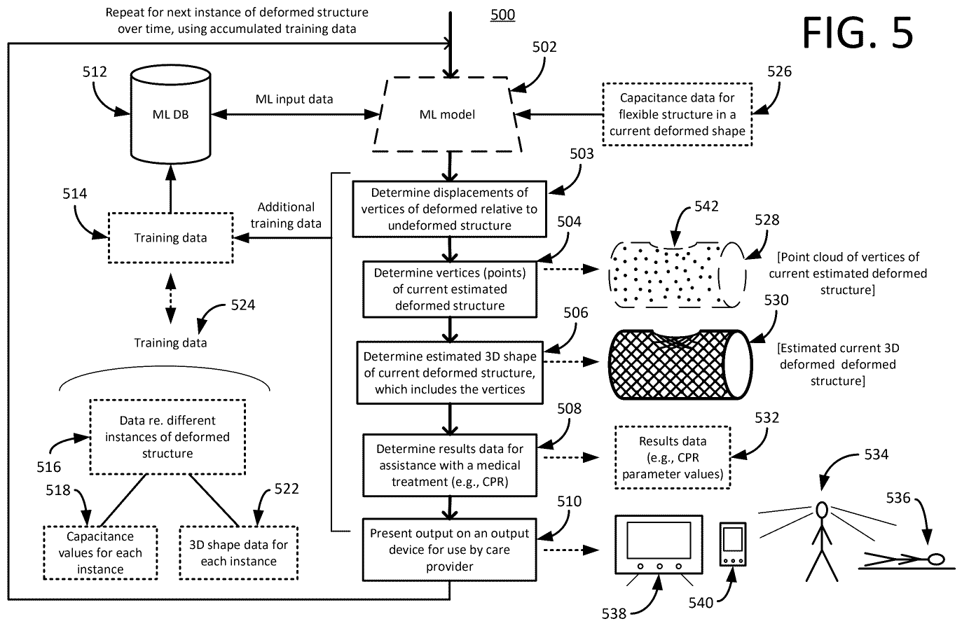

In some embodiments, for example, for a particular flexible structure, a machine learning model may be trained with large amounts of training data before use with a patient, such as being trained in a lab setting. Additionally, however, in some embodiments, a trained machine learning model may use, as additional training data for further enhancement thereof, data collected after initial use or during use. This may include, for example, data collected during use of a flexible structure applied to a patient, as described, for example, with reference to FIG. 5.

While machine learning models may, in some embodiments, generate the most accurate estimates, in some embodiments, computational models that are not or do not include machine learning models. For example, in some embodiments, a non-machine learning based predictive model may be used. For example, a predictive model may make use of statistics and may use regression analysis. Such a predictive model could use various input data, including data pairs as described herein (where each pair may include an input shape and associated capacitive cell values), as statistics for the model potentially among other data as described herein. This data may be statistically analyzed by the predictive model in order to generate a predicted shape, which may correspond with an estimated shape, for example.

While embodiments herein are generally described with regard to estimation of three dimensional shapes, in some embodiments, two dimensional shapes are estimated. This may include, for example, estimation of a two dimensional plane or cross-section of a three-dimensional shape.

A shape deformation of a flexible structure may, for example, result from force applied to a portion of the surface of the flexible structure, such as, for example, force applied from a CPR chest compression provided while the flexible structure is applied to the chest of the patient. Although the force may be applied to only a portion, or a small portion, of the surface of the flexible structure, the resulting shape deformation of the flexible structure, which may be reflective of the shape deformation of the patient's chest during the CPR chest compression, results in a shape deformation of the flexible structure, and capacitive cells thereof, that extends beyond just the portion of the surface to which the force is applied. Accordingly, for example, capacitive cells associated with the portion of the surface to which the force is applied, as well as other capacitive cells, such as capacitive cells proximate to that portion, may be, to different degrees, deformed as a result of the application of the force.

Deformation of a capacitive cell may result in changes to the horizontal surface area and thickness of capacitive cell, including the thickness of a dielectric layer between electrode layers, as described in further detail herein. Since capacitance is influenced by these factors, as described further herein, deformation of a capacitive cell can result in a change of capacitance of the capacitive cell. In some embodiments or circumstances, changes in surface area may have a comparably greater effect on change of capacitance than change in thickness of the dielectric layer. However, this may be different or opposite in some embodiments or circumstances.

Shape deformation of a flexible structure can be complex to estimate. Use of a computational model may provide advantages, and solve technical problems, associated with the potentially complex task of estimating, or optimally accurately or precisely estimating, the three dimensional shape of a deformed flexible structure. In some embodiments, a machine learning model is used. In various embodiments, various known types and variations of machine learning models may be used. In addition to the data described above, the machine learning model may use training data. The training data may include data pairs, where each pair includes data regarding a particular actual three dimensional deformed shape of the flexible structure and data regarding capacitance values associated with the capacitive cells of the flexible structure with the flexible structure in the particular deformed three dimensional shape. As described further herein, in a process that may be called model fitting, the machine learning model may use an iterative process or algorithm in which the training data is used in determining adjustments to model parameters to improve or optimize the model for future use. In this manner, the model may be optimized such that it can be used to more accurately estimate a new deformed three dimensional shape of a flexible structure not previously represented in training data.

In some embodiments, data input to a computational model, such as a machine learning model, may include physical, material or mechanical properties or parameters associated with the flexible structure, including associated effects on capacitance values or capacitance value changes associated with capacitive cells of the flexible structure, which may be caused by deformations. The model may be constructed, modified or updated to reflect or take into account such properties, such as to optimize the model for use in estimating new three dimensional shapes.

A shape deformation of a flexible structure may, for example, result from application of a force, or application of a particular force or type of force, to at least a portion of a flexible structure, including bending or twisting, or particular bending or twisting, of the flexible structure.

In some embodiments, capacitance values associated with capacitive cells of a deformed flexible structure are determined, but not always for all of the capacitive cells of the flexible structure, and not always for all of the capacitive cells of the structure as were present or functional with the flexible structure in an undeformed shape. For example, in some instances, capacitance values may be determined for only a portion of the capacitive cells of a deformed flexible structure, and these values may be used to determine an estimated shape deformation of the deformed structure. Furthermore, in some instances, it may not be practical, efficient or necessary to determine capacitance values associated with all of the capacitive cells, or some of the capacitive cells may become detached, electrically disconnected, dysfunctional or otherwise unavailable to allow determination of an associated capacitance value. For example, in the course of a medical treatment including application of force to a patient and to a flexible structure, some capacitive cells may become dislodged or broken. As such, herein, when reference is made to capacitive cells of a deformed flexible structure, this may include a subset or portion of capacitive cells of the flexible structure in an undeformed shape. In some embodiments, determination of capacitance values associated with a greater portion or number of capacitive cells of a deformed flexible structure may allow a more accurate or precise estimation of a shape deformation of the flexible structure or the shape of the flexible structure itself. Additionally, some embodiments include determination of particular capacitive cells with unreliable or inaccurate capacitance signaling, which could indicate a dysfunctional capacitive cell. Such particular capacitive cell signaling may be excluded from shape deformation and deformed shape estimations, and any models used may incorporate such determinations and exclusions. Furthermore, in some embodiments, one or more computational models, such as may include one or more machine learning models, may be used in determining such dysfunctional, or likely dysfunctional, capacitive cells, which model(s) may or may not be separate from model(s) used in estimation of shape deformations and deformed shapes.

Furthermore, in some embodiments, capacitance values may be determined with regard to a portion or number of capacitive cells of a deformed flexible structure based at least in part on, for example, considerations such as a balance of accuracy relative to processing speed. As such, for example, more values may be used if greater accuracy is desired or required, or less may be used if greater speed is required. Additionally, in various embodiments, one or more computational models may use all determined capacitance values or a portion of determined capacitance values. For example, use of more capacitance values may allow for greater accuracy, while use of less may allow greater speed. Furthermore, in some embodiments, when less than all available capacitive cell capacitance values are used, those that are used may be selected based at least in part on allowing optimal estimation, such as by being associated with selected capacitive cells that allow for most accurate estimation, for example.

Herein, applying of a flexible structure on or to a portion of a body of a patient may include, for example, applying the flexible structure to a portion of the surface of the patient's body, such as may include applying the flexible structure directly to the skin of the patient or applying the flexible structure to some covering(s). Such a covering may include, for example, a covering or partially covering substance, material or item, clothing, a wrap, a gel, an adhesive substance, or others.

In some embodiments, applying may include positioning or adhering at least a portion of the flexible structure to a portion of the surface of the patient's body. Applying may include, for example, placing or laying the flexible structure on a portion of the surface of the patient's body or covering a portion of the patient's body with the flexible structure, with or without any measure(s) taken to attach or secure the flexible structure. Applying may also include, for example, stretching the flexible structure over a portion of the surface of the patient's body, such as may occur, for example, when applying a tubular flexible structure around the torso, neck or a limb of the patient. Applying may also include adhering or attaching the flexible structure to a portion of the surface of the patient's body, such as by use of a substance such as an adhesive substance. Applying may also include covering or attaching the flexible structure to a covering of a portion of the surface of the patient's body, such as clothing or a wrap, and may or may not include attaching or securing the flexible structure, such as by adhesive, hook and loop fastener, snaps, a securing item, device, or in other ways. In some embodiments, an applying technique may be used or selected based on a balance of factors including speed and efficiency of application, and accuracy and security of placement, for example.

For example, applying by unsecured placement may have advantages in terms of speed and simplicity. However, applying by use of an adhesive of other secure coupling, for example, may have advantages in terms of most accurately conforming to the shape of the surface of the patient's body to which the flexible structure is applied, thereby leading to more accurate shape estimations relating to the portion of the patient's body. Furthermore, applying by use of an adhesive, or other secure coupling, may provide advantages in terms of the secureness and stability, such as by helping ensure no or minimal movement of the flexible structure on the portion of the patient's body during use.

Additionally, in some embodiments, a flexible structure may include fiducials, such as points or small areas on the flexible structure. When the flexible structure is applied, the fiducials are to be placed over particular patient anatomical features (e.g., the patient's nipples or sternum). The fiducials may be marked or labeled accordingly on the flexible structure, so as to indicate where they are to be placed (e.g., over the patient's nipples). Use of fiducials in this way may allow more precise tracking and alignment of portions of the flexible structure to portions of the patient's body. In some embodiments, this, in turn, may allow for more precise tracking of the deformed shape of a portion of the patient's body.

In some embodiments, a flexible structure, including a set of capacitive cells, may be used in determining an estimated three dimensional shape of the flexible structure itself. If the flexible structure is applied to a portion of the body of a patient, the estimated three dimensional shape may reflect the shape of the portion of the body of the patient to which it is applied. At least one computerized system may receive signals associated with capacitance values corresponding to at least a portion of the set of capacitive cells of the flexible structure with the flexible structure in a shape corresponding with the estimated shape. Based at least on part on the received signals, the estimated shape may be determined. Based on the estimated shape, output may be provided. For example, in connection with a medical treatment being provided, the output may include visual or audio output for use in providing assistance to a care provider providing the medical treatment (e.g., the providing of CPR chest compressions).

In some embodiments, various other data may also be used in determining the estimated shape of the flexible structure. For example, data used in determining the estimated shape of the flexible structure may include data reflecting an approximated shape of the flexible structure in a different shape (e.g. an approximated shape based on a three dimensional scan of the flexible structure in the different shape), as well as capacitance values corresponding with capacitive cells of the flexible structure with the flexible structure in the different shape.

In some embodiments, for example, a flexible structure may be used in determining the shape of the portion of the body of the patient to which it is applied. For example, a flexible structure applied to a patient prior to the providing of CPR chest compressions may be deformed, to some degree, as a result of application to the patient. Particularly, the flexible structure may be applied so as to conform to the chest or torso of the patient, and so the flexible structure may be deformed so as to reflect, or approximately reflect, the shape of chest or torso of the patient. Since the flexible structure may be used in determining a deformed shape of itself, and since the applied flexible structure reflects the shape of the chest or torso of the patient, the flexible structure may be used in determining a shape of the chest or torso of the patient prior to the providing of CPR chest compressions (as well as during or after). As described herein, tracking the shape of the chest or torso of the patient during the providing of CPR chest compressions may have a variety of uses (e.g., determining or estimating depth of CPR chest compressions, or detected chest remodeling). Additionally, however, determining or estimating the shape of the chest or torso of the patient prior to the providing of (or at the initiation of the providing of) the CPR chest compressions may also have various uses.

For example, in some embodiments, the shape of the chest of the patient prior to chest compressions, as determined or estimated using the flexible structure, may provide information that may inform or allow optimization of one or more parameters of the provided compressions. For example, in some embodiments, based on the shape of the chest of the patient prior to the providing of CPR chest compressions, as determined or estimated using an applied flexible structure, characteristics of the patient's chest may be determined that may impact optimal parameters of providing CPR chest compressions. For example, in some embodiments, the determined or estimated shape of the chest of the patient may be used to determine or estimate chest lateral distance (from left side to the right side of the patient's chest) as well as chest anterior posterior distance (from the front to the back of the patient's chest). Based at least in part on these measurements, the shape of the patient's chest as either relatively barrel chested (a relatively thick chest) or relatively flat chested (a relatively not thick chest). Of course, many other examples are possible, such as different degrees of barrel chested, different degrees of flat chested, etc. For example, in some embodiments, a ratio of chest lateral distance to chest anterior posterior distance may be determined. Based at least in part on this ratio, a determination may be made as to whether the patient is relatively barrel chested or flat chested. For example, if the ratio is at or above a specified threshold, this may indicate, or be some evidence that, the patient is relatively barrel chested, whereas, conversely if the ratio is below the specified threshold, this may indicate, or be some evidence that, the patient is relatively flat chested. Whether the patient is relatively barrel chested or flat chested may impact optimal CPR treatment parameters. For example, for a relatively barrel chested patient, a slightly larger chest compression depth may be optimal, whereas, for a relatively flat chested patient, a slightly smaller chest compression depth may be optimal. The foregoing provides one of many examples of use of a flexible structure to determine or estimate patient body dimensions or characteristics, such as may be useful in determining optimal medical treatment parameters. Moreover, in some embodiments, such dimensions or characteristics may be useful in indirectly determining or calculating other dimensions or characteristics relating to the patient's body.

Application of a deforming force may result in a deformation of a flexible structure, which may be, for example, applied to a portion of a patient's body. As described further herein, the one or more capacitive cells most proximate to the location (or area) of application of the force (e.g., directly under or nearly directly under it) may be more sensitive to the applied force, and may be more deformed by the applied force (as reflected by the change in capacitance of the cell), but other nearby cells may also be somewhat sensitive to, and deformed by it, such as may be inversely related to their proximity to the location of application of the force. This is logical from a shape tracking perspective, since, typically, a deforming force will result in the greatest deformation of the flexible structure at the location of application of the force, but will also result in a deformation of the flexible structure to a diminishing extent as distance from the location of application of the force increases.

In some embodiments, the capacitances of, or measurements based on, each of the cells deformed by application of the deforming force may be used together, or synergistically, to increase the accuracy of the determination of the resulting deformation and shape change of the flexible structure. For example, one or more models or algorithms, such as machine learning models, along with training sets (e.g., relating to other or past known or measured deformed states of the flexible structure), may be used in this regard. For example, determined capacitances or measurements based on one or more of a group of deformed cells may be used to correct, or increase the accuracy of, determined capacitances or measurements relating to one or more other of the group of cells, or may be used to correct, increase or optimize the accuracy of, the measurements associated with each of the cells, and with the group of cells as a whole. This, in turn, can lead to greater overall measurement, deformation and shape tracking accuracy and optimization, and can solve problems associated with a need for increased shape tracking accuracy or optimization, or problems associated with otherwise less accurate or inaccurate determined capacitances or measurements from individual deformed cells, for example.

In some embodiments, use of capacitive values from multiple cells, such as in determining deformations, a shape change, or a changed shape, allows definition of a mathematical or machine learning model that may allow determination of a deformation or shape change not just regard to surface points and areas occupied by cells but of each point given by the model, such as may include a portion of, e.g., or an entire, surface area of the flexible structure. For example, in some embodiments, use of capacitive values from multiple cells allows definition of an interpolative spline, with points between two adjacent cells where the combination of capacitances from those two cells can be used in a mechanical model of the flexible structure so as to accurately characterize the deformation of not just a point for each cell but also each point in that interpolating spline. In various embodiments, the physics relating the two capacitances to the individual deformations of each point in that spline could be reflected in a complex deterministic mathematical model that allows for the three-dimensional reconstruction of the deformed surface, or a machine learning model that learns from and reflects the underlying physical properties and relationships from the training set and associated capacitance measurements, for example. In some embodiments, a machine learning model may provide as simpler alternative to a deterministic mathematical model, for example.

In some embodiments, as described in detail herein, each cell of a capacitive cell network of a flexible structure, rather than including, for example, vertically (e.g., vertical relative to a horizontal upper or lower surface of a flexible structure, as described, for example, with reference to FIG. 13 herein, where, for example, CPR chest compressions may be applied generally in a vertical direction). spaced conductive layers (relative to a vertical thickness of the flexible structure, as described herein) may instead include only a single horizontal conductive layer including two conductive portions (or plates), forming a parallel plate capacitor, that are slightly spaced apart horizontally, instead of vertically. This can allow for a thinner flexible structure, which may, for example, include the horizontal conductive layer, or may also include upper and lower dielectric layers, for example. Relative to some embodiments with conductive layers, such embodiments may, in some cases, allow for simpler or less expensive manufacturing, may have lower total or per cell capacitance, and may be more sensitive to smaller deformations but may also make measurements closer to a noise floor, for example.

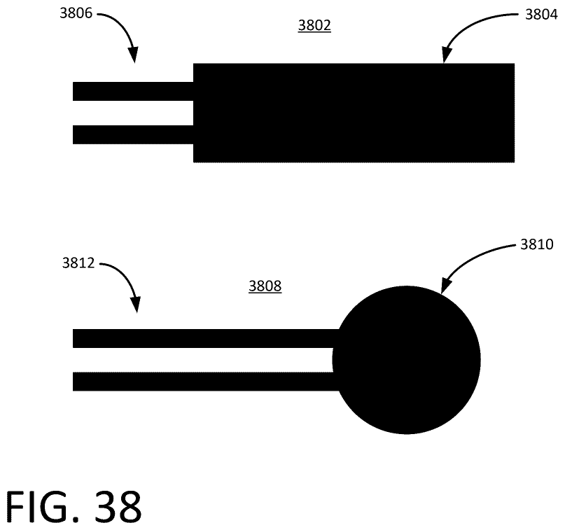

In some embodiments, a flexible structure incorporating aspects of the present disclosure, such as for application to a portion of a patient's body, may include a small number of capacitive cells, or may include one cell only, such as that provided in an embodiment illustrated by FIG. 38. For example, a single cell flexible structure may include a cell for positioning on the patient's body such that the cell is ideally located on the patient's body to sense a particular type of deformation. For example, a single cell flexible structure, positioned at a location or area of the patient's chest where CPR chest compression force is be applied, may be used in CPR chest compression metric detection (e.g., rate, depth), or may be placed on or around the patient's torso and in tracking of ventilation rate (as described further herein), which may allow for accurate detection of such metrics including. e.g., specific time periods of compression and release phases or CPR chest compressions or inspiration and expiration time periods of ventilations.

As described in detail herein, in some embodiments, a flexible structure incorporating aspects of the present disclosure may be used during the providing of chest compressions, and may be used in tracking, for example, chest deformations and chest shape changes associated with chest compressions. Such tracked shape change data may be used, for example in determination of chest compression metrics/data (e.g., rate, depth, angle, location, hand position) and in determining and providing input or guidance to a CPR provider. In various embodiments, a flexible structure may be used with, e.g., manual or mechanical compressions (e.g., piston based systems, band or strap based systems), active compression-decompression (ACD) compressions, and compressions with use of an impedance threshold device (ITD).

Furthermore, in some embodiments, a flexible structure incorporating aspects of the present disclosure may be used along with one or more motion or acceleration sensors, such as accelerometers (e.g., an accelerometer placed along or within a defibrillation pad and/or under a location of application of compression force, or two accelerometers, e.g., where one is placed on an anterior of the patient and another is placed on a posterior of the patient, or such an accelerometer along with a second accelerometer placed on, within or against a patient backboard, e.g., such as embedded into a posterior electrode and attached to the patient's back, for example). In various embodiments, the one or more accelerometers and/or the flexible structure may be used in determining chest compression metrics. For example, data obtained from use of both the flexible structure and the accelerometer(s) may be used together, such as to obtain more accurate or error-free metrics/data.

As described in detail herein, in some embodiments, flexible structures incorporating aspects of the present disclosure, may be applied to various locations on a patient's body (or several locations), e.g., pulse bands incorporating aspects of the present disclosure, may be used in measurement of pulse rate or heart rate (whether separate or included within or as part of a blood pressure cuff, for example). In some embodiments, flexible structures may be extremely sensitive to small deformative shape changes, allowing for accurate pulse tracking based on small body surface deformative shape changes resulting from increased pressure from pulsing blood flow (e.g., resulting from slightly increased blood capillary volume resulting from individual heart beats). In some embodiments, pulse rate tracking, such as may include pulse waveform tracking, using an applied flexible structure can be approximately as accurate, or more accurate, than conventional pulse rate or pulse waveform tracking by manual pulse palpation or using a pulse oximeter and SpO2, for example. As a result, in some embodiments, flexible structures may be used instead of manual pulse palpation (or use of a pulse oximeter for pulse rate and pulse waveform tracking), or both may be used together. Furthermore, in some embodiments, pulse rate and/or pulse waveform tracking using a flexible structure may be used in detection or confirmation of Pulseless Electrical Activity (PEA) or Return of Spontaneous Circulation (ROSC) in a patient. In some embodiments, pulse or pulse waveform tracking using a flexible structure may provide advantages over, for example, manual pulse palpation. For example, such tracking may provide higher sensitivity, greater accuracy and greater consistency. Furthermore, provides associated electronic signaling that can be received/stored, analyzed/processed, and used in determination of feedback to a care provider, for example.

In some embodiments, a flexible structure incorporating aspects of the present disclosure may be used during the providing of mechanical or manual ventilation to a patient. For example, in some embodiments, one or more flexible structures may be implemented as respiratory bands that may be positioned around the torso of the patient, such as around the chest or abdomen, and may or may not be used in addition to a flow sensor. The respiratory bands may monitor for and detect chest and/or abdomen rise and fall associated with inspiration and expiration, which may be used in detecting breaths, including inspiration and expiration periods, and ventilation rate. In some embodiments, signals from both the respiratory band(s) and, e.g., a flow sensor may be used in such detection or improving the accuracy thereof. Furthermore, in some embodiments, a flexible structure, such as in the form of a cylindrical pad, may be applied to a ventilation bag itself. Associated tracking and counting of bag inflations and/or deflations (e.g., as reflected by shape changes in which the bag increases or decreases in size) may allow for, or be used in combination with other methods, for tracking of ventilation rate, not necessarily even including use of flow or volume determination or comparisons.

Furthermore, in some embodiments, a flexible structure incorporating aspects of the present disclosure may be used in monitoring endotracheal tube placement and proper connection, or attachment or disattachment/dislodgment, during ventilation of a patient (such as in addition to, or instead of, other monitoring techniques). For example, in some embodiments, a flexible structure may be used around the chest of the patient to monitor chest rise and fall associated with inspirations and expirations, where lack, sudden lack, or precipitous dropoff thereof may suggest tube dislodgement. Additionally, in some embodiments, a second flexible structure may be applied around the abdomen of the patient, where unexpected or sudden rise in the abdomen area may result from, and therefor suggest, tube misplacement. In some embodiments, based on such data and determinations, appropriate feedback or guidance may be determined and provided to the care provider, such as may alert or alarm regarding potential tube misplacement or dislodgement, and provide guidance regarding checking and correcting such problems.

In some embodiments, a flexible structure incorporating aspects of the present disclosure may be used along with a tourniquet, applied to or be applied to part of a patient's body (e.g., an arm or leg), such as in connection with application and monitoring thereof, including, such in monitoring and determining guidance relating to positioning and assuring the correct tightness/pressure is applied by the tourniquet. In various embodiments, a flexible structure may be applied under, over and/or in the same or overlapping area of an applied tourniquet. The flexible structure may be used to monitor the deformation of the portion of the patient's body to which the tourniquet is applied, and may also measure the pulse/pulse waveform of the patient as detected under the area of application of tourniquet, such as to ensure that the tourniquet is tight enough so as to adequately restrict blood flow and pulse. This data can used in determining and providing feedback or guidance to the care provider, such as in real time or almost real time, such as may include use of augmented reality, regarding application, positioning or changing the level of tightness or pressure applied by the tourniquet. For example, if blood is detected to flow past the tourniquet, then it may be desirable for the tourniquet to be tightened so as to further restrict flow; in such a case, when it is desirable for the tourniquet to be tightened and/or reapplied, feedback may be provided to a user, e.g., from a tablet, mobile device, medical device and/or other feedback device on the scene.

In some embodiments, in use of machine learning or artificial intelligence along with a flexible structure, as described in detail herein, various types or forms of training data may be used. For example, in some embodiments, training data may relate to characteristics of the capacitive cell matrix of the flexible structure, including construction aspects and material layers thereof, and/or training data may relate to characteristics of the cell matrix itself, including cell arrangement, layout, density per unit area and distribution. However, in some embodiments, training data may be used that only related to construction or other aspects not including characteristics relating to the cell matrix (e.g., connectivity), which, in some embodiments, may lead to or allow for faster or more robust training.

In various embodiments, as described herein, various construction processes and materials may be used in constructing or manufacturing a flexible structure. For example, in the construction process, various types of masking techniques may be used, such as cut stencil or silk screen approaches, or laser ablation of a fully deposited sheet. Furthermore, in some embodiments, layer deposition or sputter coating may be used. In some embodiments, for example, layer material hardness may be monitored based on a durometer measure.

Herein, estimating a shape can include, for example, determining or identifying an estimated or approximate shape, among other things. Shapes can include, for example, two dimensional, three dimensional or other shapes. Some embodiments described herein include estimating a shape deformation of a flexible structure from an undeformed shape to a deformed shape. However, in some embodiments, a shape deformation may be estimated between any two different shapes, such as from a first deformed shape to a different deformed shape.

Herein, unless otherwise stated, the shape of a flexible structure refers to the horizontal shape of the flexible structure, such as the shape defined by the upper horizontal surface of the flexible structure (as further described herein, including with reference to FIG. 13). In some embodiments, a flexible structure has a horizontal length and a width that are much greater than its thickness. For example, a flexible structure may have a horizontal length or width, in cm, of, e.g., 0.2-0.5, 0.5-1.0, 1.0-2.0, 2.0-3.0, 3.0-4.0, 4.0-5.0, 5.0-10, 10-20, 20-30, 30-40, 40-50, 50-100, 100-200, 200-300, 300-400, 400-500, or 500-1,000 or 1,000-1,500. Furthermore, a flexible structure may have a thickness, in mm, of, e.g., 0.1-0.2, 0.2-0.

Herein, a care provider providing a medical treatment to a patient can include, among other things, a care provider in any way facilitating the medical treatment, even if one or more devices are used administering the medical treatment (e.g., an automated piston based CPR chest compressions device).

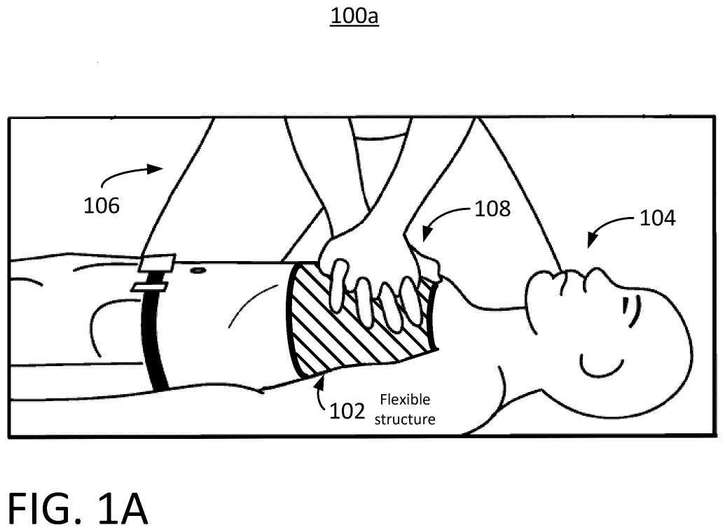

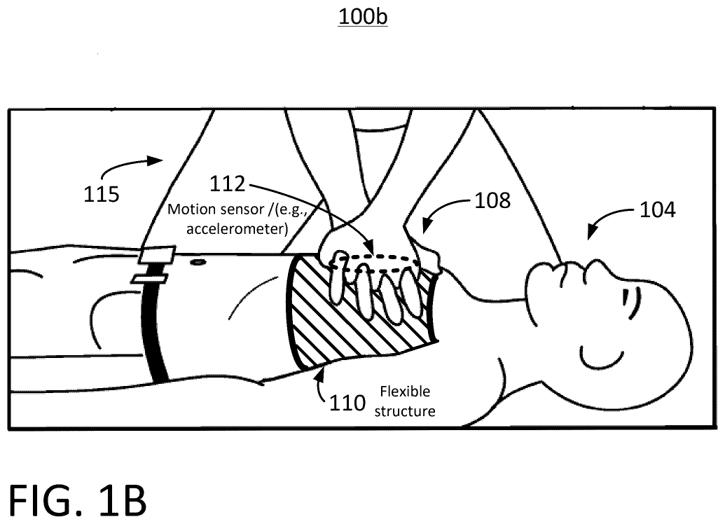

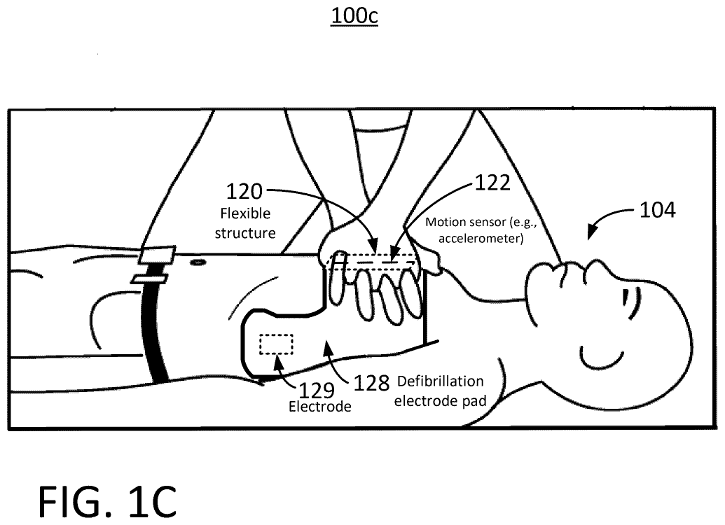

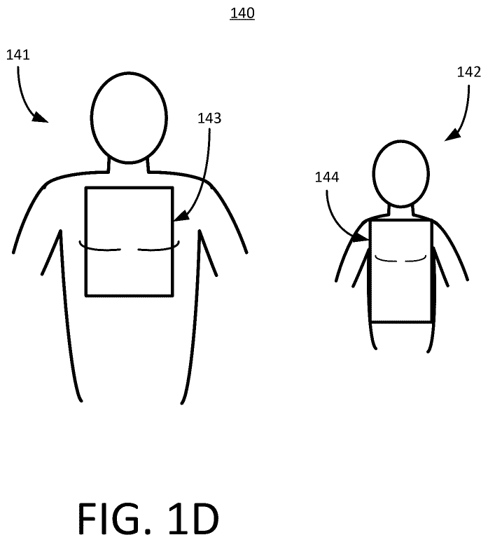

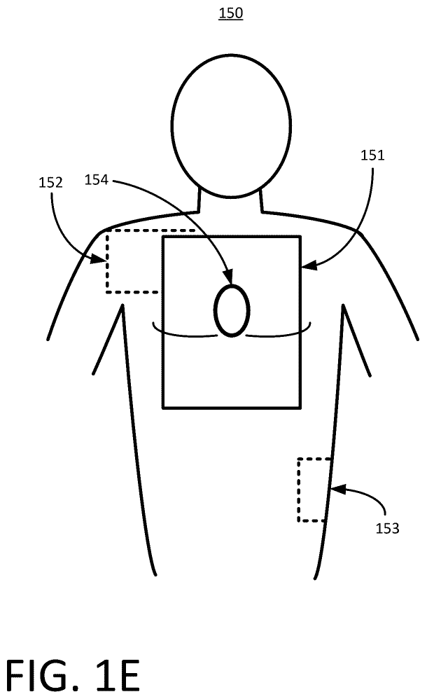

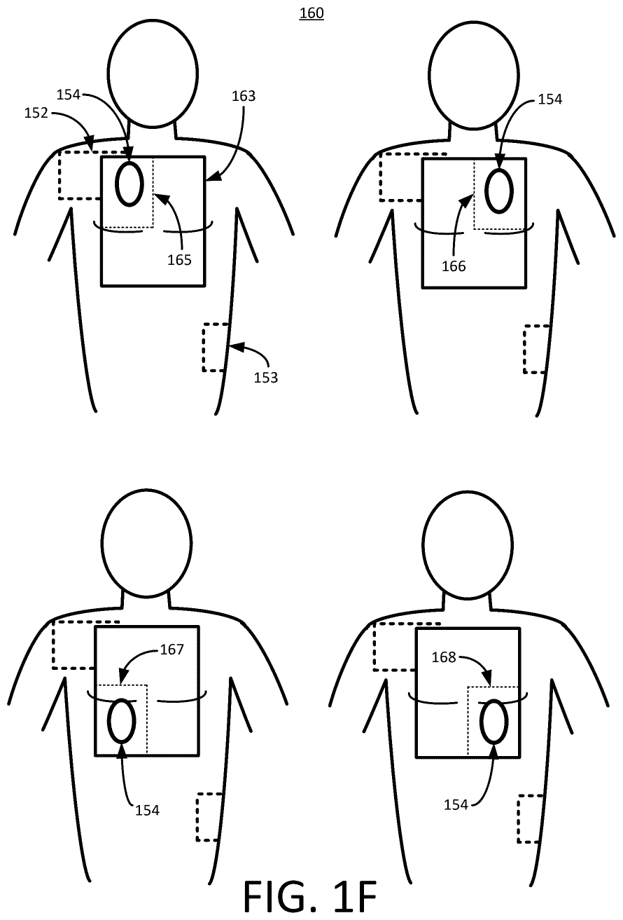

FIG. 1A illustrates an example emergency care environment 100a including use of a body applied flexible structure 102 during providing of manual CPR chest compressions 108 to a patient 104 by a care provider 106. As depicted, the flexible structure 102 is tubular in configuration and positioned around the torso of the patient 104. Force applied from a chest compression deforms the three dimensional shape of both the flexible structure 102 and the chest of the patient 104.

FIG. 1B is an illustration of an example emergency care environment 100b including use of a flexible structure 110 and a motion sensor, such as an accelerometer 112, during providing of CPR chest compressions to a patient. In the embodiment depicted, the accelerometer 112 is placed over a portion of the flexible structure, and under a hand of a care provider 115 providing CPR chest compressions. In various embodiments, the accelerometer may be not attached to the flexible structure, but held in place by the care provider 115, or may be coupled with, attached to, or embedded within the flexible structure, or over or under the flexible structure.

FIG. 1C is an illustration of an example emergency care environment 100c including use of a flexible structure 120, a defibrillation electrode pad 128 and an motion sensor, such as an accelerometer 122, during providing of CPR chest compressions to a patient 104. In the embodiment depicted, a sheet style flexible structure 120 is applied over a portion of the patient's chest where CPR chest compressions are provided. Also over the area of the patient's chest where CPR chest compressions are provided is an accelerometer 122. In various embodiments, one or both of the accelerometer 122 and the flexible structure 120 may be separate from the pad 128, which may include one or more electrodes 129 that may be coupled with or attached to the pad 128, or may be at least partially embedded within the pad 128. Additionally, in various embodiments, the accelerometer may be positioned over or under the flexible structure, or at least partially embedded within the flexible structure. Furthermore, in various embodiments, the accelerometer and the electrode pad may be separate from each other, coupled with each other, or attached to each other. In some embodiments, the flexible structure for tracking shape deformation of the patient's body may extend from the connecting material of the defibrillation electrode pad so as to form a unitary structure that can be placed on the patient's torso. As noted above, the motion sensor may be part of or separate from the unitary structure.

In some embodiments, a flexible structure may be used along with one or more motion sensors, such as accelerometers. In some embodiments, a flexible structure may not determine movement of the whole flexible structure (or of the patient's body) through space, such as may include rotational (about any axis) or translational (in any direction) movement (such as may occur during patient transport in an ambulance or on a stretcher, etc.). This may helpful, for example, when such movement is not relevant to parameters of interest (e.g., depth of a CPR chest compression). However, in some embodiments, translational or rotational movement may be relevant to one or more parameters of interest. As such, in some embodiments, a flexible structure may be used along with (or may include) one or more sensors for use in determining or estimating such movement. For example, in some embodiments, one or more accelerometers may be used. Measured changes in acceleration can be used to determine or estimate movement, such as rotational or translational movement. As such, in some embodiments, an accelerometer may be used along with, or as part of, a flexible structure, for example, to determine or estimate rotational or translational movement of the flexible structure and/or of the portion of the body of the patient to which it is applied.

For example, with CPR chest compressions, it may be of interest, and relevant to optimizing treatment, to determine rotational or translational movement of the chest or torso of the patient, or a portion thereof, during the providing of chest compressions. For example, during provided chest compressions, the patient's torso may gradually move or rotate, or portions may move or rotate as a result of possible chest remodeling. In such instances, determining or estimating such rotational or translational movement may impact and allow optimization of treatment parameters, such as the depth of compressions, or the angle of compressions, taking into account such movement. Such optimization may allow more effective treatment or may allow avoiding serious injury to the patient.

As such, in some embodiments, one or more motion sensors, such as accelerometers, may be used along with, or as part of, a flexible structure. For example, in some embodiments, one or more accelerometers may be coupled with, attached to, or at least partially embedded within, a flexible structure. Furthermore, in some embodiments, one or more accelerometers may be coupled with or attached to the patient (or a covering on the patient). In various embodiments, in uses including the providing of CPR chest compressions, one or more accelerometers may be included over an area of the patient's chest where compressions are provided, or in areas of the patient's chest that are not deformed, or are less deformed, by the compressions, or both. In embodiments in which an accelerometer is included over an area of the patient's chest where compressions are provided, the accelerometer may be used in determination or estimation of measurement of rotational or translational movement of the chest of the patient, or a portion thereof. Furthermore, the accelerometer may also be used to determine or measure, or contribute to determination or measurement of, other parameters (e.g. depth of compressions), as described further as follows.

In some embodiments, a flexible structure may be used along with, or as part of, a defibrillation electrode pad (e.g., CPR-D-Padz®, available from ZOLL Medical Corp. of Chelmsford, MA). The defibrillation electrode pad may include defibrillation electrodes for use in delivering one or more defibrillation shocks to a patient, for example. The defibrillation electrode pad may include two electrode pad portions as well as a central portion placed over a portion of the patient's chest where CPR chest compressions are provided. A care provider may provide compressions by pushing down on the central pad over the patient's chest. The central portion of the pad may include a motion sensor, such as an accelerometer. In some embodiments, the central portion of the pad may also include an embedded or attached flexible structure, such as a sheet style flexible structure (or the flexible structure may be partially included or embedded, and may extend beyond the borders of the pad) that is constructed to provide shape deformation measurements, as discussed herein. For example, a sheet style flexible structure may be embedded within the central portion of the pad under an accelerometer. As such, in some embodiments, an accelerometer may be used along with a flexible structure, such as in determination or estimation of rotational or translational movement of the patient's torso or chest, or a portion thereof, during the providing of CPR chest compressions. Additionally, in some embodiments, although various CPR chest compression parameters (e.g., depth of each compression) may be determined or estimated using estimated three dimensional shape information provided by use of the flexible structure, measurement information from use of one or more accelerometers may be used in addition. For example, measurement information obtained using one or more accelerometers may be used in addition to measurement information obtained by use of the flexible structure in order increase the accuracy of determined or estimated parameters.

For example, in the embodiment depicted in FIG. 1C, the sheet style flexible structure may be used in determining or estimating rotational or translational movement, and may also be used, along with the flexible structure, in determining or estimating other parameters (e.g., depth of compressions or change of angle of compressions). In some embodiments, measurement information provided by use of the flexible structure as well as a motion sensor, such as an accelerometer, may be used together in order to increase the accuracy of particular measured parameters. (e.g., depth of compressions). For example, in some embodiments, one or more algorithms or models may be used that incorporate measurements obtained by use of both the flexible structure and the accelerometer in calculating particular parameters, and having the measurements from both sources may serve to increase the overall accuracy of the calculated particular parameters. For example, in a simple example, averaging or weighted averaging of the measurements of a particular parameter may be used in calculating the particular parameter.

FIGS. 1D-F illustrate simplified examples of systems including a flexible structure incorporating aspects of the present disclosure as applied to a torso of a patient. In particular, in FIG. 1D, adult and pediatric patients 141, 142 is are shown, each with a generally rectangular flexible structure 143, 144, respectively, applied to the patient's torso.

FIG. 1E shows an adult patient 150 with a generally rectangular flexible structure 151 incorporating aspects of the present disclosure as applied to the patient's torso. A defibrillation electrode pad including two electrodes 152, 153 is also applied to the patient's torso, and a compression sensor/compression puck 154 (e.g., as previously described) is shown positioned over the flexible structure, for use in applying CPR chest compressions to the patient.

FIG. 1F shows views 160 of the adult patient 150 as shown in FIG. 1D, with the compression sensor 164 placed in different quadrant areas 165-8 (left top, right top, left bottom, right bottom) of the patient's chest. In some embodiments, as described herein, a flexible structure incorporating aspects of the present disclosure may be used in tracking parameters associated with the providing of, e.g., manual CPR chest compressions using a compression sensor. In some embodiments, based on measured deformations and shape change of the flexible structure, parameters and conditions associated with the providing of chest compressions may be tracked, such as may include the location of delivery of each chest compression. Additionally, use of tracking using the flexible structure enabling correlation between the approximate anatomical area of the chest being compressed to physiological parameters being tracked, such as estimating that compressions are being applied to the outflow tract versus the left ventricle of the heart, for example. In various embodiments, this may be done using the flexible structure, such as instead of, as an alternative to, or combination with use of one or more accelerometers (which may, e.g., be included with the compression sensor). It is noted that, as depicted in FIG. 1F, the flexible structure is not moved, but the location of compressions is changed.

In some embodiments, as described herein, the flexible structure may be used in tracking the location of delivered chest compressions, and output, such as visual or audio output, may be provided to the care provider accordingly, e.g., to detect whether the location of delivery is or has become suboptimal and to provide guidance to correct the location of delivery. Furthermore, in some examples, the location of delivery of chest compressions may be intentionally varied, such as to potentially improve the effect of the delivered chest compressions or to reduce risk of injury to the patient. Tracking using the flexible structure of the location of delivery of the chest compressions may be used in such examples, such as to ensure that the location of delivery is correct (e.g., the correct quadrant area), or in providing prompts to the user to change the location (e.g., to another quadrant area), for example.

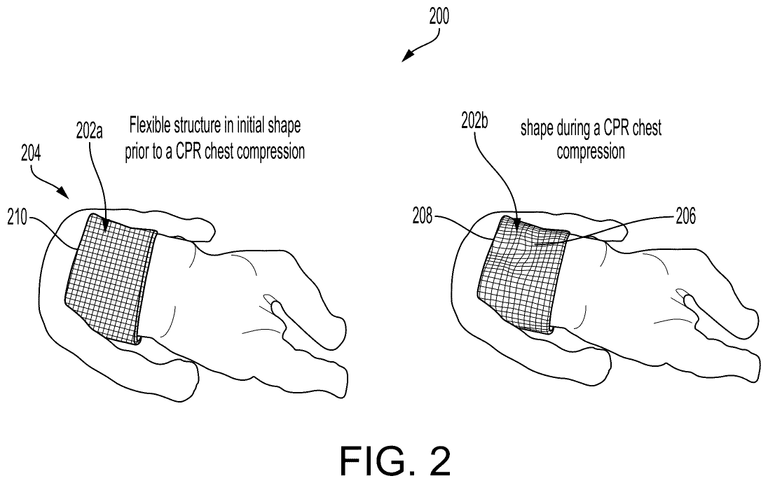

FIG. 2 is an illustration of an example flexible structure 202a, 202b applied around a modeled patient's torso 204, in both an initial shape 202a and a particular deformed shape 202b, where the deformed shape 202b may exist during providing of CPR chest compressions to a patient, such as illustrated in FIG. 1.

In various embodiments or instances, application of the flexible structure to a patient may or may not deform, or may or may not non-negligibly deform, the flexible structure relative to an undeformed shape of the flexible structure prior to application to the patient. In some embodiments or instances, if applying the flexible structure to the patient deforms, or non-negligently deforms, the flexible structure, then the deformed shape of the flexible structure after application to the patient but before CPR chest compressions may be taken to reflect the shape of the chest of the patient. If, however, application to the patient does not deform, or does not non-negligibly deform, the flexible structure, then the shape of the flexible structure in an undeformed state prior to application to the patient may reflect the shape of the chest of the patient prior to application of CPR chest compressions, for example. As such, in some embodiments, shape change and shape estimations may be made or used accordingly, in CPR chest compression applications and other applications.

During the providing of a chest compression, the shape of the flexible structure (and of the patient's chest) will change over time during a compression phase (the “compression period”) and a release phase (the “release period”) of the chest compression. The depicted shape 202a may be the shape of the flexible structure (and of a portion of the patient's chest) that exists prior to a chest compression, for example during a time when no chest compressions are being performed. A particular deformed shape, for example the shape 202b, may be the shape of the flexible structure (and of a portion of the patient's chest) that exists at some point in time during the compression period of a chest compression, such as, for example, at the point in time of maximum compression at the end of the compression phase.

For example, while CPR chest compression rates vary, an individual chest compression may include a compression phase of a duration of approximately 0.25 seconds (or, e.g., 0.2-0.3 seconds) followed by a release phase also of a duration of approximately 0.25 seconds (or, e.g., 0.2-0.3 seconds). At the start of a compression phase, the patient's chest may be in an undeformed shape. Over the approximately 0.25 second compression phase, the resulting shape deformations of the flexible structure and of patient's chest become increasingly large until the end of the compression phase, at which point the compression reaches maximum depth (e.g., for an adult, 5-6 cm). Next, the release phase begins, with the compression at maximum depth and the resulting deformation at its largest size. Over the approximately 0.25 second duration of the release phase, the resulting deformations of the flexible structure and of patient's chest become increasingly small until the end of the release phase, at which point the chest may return to an undeformed shape (assuming no chest remodeling has occurred).

In some embodiments, during the approximately 0.25 seconds of the compression phase, using the flexible structure, the deformed shape of the patient's chest, and the increasingly large shape deformation, can be tracked. With this shape tracking, the dimensions and size of the deformation itself can be tracked, such as may include tracking of the surface area that it occupies, and the depth of the deformation, which may correspond to the depth of the chest compression. As such, the tracked increasing depth of the deformation may correspond with the depth of the chest compression. As such, the maximum depth of the compression (e.g., 5-6 cm), existing at the end of the compression phase and start of the release phase, may be tracked.

Furthermore, and analogously, the decreasing depth of the deformation, and the decreasing depth of the compression, may also be tracked during the approximately 0.25 second duration of the release phase, until it reaches 0 cm at the end of the release phase when the patient's chest may once again be in an undeformed shape.

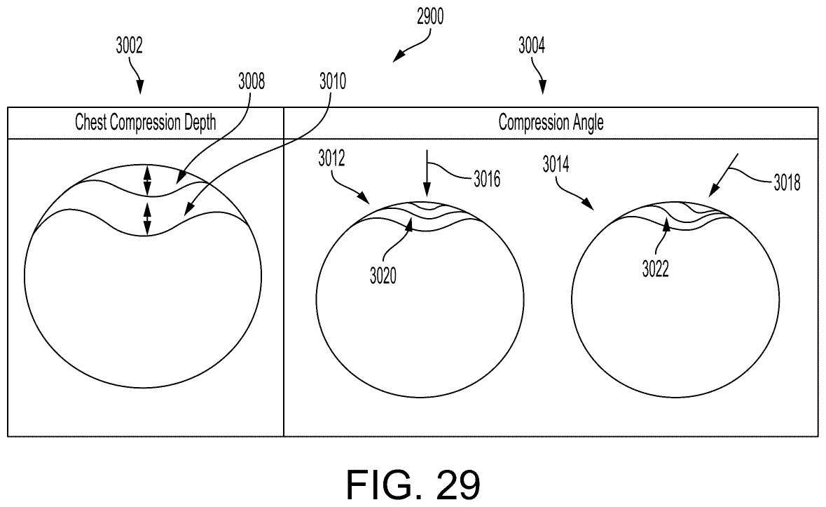

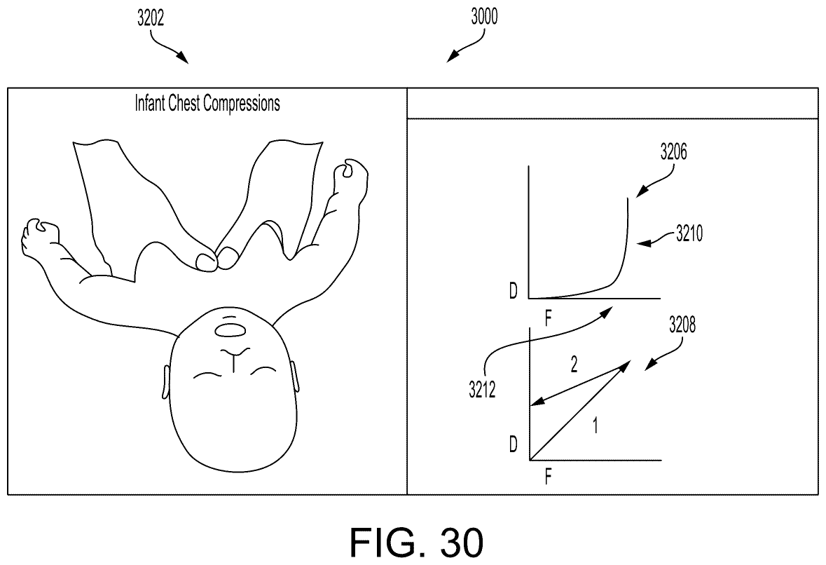

The above provides just one example of numerous parameters that can be tracked based on shape tracking using a flexible structure, with CPR chest compressions. Moreover, since the entire shape of the patient's chest, and the deformation thereof, may be tracked, numerous other parameters may also be tracked. For example, the tracked shape of the deformation may be used to determine and track the angle of the compression, and the portion of the hand or hands of the care provider used to apply the compression, as described further with reference to FIG. 29. Additionally, since the shape of the deformation is tracked, such as over the approximately 0.25 second compression phase, the manner or rate with which deformation increases in size can also be analyzed and used in various ways. This may include, for example, determining likely chest remodeling or a broken rib, as described with reference to FIG. 30.

Moreover, with CPR chest compressions, as well as other medical uses, once the flexible structure is applied, full three dimensional shape tracking can be done continuously. Furthermore, this tracking is based on estimated positional changes and not just, for example, positional changes determined indirectly based on changes in acceleration, such as may be measured by an motion sensor, such as an accelerometer.

Application of a CPR chest compression during the compression period may include application of a downward force to a portion of the flexible structure and a portion of the patient's chest under the flexible structure (whether or not there are one or more intervening layers, such as clothing over or under the flexible structure). For illustration purposes, the depicted flexible structure 202a, 202b includes a visual checkerboard pattern on its upper surface. The checkerboard pattern on the undeformed flexible structure 202a can be seen to be relatively regular. However, the checkerboard pattern on the deformed flexible structure 202b can be seen to be less regular and more distorted as a result of the deformation from the force of the chest compression, including distorted checkerboard dark and light portions (e.g., distorted dark portion 206), which are more squarely shaped in the initially shaped flexible structure 202a, but more distorted in the deformed flexible structure 202b. The application of the compression force causes stretching and deformation of the flexible structure, which is evident from the resulting visible distortion of the checkerboard pattern. Additionally, in the depicted example, a portion of the left-most border 208 of the deformed flexible structure 202b can be seen to be distorted from the application of the force, relative to relatively linear corresponding portion of the left-most border of the undeformed flexible structure 202a, which is a further indication of a change of the shape of the flexible structure due to the application of the chest compression force.

As described herein, in some embodiments, the deformation of the flexible structure results in deformation of capacitive cells of the flexible structure, which may include, for example, changes to the surface area (including of electrode layers) and thickness (including of dielectric layers between electrodes) of particular capacitive cells. This deformation of capacitive cells may result in changed capacitance values associated with the particular cells. In some embodiments, these changes in capacitance values are determined and used in modeling to estimate a shape deformation of the flexible structure, relative to the initial shape 202a. This, in turn, may be used to estimate the deformed shape of the deformed flexible structure 202b, such as by applying the estimated shape deformation to a stored approximation of the undeformed shape (e.g. a shape of the chest before the chest compression). Since the changes in capacitance values of capacitive cells may bear a complex relationship to the corresponding shape deformation of the flexible structure, according to embodiments described herein, computational models, including machine learning models, may be used to most accurately estimate the corresponding shape deformation, providing solutions to technical problems associated with estimating shape deformation, and estimating the deformed shape, of the deformed flexible structure and of the patient's chest, for example.

In the example depicted in FIG. 2, since the shape of the applied flexible structure 202a (or a portion thereof) may reflect the shape of the chest of the patient (or a portion thereof), the shape of the deformed flexible structure 202b may be used to model and track the shape of the chest of the patient. The shape deformation of the flexible structure can be estimated frequently over a period of time, thus can effectively be tracked, such as over a compression period and a release period for each CPR chest compression cycle. This, can be used, for example, in providing data, representations of the chest deformation, or values indicative of the chest shape alignment of the deformed chest in comparison to a desired chest shape that can be used, for example, to provide feedback, such as informational feedback or corrective feedback, or instructions or to the CPR provider, which can, for example, guide the care provider in optimizing parameters of the CPR chest compressions (e.g., rate, depth, force or angle), or provide data to allow the CPR provider to optimize such parameters in order to achieve a target chest deformation shape. For example, if the compression depth is too deep or shallow, the feedback or corrective feedback may provide a visual illustration of each applied compression along with an instruction to increase or decrease depth, or a visual indication of an optimal depth may be provided, so that the care provider can better optimize the depth of a later compression. For example, at the end of a compression phase of a CPR chest compression, an image may be displayed. The image may show an estimated deformed shape of the chest, including the deformation, of a particular depth, caused by the compression, along with a marking, such as a line or bar, indicating a target depth range, which may be higher or lower (more shallow or deeper) than the actual depth. Many other types of output can be provided for use in or with many other uses and types of medical treatments, as described herein.

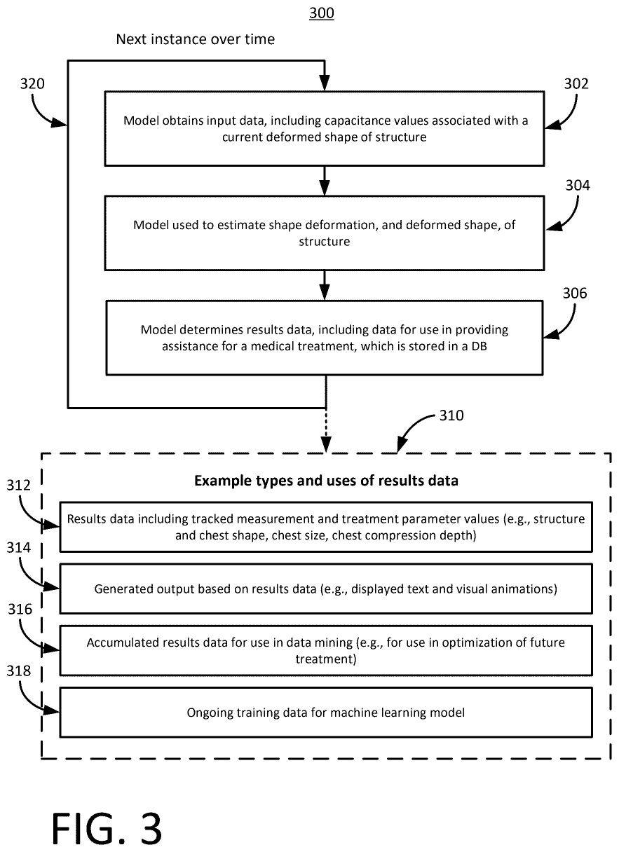

FIG. 3 is a diagram 300 illustrating an example including use of a computational model, such as a machine learning model, in tracking the three dimensional deformed shape of a structure, such as a flexible structure, as well as various uses of results data. The depicted method includes steps 302-306. In various embodiments, machine learning models of various types, and using various types of algorithms and computational techniques, may be utilized, such as in estimating shape deformations and deformed shapes, as well as during training. For example, in various embodiments, computational techniques or models may use linear regression, polynomial interpolation, Delaunay triangulation, unsupervised learning, or supervised learning, among others. In some embodiments, a particular type machine learning model may be selected based on various factors including characteristics of the flexible structure or its components, the computerized system or its components, or particular expected uses and applications. Machine learning models may be stored on a computerized system and may require large amounts of memory for storage, such as during training, such as, e.g., megabytes, gigabytes or terabytes. In some embodiments, a machine learning model is trained prior to use with a patient, such as in a lab setting, for example, although, in some embodiments, additional training may be performed using data obtained over or between uses with patients.

At step 302, the model obtains or receives input data to the model, including capacitance values associated with a current, particular deformed shape of the structure. This may include, for example, capacitance values associated with capacitive cells of the structure in the deformed shape existing at a particular point in time during the providing of a CPR chest compression, where the deformation may result from a chest compression being provided.

At step 304, the model is used in estimating a shape deformation, and in estimating the three dimensional deformed shape of the structure at the current time. This may include or require, for example, estimating the change in the deformed shape relative to an undeformed shape, or relative to one or more different deformed shapes, or both. As described in detail herein, various additional data may be used in making the estimation, including, for example, stored data providing an approximation of the actual undeformed shape, and capacitance values associated with capacitive cells of the flexible structure in the undeformed shape. The estimated shape deformation, and estimated deformed shape, of the flexible structure may reflect the estimated shape deformation, and the estimated deformed shape, of the portion of the surface of the patient's body to which the flexible structure is applied.

At step 306, the model is used to determine results data, including data for use in providing assistance, such as feedback, corrective feedback or instructions, associated with a medical treatment, such as a medical treatment being performed on a patient by a care provider. Step 306 may also include storage of the results data, such as to a memory or a database, although, in some embodiments the results data may be used immediately and not stored for later use. For example, the database may be stored, or partially stored, in a computerized system that also includes the stored model, or elsewhere, such as remotely. Furthermore, in various embodiments, the model itself may be stored on the computerized system or elsewhere, such as remotely.

Results data may include, for example, estimated shape deformation data and estimated deformed shape data for a flexible structure and a patient. Additionally, results data may include parameters determined based on estimated shape deformation data or estimated deformed shape data (e.g., depth or angle of a chest compression, as described further herein). Results data may include tracked estimated shape deformation data and tracked estimated deformed shape data over time, which may include data for many different deformed shapes. Furthermore, in some embodiments, results data may include accumulated tracked data for multiple uses of a flexible structure with multiple patients.

In some embodiments, output may be determined and presented, or determined, stored and presented, and may include, for example, displays, text, images, video or audio, at least a portion of which is based at least in part on results data. For example, output may include images reflecting a tracked deformed shape (where a tracked shape deformation or a tracked deformed shape can include a tracked estimated shape deformation or a tracked estimated deformed shape). Furthermore, output may include instructions or corrective feedback to a care provider based on a determined parameter (e.g., output may include, based on a determined chest compression depth that is outside of an optimal depth range, displayed text instructions to the care provider to increase or decrease the depth of provided CPR chest compressions).

Arrow 320 represents a return of the method to step 302, where the method repeats for the next instance of the structure over time. For example, in some embodiments, the method, including steps 302-306, is repeated very frequently, such as at a rate, which may reflect a sampling rate, of intervals of 8 milliseconds (ms) (or, e.g., in ms, 0.5-1, 1-2, 2-4, 4-6, 6-8, 8-10, 10-12, 12-20, 20-50, 50-100, 100-200 or 200-500), with processing to determine each new estimated deformed shape occurring, for example, at least as fast as the sampling rate interval. It is noted, however, that, in some embodiments, much slower sampling rates may be used. For example, in applications in which a flexible structure may be worn over a period of seconds, minutes, hours or days, and in which battery power may be used, much slower sampling rates may be used, which may help extend battery life per charge. In some such embodiments, sampling rates on the order of seconds, minutes, hours, or even days might be used. Additionally, it is noted that, in some embodiments, an entire deformed shape of a flexible structure may not be tracked, but only a portion thereof, as may be needed for the particular application, which may allow faster sampling rates. For example, in a CPR chest compressions application, it may only be necessary to track the deformed shape of the flexible structure corresponding with the portion of the patient chest that is deformed by the chest compressions, or even only a portion thereof, such as may be necessary to track one or more particular parameters (e.g., compression depth). When less than an entire deformed shape of the flexible structure is tracked, less processing may be required and, as such, a faster sampling rate (that is, with a shorter interval) may be possible. Additionally, in some embodiments, capacitances for particular capacitive cells may be determined at a faster sampling rate than others, so that deformed shape, in the area of such cells, may be tracked at a faster sampling rate. This may apply, for example, to capacitive cells associated with a portion of the patient's body of particular interest during a medical treatment (e.g., in CPR chest compressions, the patient's chest or a portion thereof).

Repeated performance of steps 302-306 allows tracking of the changing deformed shape of the flexible structure, which may reflect the changing deformed shape of the portion of the patient's body to which the flexible structure is applied. Since the deformed shape of the patient's body may be changing over time, the tracked deformed shape of the patient's body may include many different particular deformed shapes. Data representing the tracked deformed shape of the patient's body, as well tracked parameters determined based on the tracked deformed shape (e.g., tracked CPR chest compression depth), may be stored as results data.

This results data may then be used in generating output, which output may be at least in part based on the results data. The output may be used in providing assistance, such as image based corrective feedback or instructions, associated with a provided medical treatment, as described herein.

Blocks 312-318 provide some of many possible examples of particular uses and applications of the results data. Block 312 represents results data representing tracked measurement and treatment parameter values, which may relate, for example, to the portion of the patient's body, the medical treatment, or both. For example, for a CPR chest compressions application, such parameters may include the tracked deformed shape of the patient's chest as well as tracked chest compression parameters, such as compression rate force, depth or angle. In different medical care applications, results data may include many different parameters.

Block 314 represents generated output based at least in part on results data. This output may include, among other things, visual output for presentation to a care provider providing a medical treatment. This may include, for example, displayed text, a displayed animated representation of a tracked shape deformation of the portion of the patient's body, or a displayed animated representation of one or more aspects of the provided medical treatment, such as an animated representation of provided CPR chest compressions.

Block 316 represents accumulated results data for use in data mining, for example. In some examples, the accumulated data may be used in analyzing patient physiological response aspects, medical treatment device operation aspects, or care provider conduct aspects, in connection with the provided medical treatment, such as to optimize aspects of these in future applications to other patients, for example.

Block 318 represents use of accumulated results data as additional training data to further train a machine learning model, or other computational model, for example.

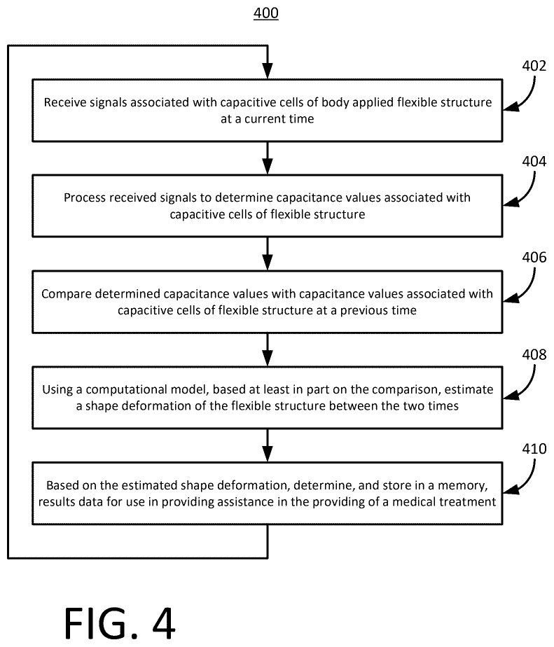

FIG. 4 is a flow diagram illustrating an example method 400 including use of capacitive cell signals from a flexible structure in tracking a three dimensional deformed shape of the flexible structure, and generating associated results data.

At step 402, signals, such as electrical signals, associated with capacitive cells of a body applied flexible structure at a current time, are received, such as by a computerized system electrically coupled with the flexible structure, or, in other embodiments, for example, by a remote computer or computerized system that receives data, which may include data regarding the signals, such as via one or more wired or wireless communications networks.

At step 404, the received signals are processed to determine capacitance values associated with capacitive cells of the body applied flexible structure at the current time. At step 406, the determined capacitance values are compared with capacitance values associated with capacitive cells of the flexible structure at a previous time. At step 408, using one or more computational models, based at least in part on the performed comparison, a shape deformation in the three dimensional shape of the flexible structure is estimated from the current time to the previous time, such as by the computerized system. Although method 400, at steps 406 and 408, includes comparison of capacitance values, in some embodiments, this comparison may not be performed or needed to estimate a shape deformation. For example, in some embodiments, a computational model may use the capacitance values associated with the capacitive cells of the flexible structure in a deformed shape to determine an associated shape deformation based on the capacitance values but without comparing them to the capacitive values of the flexible structure in a different shape. Furthermore, it is noted that, in some embodiments, only a portion of a shape deformation or deformed shape may be determined, or only particular aspects thereof as may be required to determine a particular parameter (e.g., depth of a chest compression resulting from a deformation). In such embodiments, method 400 may include, for example, only comparisons of some of the capacitive cells, and only estimation of part or aspects of a shape deformation or a deformed shape.

At step 410, based at least in part on the estimated shape deformation, results data is determined and stored in a memory, such as may include being stored in a memory of a database, for use in providing assistance in the providing of a medical treatment, such as to a care provider or other person, whether locally or remotely.

FIG. 5 is a diagram 500 illustrating an example including use of a trained machine learning model 502 in tracking a three dimensional deformed shape of a flexible structure, generating results data and presenting associated output.

As represented by block 526, capacitance data for a flexible structure in a current deformed shape is input to the trained machine learning model 502. This may include, for example, capacitance values associated with each of at least a portion of the capacitive cells of the structure. The machine learning model 502 may send and receive data to one or more databases 512.

The machine learning model 502 may receive, as input, other data such as training data 514. The training data 514 may include, for example, data 516 relating to various different deformed shapes of the flexible structure, which may include, for each, capacitance values 518 associated with capacitive cells of the flexible structure as well as three dimensional shape data 522 reflecting the deformed shape of the flexible structure, and may include other data.

Blocks 503-510 represent method steps that may be performed in some embodiments. At step 503, the method includes determination of displacements of vertices of a deformed shape of the structure, relative to an undeformed shape of the structure, such as by a computerized system coupled with the structure. In other embodiments, however, the determination may be made relative to a different deformed shape of the structure.

In some embodiments, step 503 includes determining specific three dimensional displacements of each of a set of vertices, such as relative to a polygon model based stored estimation of the undeformed structure, and applying the determined particular displacements to the particular associated vertices to determine the vertices of the deformed structure.

At step 504, the method 500 includes determination of vertices of the current deformed shape of the flexible structure. For example, as further described herein, in embodiments that use polygon modeling in shape representation, the vertices are polygon vertices of the polygon modeled shape representation, and determination of a vertex may include determination of a three dimensional location of the vertex relative to the flexible structure as a whole. In such embodiments, the vertices are not determined to reflect locations of capacitive cells.

The location of the vertex may be provided relative to other vertices, in a point cloud of all vertices that may not indicate absolute locations vertices in three dimensional space. For example, movement of particular vertices in the three dimensional coordinates of the flexible structure can be accurately tracked, irrespective of the movement of the entire flexible structure through space, such as may include translational or rotational movement (e.g., as may occur during patient transport in an ambulance or on a stretcher, etc.).

As illustrated by simplified image 528, based on the determination of the vertices, a point cloud of vertices may be modeled that represents vertices of a polygon model of an estimated three dimensional shape of the current deformed structure, where the point cloud specifies, or can be used to determine, the location of each vertex relative to each of the other vertices. Curved edge 542 is a simplified, conceptual illustration of a potential shape deformation of the structure, such as may result from application of force in connection with the providing of a medical treatment to the patient 536. The shape of curved edge 542 is only intended to be suggestive of a deformation and is not intended to accurately represent the shape of an actual example shape deformation.

At step 506, the method 500 includes determination of a full estimated deformed shape of the three dimensional shape of the structure, as illustrated by simplified image 530. In some polygon modeling based embodiments, this may include mathematical representations of planes, forming two dimensional polygons, that connect vertices, such that a continuous and complete estimated modeled three dimensional shape may be established. It is noted that, in various embodiments or examples, various numbers of vertices may be determined and utilized in the polygon model. It is noted, however, that some embodiments may include estimation of a point cloud for a deformed shape, such as a point cloud of vertices of the deformed shape, but not include determining the full deformed shape. For example, in some embodiments, results data, such as may including determination of one or more parameters (e.g., in CPR chest compressions, parameters such as compression force) may be determined based on the point cloud, without requiring estimation of the full deformed shape. Additionally, in some embodiments, only a portion of the deformed shape may be estimated, as may be needed for a particular application, and other portions may not be estimated or may be estimated only in part.

In some embodiments, determination and use of a larger number of vertices may result in a more accurate estimated three dimensional shape of the structure. However, use of a smaller number of vertices may allow for faster shape estimation, such as by requiring less computation. Furthermore, in some embodiments, the number of vertices may be selected or set by a person, such as a care provider, such as via a provided display or GUI including an associated setting, may be determined using one or more algorithms, This may reflect, for example, a balance between required speed and required accuracy. This balance may take into account various factors, such as the type or urgency of the care scenario, type or speed of the medical treatment, factors or needs relating to the patient 536 or care provider 534, or other factors. In some embodiments, determination of such optimal balances provides solutions to technical problems, for example, relating to providing optimal assistance with a medical treatment via output relating to results data, while meeting other requirements that may relate, for example, to requirements relating to speed and accuracy. Additionally, in some embodiments, the density of determined vertices may be non-uniform throughout the flexible structure, and may be greater for a portion of the flexible structure where more greater resolution is needed, such as a portion corresponding to a portion of the patient's body of particular interest to track (e.g., in CPR chest compressions, the patient's chest or a portion thereof).

Although, in FIG. 5, the example of polygon modeling is used, in various embodiments, many other different types of modeling and modeling algorithms may be utilized. In such other embodiments, optimized balances may be performed and utilized, such as may include balances between model parameters or parameter settings and required speed or simplicity. For example, in some embodiments, particular model parameters may be set higher to lead to greater accuracy or precision but lower to lead to greater speed.

At step 508, results data 532, which may include tracked shape data and tracked parameter data based on tracked shape data, for example, is determined for use in providing assistance, such as corrective feedback or instructions for use by the care provider 534 providing the medical treatment to the patient 536, for example.

At step 510, output, such as may be determined based at least in part on the results data, is presented, such as on a display or GUI, such as for use by one or more care providers. For example, in a CPR chest compressions application, the output may include CPR parameter values and associated corrective feedback, e.g., a visual indication of a current compression depth and a visual indication of an optimal compression depth, or instructions to increase or decrease depth of further compressions to approach or meet an optimal depth. As depicted, some examples of output devices may include computer or tablet computer displays 538, smartphone displays 540, or other types of displays or presentation devices, such as wrist-worn, head-worn or other wearable or otherwise body-coupled devices, for example.

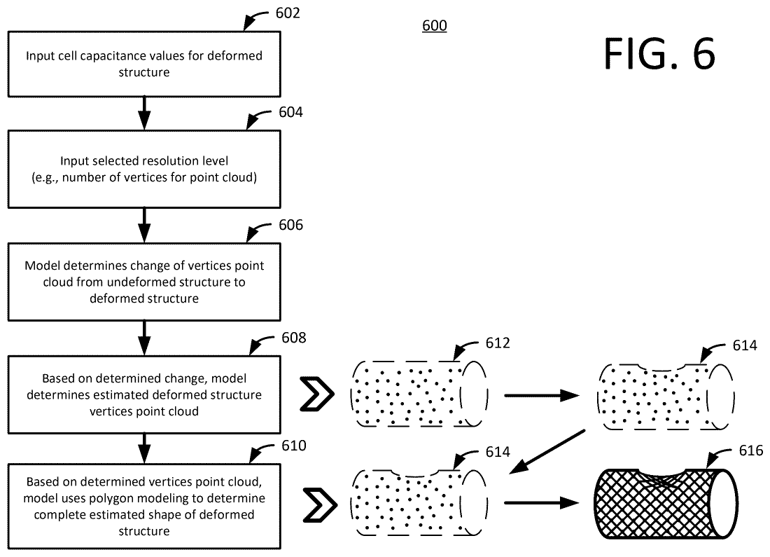

FIG. 6 is a flow diagram illustrating an example method 600 including use of a computational model in using capacitance values to model an estimated three dimensional shape of a deformed structure, using polygon modeling.

At step 602, cell capacitance values for the deformed shape are input, such as to a computational system. At step 604, a resolution level is determined, selected or input, such as by a care provider proving a medical treatment to a patient or automatically by a computerized system. For example, in an embodiment using polygon modeling, the resolution level may determine or correspond with a number of vertices used. At step 606, a computational model is used in determining a change of a vertices point cloud from an estimation of the shape of the undeformed structure to the estimated shape of the deformed structure.

At step 608, based on the determined change, the model is used to determine a point cloud associated with the deformed shape, as illustrated by simplified images 612 and 614, where image 612 provides a simplified illustration of a vertices point cloud of the undeformed shape, and image 614 provides a simplified illustration of a changed and different vertices point cloud associated with the estimated deformed shape.

At step 610, based on the determined vertices point cloud associated with the deformed shape, the model estimates a full shape of the deformed structure. This is illustrated by simplified images 614 and 616, where image 616 provides a simplified illustration of the full estimated digitally represented estimated deformed shape, and is determined based at least in part on the determined vertices point cloud of the deformed shape.

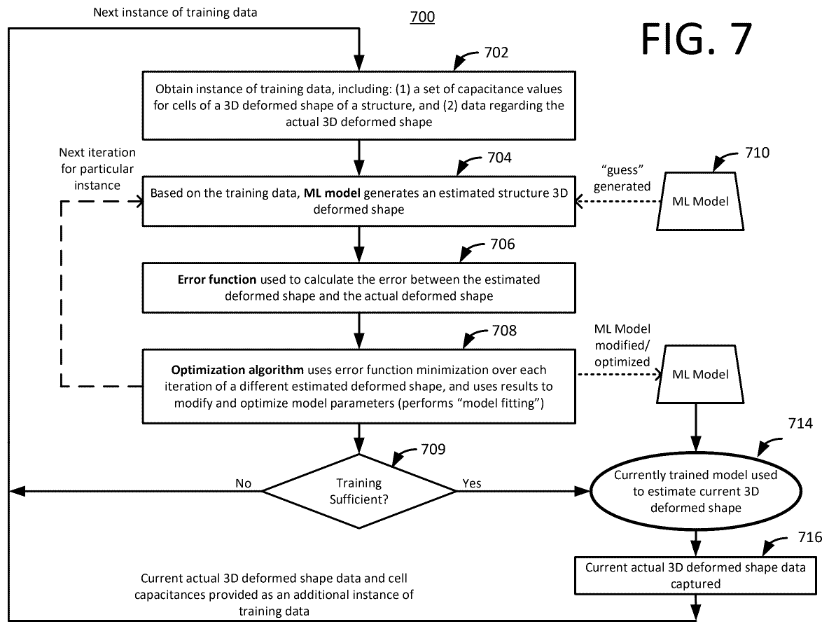

FIG. 7 is a flow diagram illustrating an example method 700 including use of a machine learning model 710 and training data in estimating a three dimensional deformed shape of a flexible structure. At step 702, instances of training data are obtained, such as by a computerized system, in which each instance may include: (1) a set of capacitance values for capacitive cells of a three dimensional deformed shape of a structure, and (2) data regarding the actual three dimensional deformed shape.

It is noted that, in various embodiments, various types of machine learning models may be used, including, for example, models that use supervised or unsupervised learning (as well as computational models that do not use machine learning). Method 700 includes exemplary steps that may be used with some examples of machine learning models that can be used in some embodiments, but many other models and methods may be used.

In some embodiments, training data can include data regarding an undeformed shape of the structure, as well as data regarding many different deformed shapes of the structure. In some embodiments or examples, for a given shape, the data may include a set of capacitance values for all or a portion of the capacitive cells of the structure in a particular shape, as well as data providing an approximation of the actual shape of the structure in that particular shape.

However, in some embodiments, various additional data may be included for each shape or some of the shapes, or generally for the particular flexible structure. In some embodiments, when additional data is provided, the machine learning model may use the additional data to better model train and optimize using the additional data. For example, in addition to the foregoing described data, additional data may be provided such as data regarding the locations of at least some of the capacitive cells relative to at least some of the other capacitive cells or data regarding an arrangement or pattern of capacitive cells.

As another example, additional data may be provided that specifies or models physical, mechanical, structural or material properties of the structure, which may be of use in modeling shape deformations and deformed shapes. For example, such additional data may reduce errors and increase the accuracy of deformed shape estimations. For example, this may be the case for particular new deformed shape estimations for which such additional data may provide a particular advantage in increasing the accuracy of the deformed shape estimation, relative to the use of training data without the additional data.

In various embodiments, various types and amounts of such additional data may be provided, and machine learning models of various types may be used so as to utilize such data to optimize the model for application in estimating new deformed shapes, for example. In some embodiments, providing such additional data may increase the accuracy of estimations, but omitting such additional data may allow for greater speed. Some embodiments include determining an optimal amount of such additional data for use, for example, taking into account a balance between accuracy and speed, which may in part depend on the specifics and requirements of a particular use as well as what particular additional data may be available. Such embodiments may thereby provide technical solutions to problems including making such determinations for optimizing model performance.

Steps 704-708 represent example steps of an iterative method that may be used in some embodiments and with some machine learning models. At step 704, based at least in part on the training data, the machine learning model 710 is used to generate an estimated three dimensional shape of a structure, such as a flexible structure. At step 706, an error function is used to calculate the error, which may quantitatively specify a difference, between the estimated deformed shape and the actual deformed shape. At step 708, for the current iteration (and for each subsequent iteration), an optimization algorithm is used that uses error function minimization over each iteration of different estimated shapes, and uses the results to modify and optimize model parameters, which may be called model fitting. This iterative process may be used, over a particular number of iterations, to model fit to produce increasingly more accurate shape estimations, and to fit the model to lead to improved model performance for future deformed shape estimations.

At step 709, the method 700 queries whether the training is sufficient. If “no,” then the method 700 returns to step 702 for the next instance of training data. If “yes,” then the method proceeds to step 714. The determination of how much training is sufficient may vary, such as based on available training data, or based on a particular use. Generally, more training data may increase the time and computational burden of training, such as by requiring large amounts of storage space (e.g. gigabytes to multiple terabytes), but may lead to greater accuracy in estimations. In some embodiments, a determination of a sufficient amount of training may be made based on a balance of speed and accuracy for the particular use.

At step 714, the currently trained model is used to estimate a current three dimensional deformed shape, such as of a deformed flexible structure. At step 716, the current actual three dimensional shape is captured and may be stored, such as in a database. In various embodiments, capturing of the current actual three dimensional shape can be accomplished in various ways and by various devices, including, for example, three dimensional scanning (e.g., three dimensional laser scanners, time-of-flight (ToF) sensors, photogrammetry or others), contact probes, or three dimensional surfaces that may be, for example, applied or pressed against the flexible structure. For example, three dimensional scan data may include triangulation data, scan based point clouds or ToF sensor measurements. In various embodiments, such devices may or may not be built into the flexible structure itself. The captured current actual shape data, as well as determined capacitive cell capacitances with the structure in that shape, are used to provide additional training data that can be used for additional model fitting. In some embodiments, an actual deformed shape of the flexible structure, as well as an actual undeformed shape of the flexible structure, may be reflected by data that represents a model that approximates the actual shape. This may include, for example, the use of polygon modeling or other techniques. It is noted, however, that, in some examples, such approximations of shapes may be based on data that reflects the actual shape (e.g., based on scanned actual shape data), rather than based on an estimation of a shape without actual shape data.

FIG. 8 is an illustration 800 of an example network 802 of capacitive cells and associated capacitance measurements. In the depicted embodiment, the network of capacitive cells is arranged in a grid type pattern, including rows 810, labelled 1-7, and columns 812, labelled A-G. Each row or column of capacitive cells may be called a “strip.” The group of capacitive cells of each strip may be electrically interconnected in what may be called a “trace.” Capacitance associated with a particular trace can be measured, such as by use of an electrically coupled computerized system. In some examples, when capacitance is measured for a row trace and a column trace, the resulting capacitance measurement represents, or approximately represents, the capacitance associated with the single capacitive cell at the intersection of the row trace and the column trace. For example, as depicted, a capacitance 804 is measured for the row 2 trace, and a capacitance 806 is measured for the column C trace, providing the approximate capacitance for individual capacitive cell 814 the makes up the intersection portion of row 2 and column C. As such, capacitance, or approximate capacitance associated with capacitive cell 814 can be determined without direct, individual measurement of the capacitance of capacitive cell 814 individually. As described further herein, in some embodiments, determining capacitances associated with at least some capacitive cells using traces, as opposed to individually, can provide substantial advantages, including speed and simplicity advantages, over using, or over only using direct, individual capacitive cell capacitance measurements.

Although the example of FIG. 8 includes use of a square grid arrangement of capacitive cell, in other embodiments, as described herein, other arrangements are possible, including other patterns. Where different patterns of capacitive cells are used, various multiplexing arrangements and methods may be used, including different groupings of capacitive cells for particular traces may also be used (e.g., not just row or column), and different combinations and numbers of traces may be used in determining capacitances for individual capacitive cells.

In some embodiments, physical vertical layers of the network of capacitive cells are used in providing different sets of electrical connections between capacitive cells. For example, one vertical layer may include connections between columns of capacitive cells, while another layer may include connections between rows of capacitive cells. In some embodiments, the layers may be electrically connectable during use, so that a measurement of capacitance can be made, for example, including a particular column and a particular row together. In some embodiments, permanent connections may be provided between particular such layers.

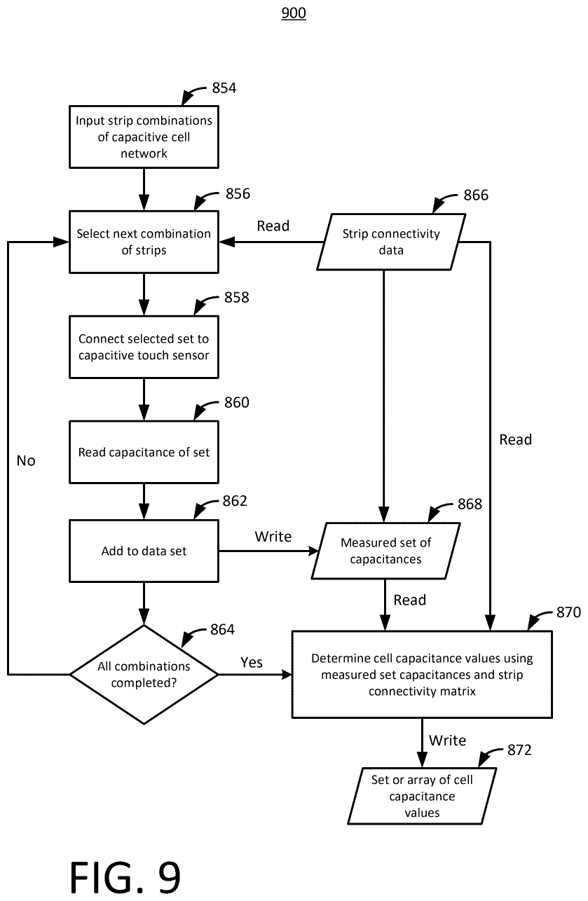

FIG. 9 is a flow diagram 900 illustrating an example method including determination of capacitance values for a network of capacitive cells of a flexible structure, such as the network of capacitive cells as depicted in FIG. 8.

In the depicted method 900, data is used that includes input strip combinations data 854. Continuing the example based on the capacitive cell network of FIG. 8, the strip combinations data 854 may include all row and column pairs of the network of capacitive cells.

Furthermore, strip connectivity data 866 is used. The strip connectivity data 866 may specify the locations of each of the capacitive cells of the network, such as the row and column of each, and may specify the interconnected capacitive cells of each row and column strip. The strip connectivity data 866 may be used in determining which strip capacitances must be measured in order to determine a capacitance associated with a particular individual capacitive cell capacitance (which can include an approximate capacitance).

Continuing the example of FIG. 8, steps 856-864 may be performed for each of the row and column combinations of the network, as specified by the input strip combinations data 854. The strip connectivity data 866 may be used in specifying which combinations are used in determining capacitances associated with particular individual capacitive cells (e.g., for capacitive cell 814 of FIG. 8, the row 2 and column C pair may be used).

At step 856, the next (or first) combination of strips is selected. At step 858, the selected set of strips is connected to a capacitive touch sensor for sensing a capacitance associated with the connected strips. At step 860, the capacitance associated with the selected set of strips is determined based on the sensed capacitance. At step 862, data representing the determined capacitance is added to stored measured capacitance data 868. Steps 856-862 are performed until completed for each combination.

At step 864, if other combinations remain, then the method 900 returns to step 856 for the next combination. If all combinations are completed, at step 870, using the measured capacitance data 868 and the strip connectivity data 866, capacitance values associated with each of the capacitive cells are determined and stored as a set or array of cell capacitance values 872. Continuing the example of FIG. 8, the row 2 and column C strip combination may be used to determine a capacitance associated with capacitive cell 814, and capacitances associated with other capacitive cells may be similarly determined using appropriate row and column strip combinations.

Once the method 900 is completed so that capacitance values for each of the capacitive cells of the network is complete, this data may be used, as described further herein, in estimating an associated shape, such as a deformed shape, of the flexible structure including the network of capacitive cells.

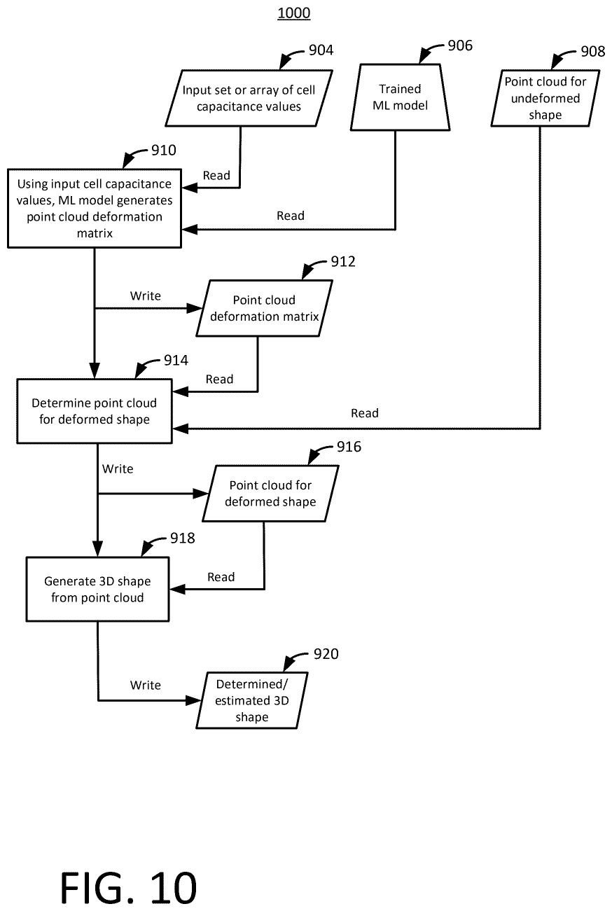

FIG. 10 is a flow diagram illustrating an example method 1000 including use of a machine learning model in determination of an estimated three dimensional shape, such as a deformed shape of a flexible structure. At step 910, using an input set or array of cell capacitance values 904 (such as, for example, the set or array of cell capacitance values 872 as depicted in FIG. 9), a trained machine learning model 906 is used in generating a point cloud deformation matrix 912, which is stored.

At step 914, using the trained machine learning model 906 or one or more other algorithms or computational models, the point cloud deformation matrix 912 is used, along with data 908 representing a point cloud 908 for an undeformed shape, such as an undeformed shape of the flexible structure, in determining a point cloud 916 for the deformed shape. In some embodiments, as described further herein, the point cloud deformation matrix 912 may specify displacements for each of the points of the point cloud 908 for the undeformed shape to be applied to arrive at the point cloud 916 for the deformed shape. Once applied, the point cloud 916 for the deformed shape is determined and stored.

The trained machine learning model 906 is used in determining the particular displacements for arriving at the point cloud 916 for the deformed shape from the undeformed shape, based on data including the set or array of capacitance values for the capacitive cells associated with the deformed shape. If polygon modeling is used, the point clouds 908, 912 may represent vertices in a polygon modeled shape representation.

At step 918, using the trained machine learning model or one or more other algorithms or computational models, a full three dimensional shape 918 is generated based on the point cloud 916 for the deformed shape, and stored as an estimated shape of the deformed shape 920. If polygon modeling is used, this may include storing a representation of the estimated deformed shape in which two dimensional polygons are used, with point cloud vertices forming polygon vertices, for example.

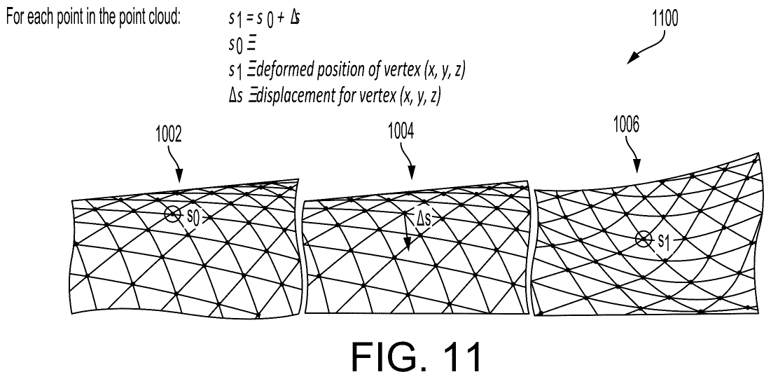

FIG. 11 is an illustration of an example of determination of displacement of a vertex, of a vertex point cloud, of a flexible structure, from an undeformed shape to a deformed shape, as might be used in some examples of the method 1000 as depicted in FIG. 10. The displacement can be given by the following equation

$${S}_{1} = {S}_{0} + Delta S \qquad ( Equation 2 )$$

Where.
S₁=three dimensional position of vertex in deformed shape
S₀=three dimensional position of vertex in undeformed shape
Delta S=three dimensional displacement vector of vertex from undeformed shape to deformed shape

As depicted, image 1002 shows an example of the vertex at position S₀ in a point cloud associated with the undeformed shape, image 1004 shows an example displacement vector (change in S), and image 1006 shows an example of the vertex at the position S₁ in a point cloud associated with the deformed shape. It can be seen that the vertex in the S₁ position is displaced relative to the vertex in the S₀ position, as given by the displacement vector (Delta S). By applying determined displacements to each point in a point cloud associated with the undeformed shape, a point cloud associated with the deformed shape can be generated.

FIG. 11 depicts determination of displacement of a vertex from an undeformed shape to a particular deformed shape. However, some embodiments and examples include determination of displacement of a vertex from a particular deformed shape (e.g., a first deformed shape) to another, different particular deformed shape (e.g., a second deformed shape), in a manner similar to the technique described in FIG. 11. For example, in such an instance, S₁ may be the three dimensional position of the vertex in the second deformed shape, S₀ may be the three dimensional position of the vertex in the first deformed shape, and Delta S may be the three dimensional displacement vector of the vertex from the first deformed shape to the second deformed shape.

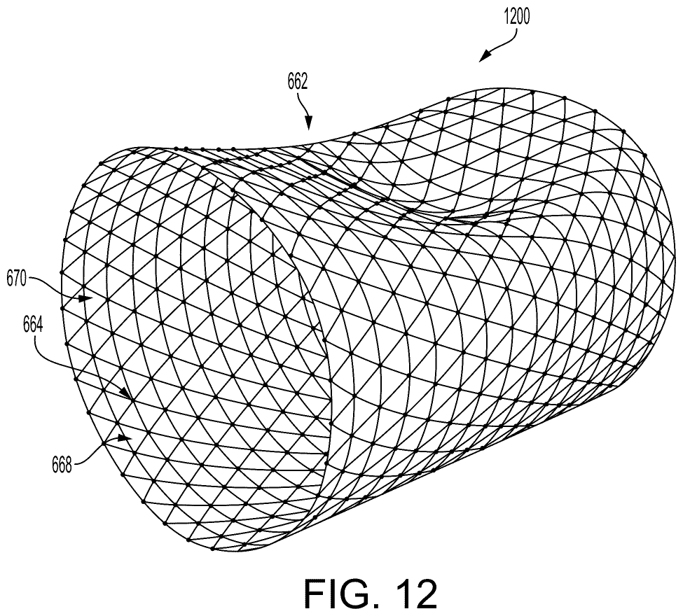

FIG. 12 is an illustration of an example of a complete estimated three dimensional deformed shape 1200 of a tubular deformed flexible structure including use of a polygon modeling technique, such as may be generated using the technique described with reference to FIG. 11. Each point at the intersection of the intersecting white line segments of the shape 1200, such as point 664, represents a vertex of the estimated deformed shape. The white line segments, such as line segment 670 represent edges, and the dark areas, such as dark area 668, represent two dimensional polygon surfaces, of the polygon modeled full estimated three dimensional shape.

In some embodiments, as described herein, calibration may be performed with regard to a flexible structure. Calibration may include, for example, determining capacitance values associated with each capacitive cell of a flexible structure in an initial or undeformed shape. In some embodiments, calibration data may be used in shape estimations or improving the accuracy of shape estimations, and may be used in data noise rejection.

FIG. 13 is a simplified illustration of example portions of a flexible structure, with and without vertical stacking of capacitive cells. For simplicity of illustration, the flexible structure is depicted as flat, although in various embodiments it may not be flat. Furthermore, only portions of a simplified example flexible structure are illustrated in the images 1800a-d. For illustrative purposes, FIG. 8 is described with reference to a set of three dimensional axes 1806 (X, Y and Z axes).

Simplified image 1800a illustrates a portion of a simplified flat flexible structure, in a perspective view. For purposes of illustration, a thickness of the 1802 of the flexible structure runs along the direction of the Z axis, a lower horizontal surface 1814 of the flexible structure is configured to be applied to a portion of the surface of the body of a patient (or to clothing or other covering on the patient, for example), and an upper horizontal surface 1804 may, in some embodiments, receive direct contact from a deforming force (e.g., the hand of person performing CPR chest compressions, or a surface of a device used in performing automatic CPR chest compressions, for example). Furthermore, in some embodiments, capacitive cells may be oriented in the flexible structure such that, for a capacitive cell, a top of the capacitive cell is vertically closer to the upper horizontal surface 1804 of the flexible structure than a bottom of the capacitive cell. Additionally, in some embodiments, the top of the capacitive cell may be at, or form a portion of the upper horizontal surface 1804 of the flexible structure, or the bottom of the capacitive cell may be at, or form a portion of the lower horizontal surface 1814 of the flexible structure.

As described herein, in various embodiments, one or more layers of patient clothing, adhesive or other covering may lie between the lower horizontal surface 1814 and the patient, the upper horizontal surface 1804 and the patient, or both. As depicted, the lower horizontal surface 1814 includes edge 1812 and the upper horizontal surface 1804 includes edge 1810. In the simplified illustration, both the upper horizontal surface 1804 and the lower horizontal surface 1814 lie in a plane that is parallel to a plane defined by the X and Y axes (the x-y plane). It is noted that, in the simplified images, dimensions are not drawn to scale. For example, in some embodiments, a thickness 1802 of the flexible structure may be very small (e.g., between 0.05-20 mm, as described in detail herein).

Simplified image 1800b shows a portion of the flexible structure in a cross-sectional view that would be defined by a plane running through the thickness of the flexible structure. The image 1800b includes a simplified example of capacitive cells of the flexible structure 1808. It is noted that image 1800b is not drawn to scale. For example, in some embodiments, thicknesses of the capacitive cells may be very small (e.g., between 0.05-10 mm, as described in detail herein).

In the example shown in image 1800b, there is no vertical stacking of capacitive cells 1808. Herein, an embodiment including vertical stacking of capacitive cells may include any embodiment in which different capacitive cells are positioned at different vertical levels relative to the thickness of a flexible structure, whether or not any capacitive cells are in fact positioned vertically over or partially over any other capacitive cells. In the example shown in image 1800b, all of the illustrated capacitive cells 1808 are positioned at or close to the middle of the thickness 1802 of the horizontal surface 1804 of the flexible structure, although in other embodiments, capacitive cells may be positioned at various levels along the thickness 1802 of the flexible structure. Furthermore, in various embodiments, surfaces of capacitive cells, such dielectric cover layers, may or may not form portions of the lower horizontal surface 1814 or the upper horizontal surface 1804 of the flexible structure.

Simplified images 1800c and 1800d show portions of a flexible structure in cross-sectional views that would be defined by a plane running through the thickness 1802 of the flexible structure. The embodiments depicted in images 1800c and 1800d include different variations of vertical stacking of capacitive cells 1814, 1816. In the variation shown in image 1800c, some depicted capacitive cells are positioned directly over others, while, in the variation shown in image 1800d, no depicted capacitive cells are located partially or directly over others. However, in both variations, vertical stacking is used, since different capacitive cells are positioned at different vertical levels along a thickness 1802 of the flexible structure.

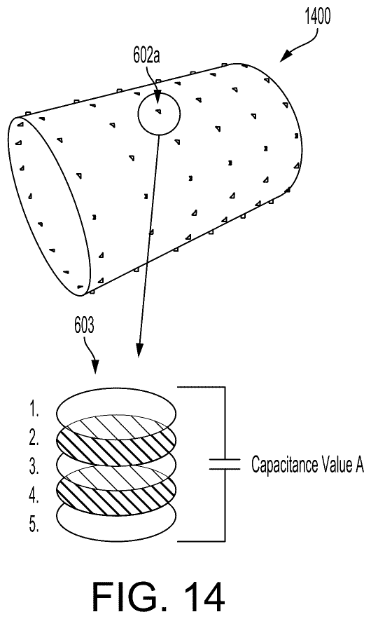

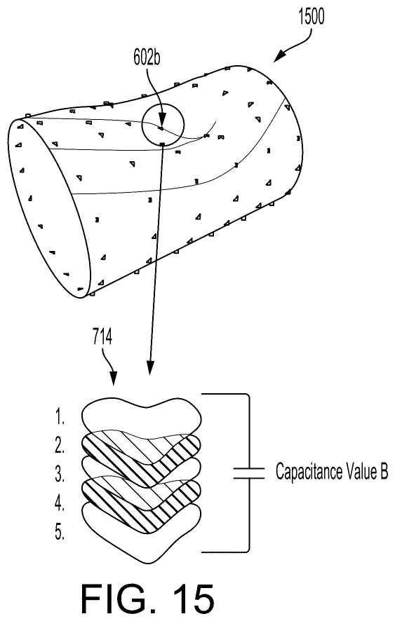

FIGS. 14-15 are illustrations examples of differently shaped capacitive cells of flexible structures, showing layers thereof. In some embodiments, each capacitive cell, such as of a network of capacitive cells of a flexible structure, may include multiple layers. For example, in some embodiments, a capacitive cell may be made of up of at least three layers, including a dielectric layer between conductive layers, where, in this three layer type of capacitive cell, the conductive layers form top and bottom layers which are electrode layers. As such, a capacitive cell of this type may include three layers, from top to bottom, of: (1) first conductive layer; (2) dielectric layer; (3) second conductive layer. In such a three layer example, the first conductive layer forms the top layer (e.g., which may be closest to the upper horizontal surface 1804 of the flexible structure) and the second conductive layer forms the bottom layer. The conductive layers may be made of any of various conductive materials or compositions, such as silicone doped/impregnated with conductive carbon powder. The dielectric layer may be made of any of various dielectric materials or compositions, such as pure silicone. In some embodiments, a flexible structure, aside from the capacitive cell network, may be made of any of various flexible materials or compositions, such as silicone rubber.

As described herein, in various embodiments, a capacitive cell may have more than three layers, such as four, five, six, seven, eight, nine or more layers. For example, relative to a three layer capacitive cell as described above, a capacitive cell may have a fourth layer, which may be a dielectric layer, disposed on the first conductive layer and forming a top layer. In another example, a capacitive cell may have a fourth layer, which may be a dielectric layer, disposed on the second conductive layer and forming a bottom layer. In another example, a capacitive cell may have fourth and fifth layers, which may be dielectric layers, disposed on the first conductive layer and the second conductive layer and forming top and bottom layers. In some embodiments, having dielectric layers as top and/or bottom layers may provide an advantage in protecting the cell from unwanted capacitance changes, such as may be caused by an object, such as a care provider's hand or finger, touching or coming close enough to touching the conductive layer, and causing an unwanted capacitance change. On the other hand, in other embodiments, a top and/or bottom layer may be conductive, such as, for example, when touch or near touch capacitance changes are desired, such as when it is desired to detect touch or a nearby object that may cause a capacitance change, for example. Additionally, dielectric top and/or bottom layers may be included to protect the capacitive cell from damage, such as physical or chemical damage. Furthermore, thicker dielectric top and/or bottom layers may be included to provide greater protection against unwanted capacitance changes or damage to the cell, for example, but may have a disadvantage, for example, in increasing the thickness of each capacitive cell and of the flexible structure overall.

Still further, in some embodiments, a capacitive cell may have more than two conductive layers. For example, a capacitive cell may have a top conductive layer disposed over a dielectric layer, or a bottom conductive layer disposed over a dielectric layer, or both. For example, additional top or bottom conductive layers may be included for sensing of changes of capacitance resulting from nearby objects or touch. Still further, in various other embodiments, additional conductive or dielectric layers may be included, for various different uses requiring different capacitive cell physical, mechanical, electrical or sensing properties, for example.

In various embodiments, various methods may be used to form capacitive cell networks of flexible structures, which may include the layers that form each capacitive cell. Furthermore, in some embodiments, all of the capacitive cells may be created together or simultaneously. It is to be noted, however, that a flexible structure may include various other components, layers or materials, which may be included to increase practical aspects not necessarily related to sensing aspects, such as may serve to protect the overall flexible structure, make it easier to apply or be worn by a patient, etc. For example, in various embodiments, a flexible structure may be partly be made of various compositions, materials, fabrics, etc., which may, in some cases, cover or partly cover layers that include capacitive cells. For example, in some embodiments, such materials may be used to at least partly cover surfaces of, or even encapsulate, the flexible structure.

Methods to form capacitive cell networks may be chosen, for example, to ensure that layers have even thicknesses and are defect-free. In one example in which 5 layer capacitive cells are used, the following steps may be used. First, pure silicone is drawn across a flat carrier plate in an even thickness, such as by using a wire-wound rod, forming layer 1 (cover layer of capacitive cells). Next, layer 1 is cured, (whenever curing is used, it may include use of heat). Next, a first plastic mask is laid over layer 1. Next, conductive carbon doped silicone is drawn across layer 1, forming layer 2 (electrode layer of capacitive cells). Risers may be used on the sides of a carrier plate to determine the thickness of layer 2. Next, the first plastic mask is removed. Next, layer 2 is cured. Next pure silicone is drawn across layer 2, forming layer 3 (dielectric layer of capacitive cells). Next, layer 3 is cured. Next, a second plastic mask is drawn across layer 3. Next, conductive carbon doped silicone is drawn across layer 3, forming layer 4 (electrode layer of capacitive cells). Next, the plastic mask is removed. Next, layer 4 is cured. Next, pure silicone is drawn across layer 4, forming layer 5 (cover layer of capacitive cells). Finally, layer 5 is cured.

In various embodiments, various techniques may be used in ensuring that electrical connections are provided to allow measurement of capacitances associated with groups of capacitive cells and individual capacitive cells. In some embodiments, techniques are selected that allow for low impedance, low capacitance electrical connections. For example, in some embodiments, connections may be accomplished including use of production or fabrication techniques including use of pads, piercing techniques, snaps, rivets, welding or others. In some embodiments, elastomeric connectors may be used, such as in connecting capacitive cells to one or more electrical circuits or PCBs for use in measuring capacitance.

Various materials may be used in production or fabrication of a portion of a flexible structure including a network of capacitive cells. Various elastomeric materials may be used, but, in some embodiments, silicone is selected, given advantages in areas including tear resistance, electrical properties, and availability of particular biocompatible materials. In some embodiments, toluene is selected for uses including thinning of pure and doped silicone or other elastomeric materials, but, in other embodiments, other thinning agents may be used. In some embodiments, conductive carbon is utilized, such as carbon black, such as in powder or granular varieties, for example. In various embodiments, various thinners may be used, for example, for suspending carbon black powder during mixing, such as isopropyl alcohol or another compatible thinning agent.

In various embodiments, various compositions may be used for various capacitive cell layers. For example, for cover or dielectric layers, a 2:1 ratio by weight composition of silicone to toluene may be used. For carbon black doped silicone layers, a 1:1 ratio by weight of silicone to toluene and a 2:0.2 ratio by weight of isopropyl alcohol to carbon black may be used. However, in other embodiments, other compositions and ratios may be used.

In various embodiments, various techniques may be used, for example, for selectively placing or laying down of doped silicone for electrode layers. For example, some techniques include laying down a full doped silicone layer and then, after curing, laser etching away undesired portions of the doped silicone. Additionally, some techniques include use of a plastic mask to selectively place or lay down a doped silicone layer. Furthermore, some techniques include silk screening an electrode layer, which may allow for embedding layers into fabrics and onto other surfaces, such as flexible, deformable surfaces.

In some embodiments, a capacitive cell may include additional layers, however. For example, in some embodiments, a five layer capacitive cell may include a dielectric layer between electrode layers, along with top and bottom dielectric cover layers over the electrode layers. As such, a capacitive cell of this type may include five layers, from top to bottom, of: (1) top cover layer; (2) electrode layer; (3) dielectric layer; (4) electrode layer; (5) bottom cover layer. In some embodiments, the cover layers may be thicker than the other layers and may serve to, for example, seal or better seal the capacitive cell, protect the capacitive cell from environmental damage and prevent or mitigate unwanted coupled or parasitic capacitances associated with external objects. In some embodiments, the cover layers also serve to prevent unwanted contact or touch sensing. However, in some embodiments, one or both of the cover layers may include thin areas specifically to allow contact or touch sensing (and, touch sensitive capacitive cells may be located at or near the upper horizontal surface of the flexible structure). In other embodiments, capacitive cells may include additional layers, such as additional pairs of electrode layers and additional pairs of dielectric layers between cover layers, for example.

The electrode layers of a capacitive cell form a parallel plate capacitor. The capacitance of a parallel plate capacitor is given by the following equation:

$$C = {K}_{r} {K}_{0} ( A / d ) \qquad ( Equation 1 )$$

Where:
C=capacitance
Kᵣ=dielectric constant
K₀=electric constant
A=surface area of electrode
d=thickness of dielectric layer

In some embodiments, each capacitive cell is electrically coupled to a capacitive touch sensor, such as may be included in a touch sensor integrated circuit, whether directly or via one or more intermediate capacitive cells. When used for determining capacitances of capacitive cells and groups of capacitive cells for modeling and deformed shape estimations, for example, detecting human touch is not the object. However, in some embodiments, capacitive cells may also be configured to detect human touch. It is noted that, in other embodiments, capacitance may be measured differently than, and without use of, a touch sensor, such as may include use of a different type of capacitive sensor. Conductive paths between capacitive cells may, for example, be made of any of various conductive materials or compositions, such as silicone doped with conductive graphite, which, in some embodiments, may be the same material as the electrode layers of the capacitive cell itself.

In some embodiments, electrical connectors such as pins may be used to selectively connect and disconnect particular electrical connections, such as may relate to the electrical path between a capacitive cell or group of capacitive cells and measurement electrics of a coupled computerized system, such as may including one or more microcontrollers, touch sensor pins, PCBs and integrated circuits. A capacitance measurement (made regarding a capacitive cell or a group of capacitive cells) may include measuring an associated charge and discharge time. These times may correlate with a capacitance of an entire electrical path, for example, between measurement electronics, the capacitive cell or group of cells, and an electrical ground. In some embodiments, parasitic capacitance, or parasitic capacitance relative to the capacitance that it is desired to determine, is minimized, so that a measured capacitance value is as much as practical due to the capacitance that it is desired to determine, rather than due to parasitic capacitance. In some embodiments, when measuring a capacitance associated with a capacitive cell or group of capacitive cells of a network, other capacitive cells of the network may be connected to ground in order to protect against or mitigate noise. However, it is noted that, in some embodiments, some parasitic capacitances may be unwanted, but others may be desirable and therefore not noise. For example, it may be desirable for parasitic capacitances caused by nearby deformations to impact capacitances for capacitive cells, such as for machine learning training data including capacitance values for capacitive cells of a flexible structure in a particular deformed shape. Therefore, grounding of particular capacitive cells may depend on the specifics of a particular embodiment and use.

In various embodiments, and as further described herein, capacitive cells may have various different shapes and horizontal surface areas. In some embodiments, shape or size may be used at least in part to allow compatibility with capacitive touch sensor integrated circuits that may be selected for use. Furthermore, in some embodiments, shape or size of each capacitive cell may be selected to suit or optimize for one or more particular uses or applications, or anticipated uses or applications, or environmental or other conditions such as may accompany such uses or applications. For example, smaller size capacitive cells may be used when greater sensitivity to local displacements may be needed, but larger capacitive cells may be used for greater rest capacitance and for better protections against the impact of parasitic capacitance (given the greater rest capacitance), for example. In some embodiments, the size and shape of each capacitive cell may be optimized for the particular associated use or application. This may include embodiments in which all capacitive cells of a network of capacitive cells are of the same size and shape, as well as embodiments in which some capacitive cells are of a different size and shape than others.

In FIG. 14, a tubular flexible structure 1400 in an undeformed shape is shown, which includes a network of capacitive cells, including capacitive cell 602a. Lower image 603 shows a simplified depiction of layers of an example of a capacitive cell 602a in an undeformed shape, circular in horizontal shape and including five layers, numbered 1-5. These layers may include, from top to bottom: (1) top cover layer; (2) electrode layer; (3) dielectric layer; (4) electrode layer; (5) bottom cover layer. While the layers 1-5 are shown separated for illustration purposes, they are actually integrated and together make up the thickness of the capacitive cell 602, which may be much smaller than the horizontal radius of the circular capacitive cell 602.

In embodiment shown in FIG. 14, each layer is of the same horizontal shape and area. However, in some embodiments, some layers may be of different shapes or areas than other layers. For example, in other embodiments, conductive layers may differ from each other in horizontal shape or area. Additionally, in various embodiments, a dielectric layer between conductive layers may be of various flexural strength. Such variations in these regards may change the electrical properties of the conductive cell, and may lead to different capacitance changes caused by particular deformations of the cell. For example, for particular uses, particular variations in these regards may lead to more accurate shape estimations.

In FIG. 15, the tubular structure 1500 in a deformed shape is shown, as well as the capacitive cell 602b in a deformed shape. As can be seen in lower image 714, the five layers 1-5 of the capacitive cell 602b in the deformed shape reflect a different shape, which, relative to the capacitive cell 602a in the undeformed shape, is irregular rather than circular, and may have a different horizontal surface area (such as a larger surface area), and thickness (such as a smaller thickness). In some embodiments and examples, changes in conductive layer surface area (e.g., from stretching caused by deformations), rather than changes in the thickness of the dielectric layer between the conductive layers, may be the dominant driver of capacitance changes caused by deformations of capacitive cells. In the example shown, as a result of the deformation, the capacitive cell 602b in the deformed shape shown in FIG. 15 has an associated capacitance of Capacitance Value B (a particular capacitance value), which is smaller than Capacitance Value A (another particular capacitance value), which is the capacitance associated with the capacitive cell in the undeformed shape, as a result of the changes to the surface area of the electrode layers, and changes to the thickness of the dielectric layer between the electrode layers, caused by the deformation. It is noted that, in other embodiments and examples, a deformed capacitive cell may have a capacitance value that is either larger or smaller than that of the capacitive cell in an undeformed shape.

In various embodiments and uses, a capacitance value associated with a particular cell can vary (e.g., in pF, 5-10, 10-50, 50-100, 100-200, 200-500, 500-1,000 or 1,000-2,000). In some embodiments, anticipated capacitive cell capacitances may be selected to optimize based on, for example, a particular use, such as by providing more accurate estimates or determinations, which may include providing better data noise rejection, for the particular use. For example, capacitive cells used in shape deformation sensing may be selected to have capacitance ranges at or toward the middle or higher of the above listed ranges, whereas capacitive cells used in touch or nearly object sensing may be have capacitances at or toward the middle or lower of the above listed ranges. Furthermore, in some embodiments, some particular capacitive cells, or groups of capacitive cells, within a network of capacitive cells of a flexible structure, may be selected to have different capacitance ranges, based on uses and requirements specific to that particular group.

In various embodiments, the various layers of capacitive cells may have various thicknesses. In various embodiments, various thicknesses of capacitive cells and layers thereof may be selected for optimal performance, which may be influenced by a variety of factors, such as may relate, for example, to characteristics of the capacitive cells themselves, the network of capacitive cells, the flexible structure, the expected uses or applications, environmental conditions, or particular desired performance parameters. In some embodiments, such thicknesses may be determined, for example, to result in optimal flexural, deformation, physical or mechanical characteristics, particular coupled capacitance rejection requirements, or other factors.

In some embodiments, a dielectric layer may have a thickness of, for example, 90 micrometers (or, e.g., between 10 and 20 micrometers, between 20 and 30 micrometers, between 30 and 40 micrometers, between 40 and 50 micrometers, between 40 and 140 micrometers, between 60 and 120 micrometers, between 80 and 100 micrometers, between 85 and 100 micrometers, between 100 and 500 micrometers, between 500 micrometers and 1 mm, between 1 mm and 2 mm, between 2 mm, between 2 mm and 3 mm, between 3 mm and 4 mm, between 4 mm and 5 mm, or between 5 mm and 10 mm). In some embodiments, an electrode layer may have a thickness of, for example, in micrometers, of 45 (or, e.g., 30-70, 40-50, 43-47, 10-20, 20-30, 30-40, 50-10, 100-200, 200-300). In some embodiments, a cover layer may have a thickness of, for example, in micrometers, 180 (or, e.g., 50-200, 170-190, 177-183). In some embodiments, a capacitive cell (including all layers) may have a thickness of, in mm, 0.55 (or, e.g., 0.05-2.0, 2.0-3.0, 3.0-4.0, 4.0-5.0, 5.0-10, 0.1-1.0, 0.2-0.8, 0.3-0.7, 0.4-0.6 or 0.52-0.57). In some embodiments, a flexible structure (which includes capacitive cells) may have a thickness of, in mm, 0.55 (or, e.g., 0.05-2.0, 2.0-3.0, 3.0-4.0, 4.0-5.0, 5.0-10, 0.1-1.0, 0.2-0.8, 0.3-0.7, 0.4-0.6, 0.52-0.57, 0.5-1.0, 1.0-2.0, 2.0-3.0, 3.0-4.0, 4.0-5.0, 5.0-10.0, 10.0-15.0 or 15.0-20.0).

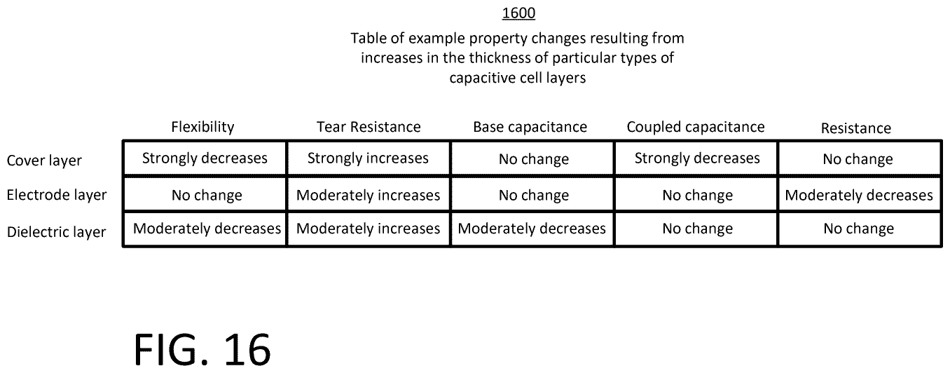

FIG. 16 is a table 1600 illustrating example property changes resulting from increases in the thickness of particular types of capacitive cell layers. For a cover layer, flexibility strongly decreases, tear resistance strongly increases, based capacitance does not change, coupled capacitance strongly decreases, and resistance does not change. As such, increasing the thickness of the cover layer may provide advantages in terms of tear resistance, but may result in reduced flexibility, which may render the capacitive cell more susceptible to damage resulting from deformation.

For a conductive layer with increased thickness, flexibility does not change, tear resistance moderately increases, based capacitance does not change, coupled capacitance does not change, and resistance moderately decreases. For example, increasing the thickness of the electrode layer may provide advantages, such as by providing increased tear resistance or increased electrical resistance, but may increase manufacturing cost.

For a dielectric layer, between conductive layers, with increased thickness, flexibility moderately decreases, tear resistance moderately increases, base capacitance moderately decreases, coupled capacitance does not change, and resistance does not change. As such, increasing the thickness of the dielectric layer may provide advantages in terms of tear resistance, but may result in reduced flexibility, which may render the capacitive cell more susceptible to damage, such as damage that may result from deformation.

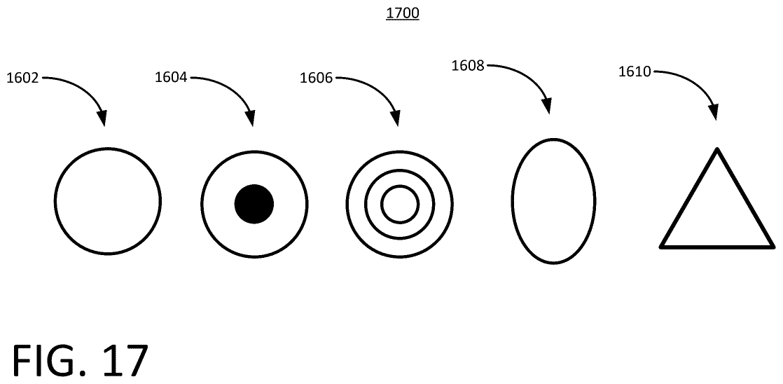

FIG. 17 is an illustration 1700 of some example capacitive cell shapes and configurations. As depicted, these include circular 1602, ring 1604, multiple rings 1606, oblong 1608 and triangular 1610. In various embodiments, any of many other shapes, configurations and sizes may be used.

In some embodiments, a particular shape or shapes for one, some or all capacitive cells of a network may be selected to optimize based on factors that may include the intended or expected use(s) or application(s) for the associated flexible structure or particular desired performance areas of emphasis. For example, symmetric or relatively symmetric shapes, such as a circularly shapes capacitive cell 1602, may provide a similar or identical capacitance change in any direction of bending, helping allow detection of any associated deformation. However, particular non-symmetric shapes of capacitive cells, including oblong shaped capacitive cells 1608 and triangular shaped capacitive cells 1610, may provide more capacitance change and sensitivity for bending in one or more particular directions of bending, or ranges of bending, and may be selected when such bending may be expected or is prioritized to detect. As such, for example, differently shaped capacitive cells may effectively provide more or less capacitive measurement sensitivity in particular directions relative to the shape features of the capacitive cell. Additionally, orientation of a particular capacitive cell, as well as arrangements including orientations of groups of capacitive cells, may affect the sensitivities and performance associated with the network of capacitive cells, as described further herein.

Ringed capacitive cells 1604, 1606 may provide advantages including flexibility of use. For example, in some embodiments, rings around each of a group of capacitive cells may be electrically connected and used for electrical ground, for example, to act as shields or for connection, or to be connectable, to a touch sensor. Furthermore, capacitive cells of different sizes may be selected for locations on different areas of the flexible structure, for instance, if different deformations or detection requirements or priorities may be expected or apply in those areas. Various factors affecting size selection for capacitive cells is also described herein, where larger capacitive cells may provide greater resting capacitance. Both shape and size of capacitive cells may be selected, for example, to optimize various performance parameters based on a variety of factors.

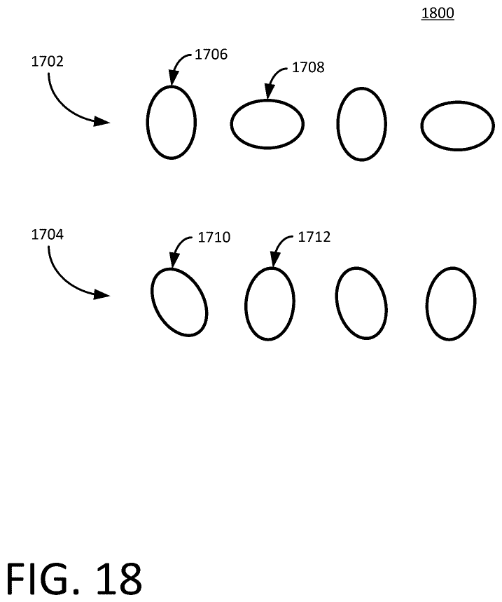

FIG. 18 is an illustration of example capacitive cell horizontal orientations within a group of capacitive cells. In orientation 1702, alternating adjacent capacitive cells 1706, 1708 are positioned as if rotated 90 degrees relative to each other. In orientation 1704, adjacent capacitive cells 1710, 1712 are oriented irregularly, in various degrees of horizontal rotation relative to each other. With variously shaped capacitive cells, capacitive sensitivity may be affected by the shape of the capacitive cell. As described herein, for example, differently shaped capacitive cells may offer different sensitivity for bending in different directions or along different axes. In some embodiments, differently shaped capacitive cells may deform differently from different deformations in different directions or along different axes, such as by contracting or expanding, or contracting or expanding differently.

Additionally, orientation of a capacitive cell, such as within a network of capacitive cells of a flexible structure, and within a flexible structure itself, affects the orientation and direction of the shape features of the capacitive cell relative to other capacitive cells and the network, relative to the network as a whole, and relative to the associated flexible structure as a whole. As such, orientation of each capacitive cell may also affect capacitive measurement sensitivity in various directions relative to the overall flexible structure and its components. Therefore, in some embodiments, both shape and orientation of each capacitive cell (as well as other aspects, such as size, as described further herein), are taken into account in determining optimal configurations. In various embodiments, various arrangements, which may include both location and orientation patterns, of capacitive cells may be used. For example, in some embodiments, capacitive cells may be arranged so that bending in a particular direction or along a particular axis causes contraction of some capacitive cells and expansion of others.

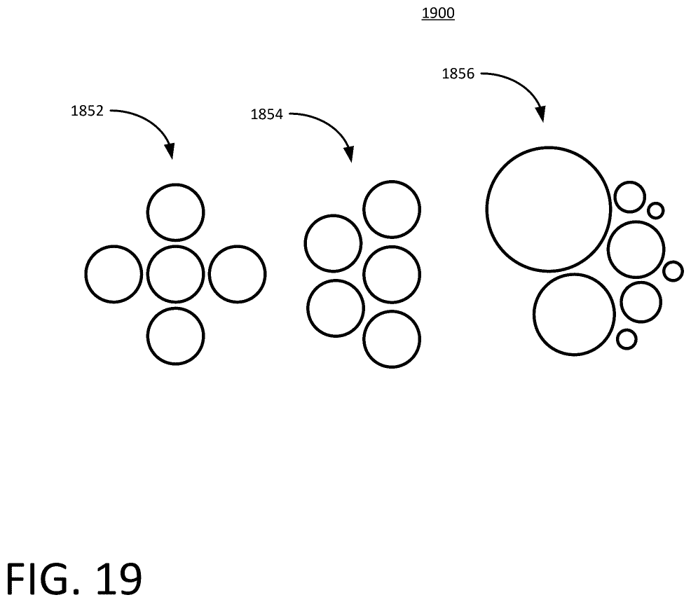

FIG. 19 is an illustration of some example capacitive cell horizontal arrangement variations of groups of capacitive cells. In arrangement 1852, example horizontally circular capacitive cells are arranged adjacent to, yet spaced apart from, each other in a regular grid style pattern, which may be called a rectilinear arrangement. In arrangement 1854, example horizontally circular capacitive cells are arranged in a pattern in which each capacitive cell may relatively close to more than one other capacitive cell. In arrangement 1806, example horizontally circular capacitive cells of various horizontally defined sizes are arranged in an irregular pattern. As described herein, in some embodiments, more dense arrangements, providing more capacitive cells per unit area, and/or larger cells, may be used with portions of a flexible structure where greater measurement sensitivity is needed or desired. For example, this may include areas in which a deformation is anticipated. In some embodiments, larger capacitive cells may provide advantages in accuracy or resolution with regard to shape estimations of larger deformations, while smaller capacitive cells may provide similar advantages with regard to shape estimations of smaller deformations. Furthermore, use of different sized cells and use of irregular arrangements may provide advantages with regard to minimizing modeling inaccuracy caused by artifacts.

In various embodiments, horizontal arrangements or patterns may include many different types of variations, including irregular, regular or geometric arrangements or patterns, arrangements or patterns in which some capacitive cells contact or do not contact others, and arrangements in which particular capacitive cells are different from others in various ways, which may include being sized differently, shaped differently or composed differently, such as by having different amounts or types of layers or being composed of different materials. In some embodiments, rectilinear arrangements, such as arrangement 1802, may allow for efficient electrical interconnections between groups of cells, but may cause production of banding artifacts, such as when the associated flexible structure is bent between capacitive cell locations. Other arrangements, such as arrangement 1804, may reduce or eliminate dead zones, such as, for example, areas for which bending may not be detectable or easily detectable, but may not allow for any straight lines along which bending will not cause deformation of any cells, which may be desirable in some cases. In some embodiments, while arrangements with more horizontal area density of capacitive cells may increase resolution, they may also make interconnections between capacitive cells more difficult to implement, and may make measurement of capacitances of individual cells more difficult.

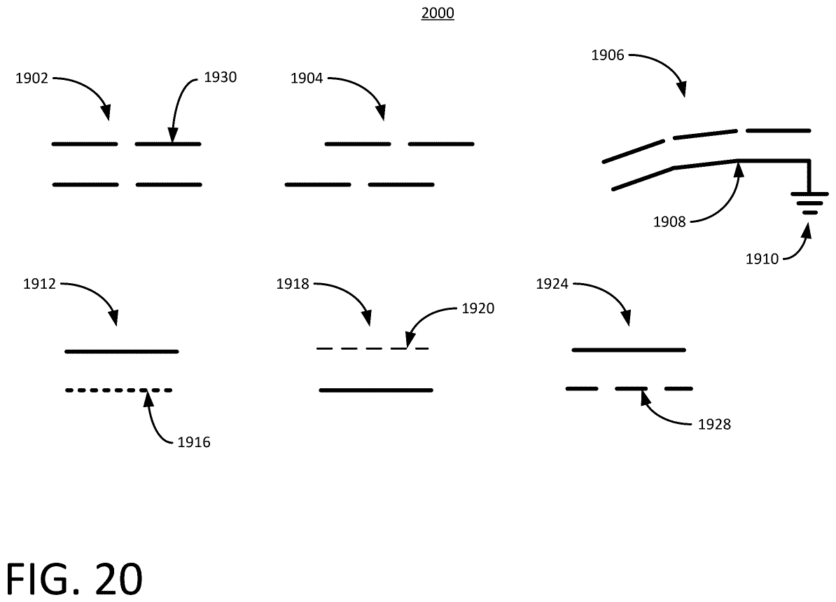

FIG. 20 is an illustration of simplified example capacitive cell related arrangements, with illustrations shown in a cross-sectional view that would be defined by a plane running through the thickness of an associated flexible structure. Image 1902 shows capacitive cells 1930 in a vertically stacked arrangement, with some capacitive cells positioned directly over others. Image 1904 shows capacitive cells in a vertically stacked arrangement, with some capacitive cells positioned partially over others. Image 1906 shows an arrangement with capacitive cells in which a flexible structure includes a monolithic ground plane layer 1908 including an electrical ground 1910, which may be positioned along or near a lower horizontal surface of the flexible structure. Image 1912 shows an example flexible structure configuration that includes a force sensor 1916 positioned vertically under a capacitive cell, the capacitive cell being made up of a dielectric layer between two conductive layers. Image 1918 shows an example flexible structure configuration that includes a touch sensing layer 1920 positioned vertically over a capacitive cell, which might be used, for example, to detect hand touch.

Image 1924 shows an example flexible structure configuration that includes an electrocardiogram (ECG) lead positioned or embedded vertically under a capacitive cell. In some embodiments, fabrication of a portion of a flexible structure including a network of capacitive cells may include embedding of an ECG lead that can be used for measurement of patient ECG while the flexible structure is applied to the patient.

In some embodiments, capacitive cells of a flexible structure may be used for more than or other than shape deformation and deformed shape estimations. For example, in various embodiments, capacitive cells of a flexible structure may be used in force sensing, human touch sensing, humidity and moisture sensing, temperature sensing, ambient pressure sensing and impedance sensing.

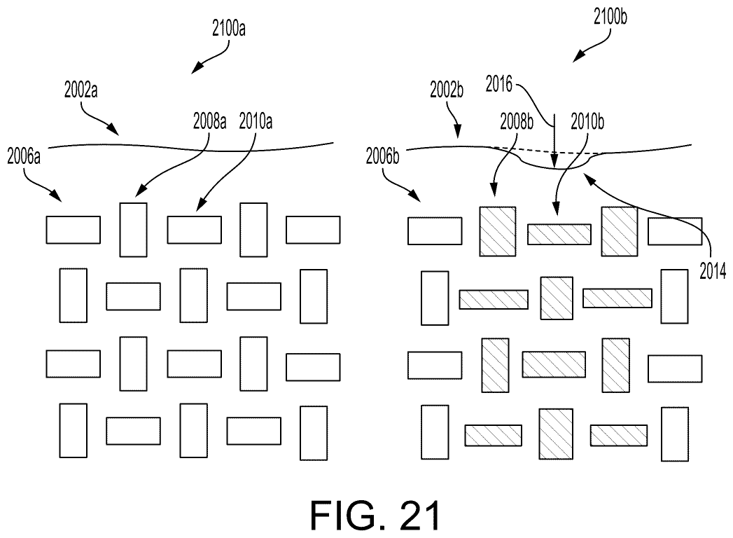

FIG. 21 is an illustration of example capacitive cell groups 2006a, 2006b in an undeformed flexible structure and a deformed flexible structure. Image 2100a provides a simplified illustration of a portion of an upper horizontal surface 2002a of the flexible structure in an undeformed shape. Image 2100b provides a simplified illustration of a portion of the upper horizontal surface 2002b of the flexible structure in a deformed shape due to application of a deforming force 2016. In image 2100b, a simplified illustration is provided of the deformed portion 2014 of the upper horizontal surface 2002b, but shown only for conceptual purposes and not drawn to scale or to reflect the contour or shape of an actual deformation.

The illustrated capacitive cells 2006a, 2006b of the flexible structure in the undeformed shape can be seen to be in an arrangement including vertical stacking and including adjacent capacitive cells in alternating vertical rotational positions (e.g., capacitive cells 2008 and 2010, which are positioned as if rotated 90 degrees relative to each other).

Some of the illustrated capacitive cells 2006b with the flexible structure in the deformed shape can be seen to be deformed relative to the shape of the same capacitive cells 2006a with the flexible structure in the undeformed shape, as a result of application of the deforming force 2016 to the upper horizontal surface 2002b of the flexible structure. Particularly, for example, capacitive cells 2008b, 2010b are compressed relative to the capacitive cells 2008a, 2010a in an undeformed shape, so that the deformed capacitive cells 2008b, 2010b are slightly shorter vertically and slightly wider horizontally than the capacitive cells 2008a, 2010b in the undeformed shape. Deformations of capacitive cells may result in changes in capacitances associated with the capacitive cells, which can be used in estimation of changes to the three dimensional shape of the associated flexible structure, such as may result from application of a deforming force to the flexible structure.

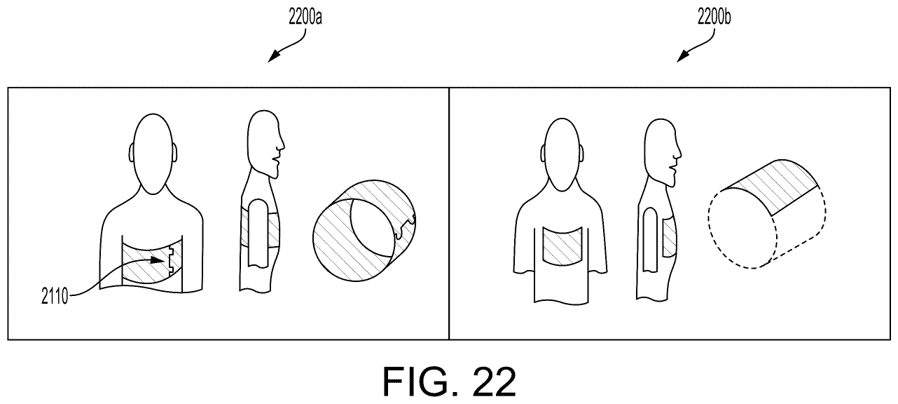

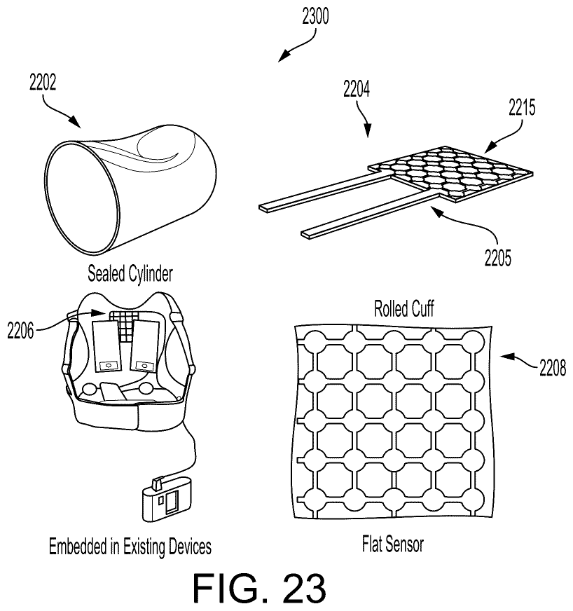

FIGS. 22-23 are simplified illustrations of example types and configurations of flexible structures. In FIG. 22, example embodiments 2200a, 2200b of a flexible structure are illustrated. In embodiment 2200a, the flexible structure is tubular and configured to wrap entirely around the torso of the patient. The flexible structure includes a closable seam 2110. For example, the flexible structure, in a non-closed shape relative to the seam 2110, may be wrapped around the torso of the patient by a care provider. The care provider may then attach edges of the flexible structure at the seam 2110, thus closing the flexible structure at the seam so that the flexible structure forms a closed tubular shape around a portion of the torso of the patient. In various embodiments, any of various coupling or attaching components or techniques may be used to attach the edges of the flexible structure at the seam 2110, including, for example, use of a hook and loop fastener, adhesive, another physical or mechanical attachment (e.g., one or more hooks, latches, snaps, moveable or non-movable attachment components, or others). In various embodiments, the flexible structure may be sufficiently secured by being wrapped (which may or may not include being stretched) around the torso of the patient and secured at the seam 2110. However, in other embodiments, the flexible structure may be secured, or further or more conformably secured, to at least a portion of the surface of the patient to which it is applied, such as by use of an adhesive or in other ways. Furthermore, in various embodiments, flexible structures may be sized for various types, ages and sizes of patients, including, for example, pediatric, adult, infant, child, small or young adult, or may be sized according to size scale (e.g., small, medium, large, extra large, etc.).

Although, in the embodiment illustrated in FIG. 22, the flexible structure is configured to be wrapped around and then secured at the seam, in other embodiments, a flexible structure may be tubular even in a resting state prior to be applied to a patient, and may have or need no closable seam. In some embodiments, for example, such a tubular flexible structure may be applied by being placed over the head or lower body of the patient and moved until it is positioned, which may or may not include stretched, around the torso of the patient. In some embodiments, tracking shape deformation of, for example, an applied tubular flexible structure can allow detection of patient respiration rate, by identifying associated slight expansions and contractions of the torso.

In embodiment 2200b, a sheet style flexible structure is not closed but instead is applied on a portion of the surface of the torso of the patient (e.g., on at least a portion of the chest of the patient). In various embodiments, the flexible structure may not need to be secured or may be sufficiently secured merely by being placed on the patient. However, in other embodiments, the flexible structure may be secured, or further or more conformably secured, to at least a portion of the surface of the patient to which it is applied, such as by use of an adhesive or in other ways. For example, in some embodiments, an adhesive may be disposed on the bottom horizontal surface of the flexible structure, to adhere to the patient (or the patient's clothing or other covering). Furthermore, in some embodiments, the outside edges of a sheet style flexible structure, or an upper horizontal portion thereof, may include, or be attached to, an additional border portion that includes an adhesive. Still further, in some embodiments, a flexible structure may be included within and/or extending from a defibrillation electrode pad, and conductive gel used for application of the pad to the patient may serve as an adhesive. For example, in some embodiments, an electrode pad assembly may include defibrillation electrodes for placement on a patient at appropriate locations (e.g., anterior-posterior, anterior-lateral positions) for defibrillation, and the electrode pad assembly may also include flexible structure(s) as described herein that extend over the sternum region where it is appropriate to apply chest compressions such that the deformed shape of the chest may be estimated in real-time. It can be appreciated that other arrangements of the flexible structure may be provided on a patient to suit the relevant medical application, beyond defibrillation, cardiopulmonary and other resuscitation treatment.

In FIG. 23, illustrated example flexible structure 2202 is tubular and may, for example, wrap around a portion of a patient, such as the patient's torso, limb, neck or head (e.g., a headband style). Illustrated example flexible structure 2204 is substantially flat and rectangular or square in an undeformed shape, and includes (or is configured to attach to) two protruding portions 2205. In various embodiments, these protruding portions may or may not include capacitive cells and may wrap around a portion of the patient and attach, for example, to edge 2215 of the flexible structure to secure the flexible structure to the patient. Illustrated example flexible structure 2208 may be similar to illustrated example flexible structure 2204 but not include (or be configured to attach) to protruding portions. Illustrated example flexible structure 2206 is configured to be placed or embedded within another device, such as, as illustrated, a LifeVest® wearable cardioverter defibrillator (WCD) available from ZOLL Medical Corporation of Chelmsford, MA.

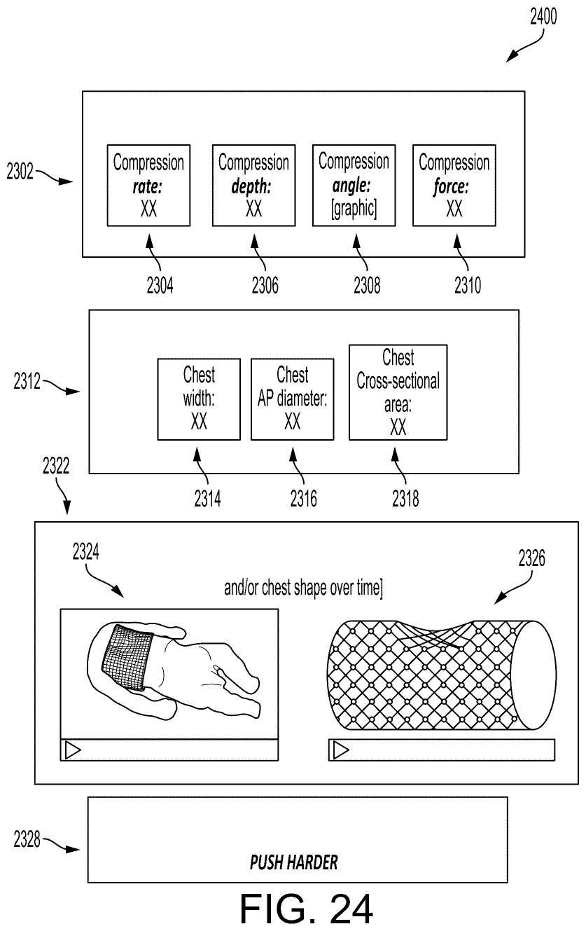

FIG. 24 is block diagram 2400 illustrating example presented output, relating to CPR chest compressions, generated based on tracking of a three dimensional deformed shape of a flexible structure. Block 2302 illustrates simplified examples of output relating to changing CPR chest compression related parameters, which may be tracked over time, such as during the providing of CPR chest compressions to a patient. As depicted, the example displayed parameters include a current (such as real time or near real time) compression rate 2304 (e.g., in compressions per minute), a compression depth 2306, a compression angle 2308 (which may, for example, be or include one or more graphics or images to show or convey the compression angle), and compression force 2310. However, in various embodiments, various other CPR chest compression parameters may be shown.

Block 2312 illustrates simplified examples of output relating to changing chest or other patient related parameters, which may be tracked over time, such as during the providing of CPR chest compressions to a patient. These include chest width 2314, chest diameter 2316 and chest cross-sectional area 2318.

Block 2322 illustrates simplified examples of video or animated output, such as a video or animated presentations 2324, 2326 that may show tracked changing shape of the flexible structure or the patient's chest during the CPR chest compressions. Such presentations may be, for example, real time or almost real time and may be playable from storage at a later time. For example, based on shape tracking, animated visual presentations could be provided to depict the tracked deformed shape of the patient's body, and may also depict aspects of user actions, such as be showing a depiction of the user's hands providing chest compressions.

Block 2328 illustrates a simplified example of an instruction to a care provider based on tracking of the changing shape of the flexible structure or the patient's chest. This may include, for example, an instruction for the care provider to push harder, such as if the tracking is used to determine that one or more last or recent provided manual CPR chest compressions had less than optimal compression force or depth.

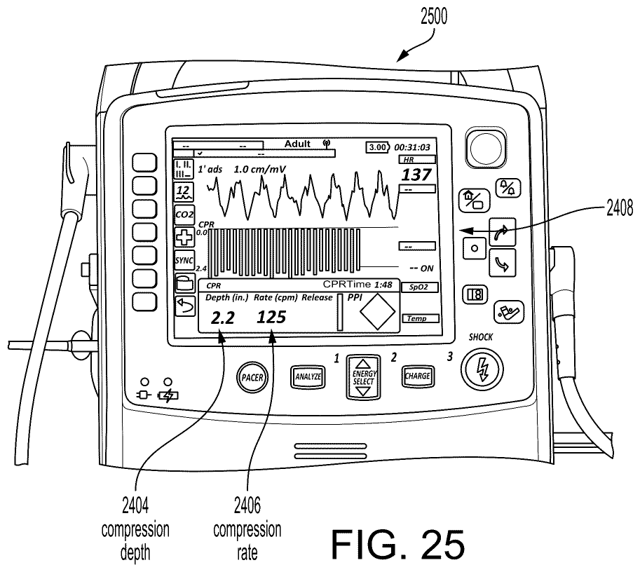

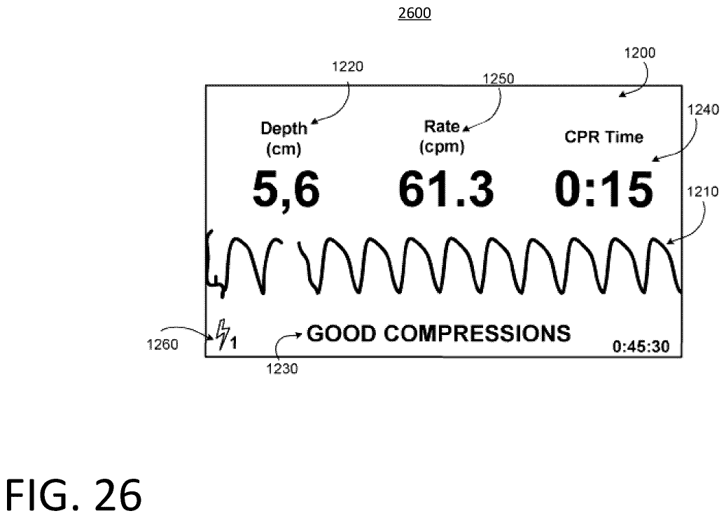

FIGS. 25-26 are illustrations relating to displayed CPR chest compression related parameters determined using tracking of change of three dimensional shape of a flexible structure. As illustrated in FIG. 25, output is provided on a display 2408 of a defibrillator 2500 and includes parameters such as, for example, a current or last compression depth 2404 and a current compression rate 2406. FIG. 26 provides a simplified illustration of one example of a display 2600 including output, which includes compression depth 1220 in cm, compression rate 1250 in compressions per minute, total elapsed time of the providing of the CPR chest compressions 1240 in seconds, a graphical display relating to provided compressions over time 1210, an indication of the number of compressions provided so far 1260, and corrective feedback 1230 to the care provider regarding the providing CPR chest compressions. In this case, the corrective feedback is “Good Compressions”, which, in various embodiments, may indicate that one or more compression parameters are optimal or within an optimal range (e.g., compression rate, depth, force or angle).

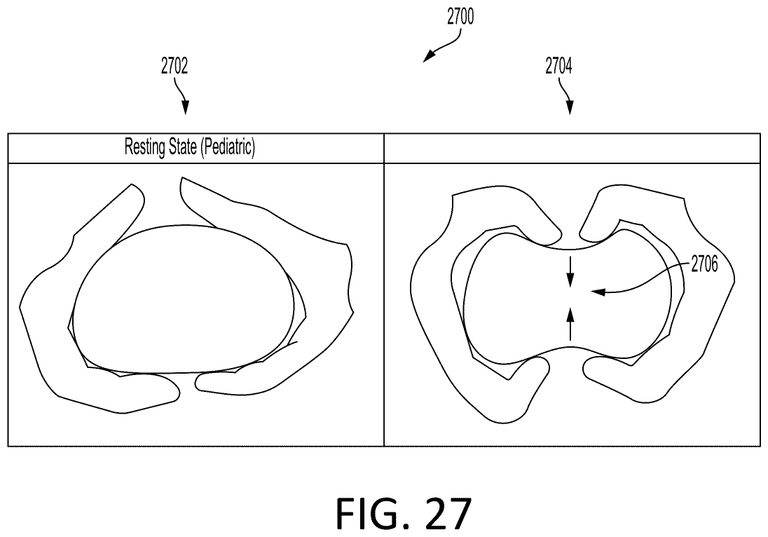

FIG. 27 is an illustration relating to an example schematic of an uncompressed shape 2702 and a compressed shape 2704 of the torso of a pediatric patient during front and back applied manual CPR chest compressions. Force vectors 2706 represent the compressing and deforming forces applied to the chest and the back of the patient. According to some embodiments, an applied flexible structure (not shown), such as may be wrapped around the torso of the patient, may allow for modeling, estimation and tracking of the deformed shape of the flexible structure as well as the torso of the patient, such as over the course of multiple front and back applied manual CPR chest compressions. This can be used to determine parameters relating to the provided compressions, such as force, depth and angle of compressions. For example, the corrective feedback may include displayed text instructing the user to increase or decrease depth of compressions by a certain amount, or may depict the actual depth of a provided compression relative to an ideal depth, so that the care provider can correct depth of one or more subsequent compressions accordingly. In other examples, the corrective feedback may include a display that may be provided to depict the angle of an actual compression relative to a target angle, to allow the care provider to adjust accordingly for subsequent compressions. Additionally, since such corrective feedback may be updated continually, the care provider may be able to continue to make adjustments over multiple compressions, such as may allow gradually reach an ideal depth, force or angle.

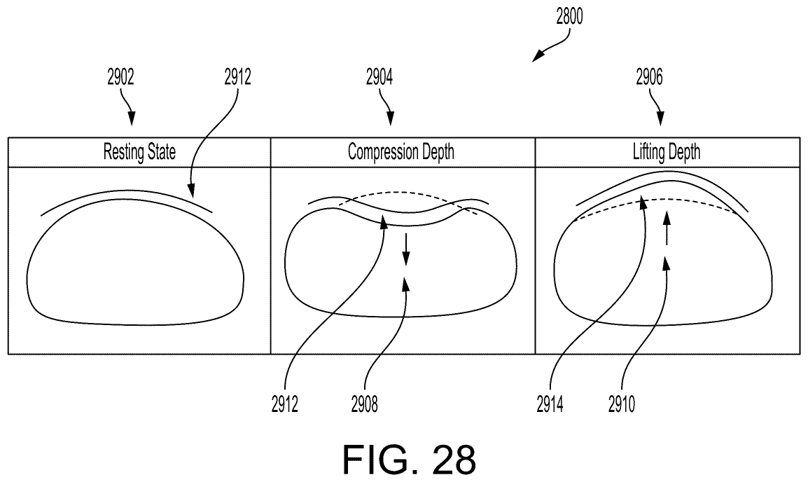

FIG. 28 is a simplified illustration relating to example schematic shapes of a portion of the torso of a patient, as well as an applied flexible structure 2912, during applied CPR chest compressions, including a resting and uncompressed shape 2902, a compressed shape 2904 and a vertically lifted shape 2906 shape. In the compressed shape 2904, force vector 2908 represents the applied deforming force, which is a force pushing against the upper horizontal surface of the flexible structure 2912, which force causes a vertically depressed deformation 2912 of the flexible structure 2912 and a portion of the patient's chest to a certain maximum depth. In the lifted shape 2906, force vector 2910 represents the applied deforming force, which is a force pulling a portion of the upper horizontal surface of the flexible structure 2912, which force causes a vertically raised deformation 2914 of the flexible structure 2912 and a portion of the patient's chest to a certain maximum lift. Each of these shapes 2902, 2904, 2906 can be modeled and estimated using embodiments described herein, and the changing shape of the flexible structure and of the patient's chest can be tracked. For example, based on tracked changing shape of the patient's chest, the maximum depth and maximum lift can be determined, and, if needed corrective feedback can be provided to the care provider accordingly. For example, the corrective feedback may include displayed text instructing the user to increase or decrease depth of compressions by a certain amount, or may depict the actual depth of a provided compression relative to an ideal depth, so that the care provider can correct depth of one or more subsequent compressions accordingly. Additionally, since such corrective feedback may be updated continually, the care provider may be able to continue to make adjustments over multiple compressions, such as may allow, if needed, gradually reaching an ideal depth.

FIG. 29 is an illustration relating to example modeled CPR chest compression depths and angles. Simplified illustration 3002 shows deformations 3008, 3010 of a patient's chest and an applied flexible structure (not shown) resulting from CPR chest compressions of different depths (or a single compression at different points in time during a compression phase), which can be modeled and estimated using embodiments as described herein.

Simplified illustration 3004 shows deformations 3012, 3014 of a patient's chest and an applied flexible structure (not shown) resulting from CPR chest compressions of different depths (or different depths of single compression at different points in time during the application of the compression). Deformation 3012 results from a force vector 3016 in a vertical direction, while deformation 3014 results from a force vector 3018 in an angled direction relative to vertical. As can be seen, the deformations 3020 resulting from the vertical force vector 3016 are shaped differently than the deformations 3022 resulting from the vertically angled force vector 3018. Specifically, in the illustrated simplified example, the deformations 3020 resulting from the vertical force vector 3016 show greater left to right symmetry than the deformations 3022 resulting from the vertically angled force vector 3018.

Some embodiments as described herein model, estimate and track these deformations. Additionally, in some embodiments, variations in shapes of deformations, which may be influenced by an angle of the deforming force, can be used to determine or estimate the angle of the deforming force. Furthermore, the determined or estimated angle of a deforming force, such as a CPR chest compression, may be compared with an optimal such angle. Based at least in part on the comparison, corrective feedback or instructions may be provided to the care provider providing the CPR chest compressions relating to the angle of the provided compressions, such as corrective feedback relating to a change of angle needed to optimize or better optimize the angle of provided compressions.

FIG. 30 is an illustration and associated plots 3206, 3208 relating to detection of chest remodeling resulting from CPR chest compressions, using techniques according to some embodiments of the present disclosure. Simplified illustration 3202 shows front and back CPR chest compressions being applied to a pediatric patient, where a flexible structure (not shown) is applied to at least a portion of the chest of the patient. Chest remodeling can include changes to the shape of a patient's chest that may persist between CPR chest compressions, after the providing of CPR chest compressions, long-term or even permanently. In some instances, chest remodeling, or sufficiently great or severe chest remodeling, can indicate injury, such as a broken rib. Furthermore, in some instances, detecting chest remodeling, or increasingly great or severe chest remodeling, can be used, for example, in providing critical instructions or corrective feedback to a care provider providing the compressions, such as to decrease the force or change the angle of the compressions to prevent or reduce further chest remodeling and associated risk or injury to the patient. In some embodiments, shape tracking is used to determine parameters that can be used to detect chest remodeling, such as tracked patient chest width, chest diameter and chest cross-sectional area.

For example, for a remodeled chest with a significant depressed area, a compression of a certain depth, which may be appropriate for a patient with an unremodeled chest, may be too deep and greatly damaging to a patient with such a remodeled chest. The corrective feedback may include, for example, displayed text instructing the user to increase or decrease the force of compressions by a certain amount, or may depict the force of a provided compression relative to an ideal depth, so that the care provider can correct depth of one or more subsequent compressions accordingly. In other examples, the corrective feedback may include a display that may be provided to depict the angle of an actual compression relative to an ideal angle, to allow the care provider to adjust accordingly for subsequent compressions. Furthermore, for example, chest remodeling may change a chest AP diameter and other dimensions, such as which may in turn change safe or optimal compression characteristics such as angle or depth of compressions.

Simplified example plot 3206 shows applied CPR chest compression force (F) relative to the deformation depth (D) resulting from the force. As can be seen by the increased slope portion 3210 of the plot, as force increases beyond a certain point, roughly indicated by point 3212 along the horizontal axis, deformation begins increasing at a much faster rate. This increased rate of deformation can be evidence of chest remodeling.

Simplified plot 3208 shows applied CPR chest compression force (F) (e.g., in Newtons), relative to the associated chest deformation depth (D) (e.g., in mm) tracked over the time period (1) of a compression phase of a particular compression and the period (2) of a release phase of the particular compression. A difference in, for example, in the deformation depth before and after the application of the CPR compression (including both phases) may represent the deformation depth that now exists in the patient's chest even when no chest compression is being applied. This difference may be caused by, or in part caused by, and may be evidence of, chest remodeling caused at least in part by one or more CPR chest compressions.

As illustrated by simplified example plots 3206 and 3208 and their uses, in some embodiments, by tracking the changing shape of the patient's chest during the providing the CPR chest compressions, analytics can be generated and used to detect, or detect potential, chest remodeling, to determine or estimate the magnitude thereof, and to provide appropriate output to the care provider to better optimize treatment to the patient, potentially preventing or mitigating patient injury, or better optimizing parameters of provided CPR chest compressions.

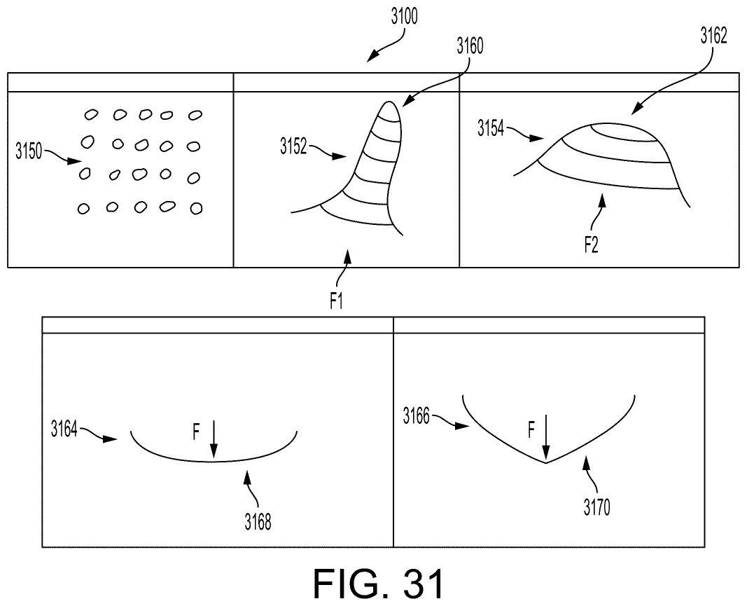

FIG. 31 is an illustration 3100 relating to examples of use of modeling of CPR chest compression related parameters for providing corrective feedback for optimization of the providing of the CPR chest compressions. The illustrated examples may, for example, be associated with use of a flexible structure including a grid pattern horizontal capacitive cell arrangement 3150, examples of which are further described herein.

Simplified illustrations of deformations 3152 and 3154 show example modeled deformation shapes that may result from application of forces to a flexible structure, such as forces from CPR chest compressions provided to a patient, where the flexible structure has been applied to a portion of the patient's chest. Force vector F1 represents the applied compression force causing deformation 3152 and force vector F2 represents the applied compression force causing deformation 3154. As can be seen, the deepest portions 3160, 3162 (in the directions of each of the force vectors F1, F2) are shaped differently, with deepest portion 3160 being generally wider and more rounded and deepest portion 3162 being generally more narrow and less rounded. The more rounded deepest portion 3160 may be indicative of a larger surface area associated application of force F1, relative to a smaller surface area associated with application of force F2. In some embodiments, such different force application surface areas associated with these modeled deformation shapes 3152, 3154 can be used, for example, to determine characteristics relating to manually provided compressions, such as what portion of portions of the providers hand or hands are being used to apply the compressions, whether or to what degree or direction the hand or hands might be leaning on the patient's chest, whether full release is being allowed, etc. Furthermore, in some embodiments, computational deformation profiles may be used to characterize types of deformations to allow for matching of particular types of deformations to particular causes, conditions, procedures, techniques or devices.

In some embodiments, determined CPR chest compression related parameters or characteristics may be, for example, compared to ideal parameters or characteristics. This comparison may be used in determining corrective feedback that may be provided to the care provider providing the chest compressions, such as with regard to modifying a portion of the hand or hands used to apply the compressions.

In simplified illustrations 3164 and 3166, the same applied force, as represented by force vector F, such as a CPR chest compression force, results in modeled deformations of different depths, with deformation 3170 being deeper than deformation 3168. Assuming that the illustrations 3164 relate to different patients, then the deeper deformation 3170 may indicate a patient with a chest that provides less resistance against force, and the less deep deformation 3168 may indicate a patient with a chest that provides more resistance against force, for example.

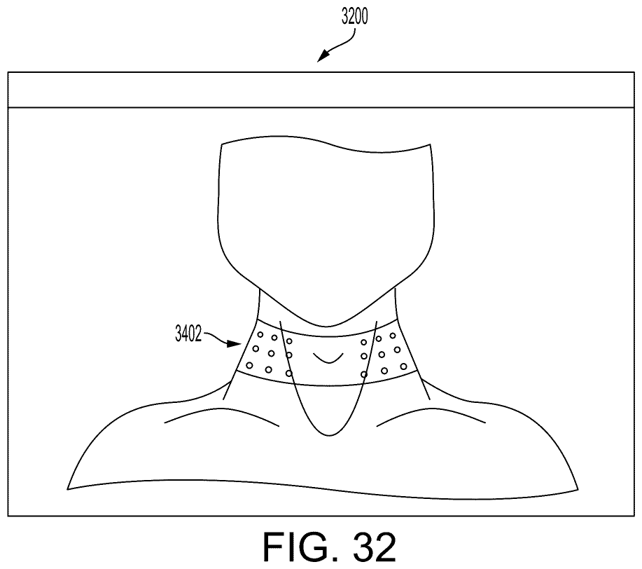

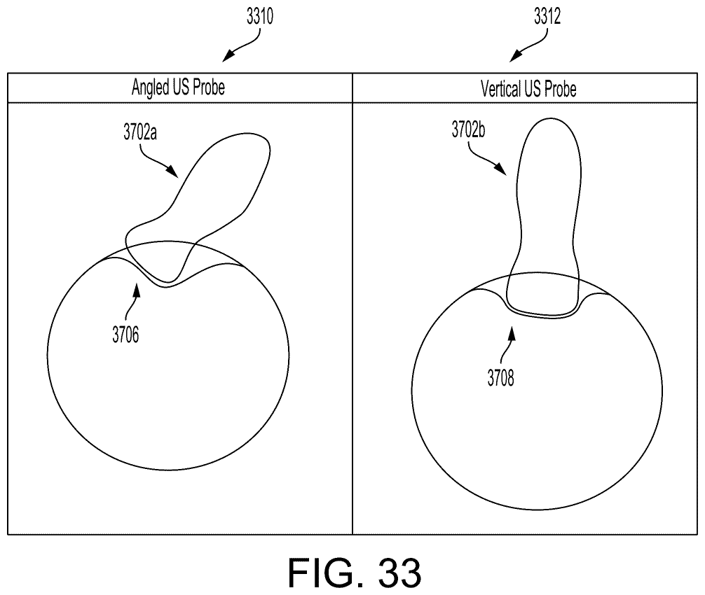

FIG. 32 is an illustration relating to use an example flexible neck applied flexible structure 3402 that can be used in detection of a patient's neck pulse. As depicted, the flexible structure may be applied around the neck of the patient. In some embodiments, tracked shallow or small deformations over time can be associated with the small deformation forces caused by the pulse pressures created by each heartbeat of the patient. This may be of use in determining and tracking heart rate. In other embodiments, flexible structures used pulse detection and heart rate determination may be configured to be applied to other body areas, such as around a patient's wrist. In some embodiments, pulse detection may be used in detection of, or in helping to detect, pulseless electrical activity (PEA) or pseudo PEA in a patient, for example. In some embodiments, a flexible structure used for pulse detection may have a high sensitivity to allow for effective tracking of small shape changes caused by pulse pressures.

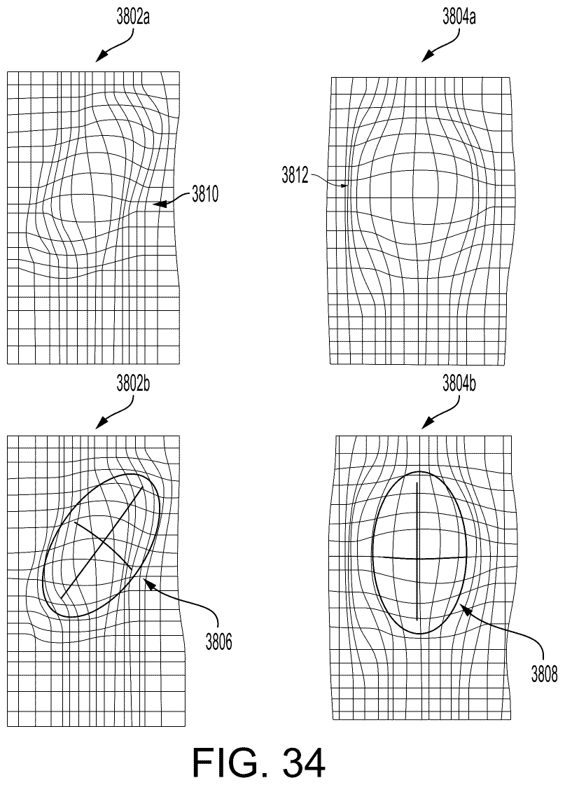

FIG. 33-34 are illustrations 3310, 3312 relating to use of techniques according to embodiments of the present disclosure to detect and provide corrective feedback relating to positioning of an ultrasound probe 3702a, 3702b during ultrasound imaging. For example, the ultrasound imaging may include movement and positioning, as well as slight pressing, of the probe over a portion of the surface of the patient's body while a flexible structure is applied to the patient.

In FIG. 33, as can be seen, in simplified illustration 3310, the probe 3702a is positioned at an angle relative to vertical, whereas in illustration 3312, the probe 3702b is vertically positioned. Furthermore, the modeled deformation 3706 (to the flexible structure or a portion of the surface of the body of the patient) caused by the force applied by the vertically angled probe 3702a during ultrasound imaging is shaped differently than the deformation 3708 caused by the vertically positioned probe 3702b. In some embodiments, based at least in part on the modeled deformations caused by the probe, an angle of the probe, such as in three dimensional space, can be determined or estimated.

In FIG. 34, simplified illustrations 3802a, 3802b, 3804a, 3804b, show contours indicating modeled deformations 3810, 3812 caused by different rotational positioning of an ultrasound probe about a horizontal plane. Since different rotational positions of the probe may result in different deformations, in some embodiments, tracking of deformations (to the flexible structure or the portion of the surface of the body of the patient's) may be used in determining or estimating rotational positioning of the probe. As shown in simplified illustrations 3802b and 3804b, the different modeled deformations 3810, 3812 may be used to model the associated different horizontal rotational positions 3806, 3808 of the probe.

In some embodiments, based on probe vertical angle and horizontal rotational position tracking, output may be determined and presented to the care provider performing the ultrasound imaging, such as corrective feedback or instructions relating to the angle or horizontal rotational position of the probe. Such output might include, for example, when the angle or horizontal rotational position is correct, or within a correct or optimal range, a visual display confirming that the angle or horizontal rotational position is correct. Such output might also include, for example, when the angle or horizontal rotational position is incorrect, or outside of a correct or optimal range, providing a visual display notifying, warning or alerting the care provider that the angle or the horizontal position is incorrect, or outside of a correct or optimal range, and providing visual instructions for correcting the angle or horizontal rotational position.

As such, in various medical care applications, some embodiments include determination and presentation of corrective feedback to a care provider, such as image-based, video or augmented reality based feedback, within a mere fraction of a second delay from current conditions. Such corrective feedback may allow the care provider, based on instructions or image based feedback, when needed, to gradually or continually correct parameters of the provided care, or to maintain the parameters within ideal ranges, as well as to be quickly made aware of and make corrections to correct erroneous adjustments that actually inadvertently increase divergence from ideal parameters. This may include, for example, textual instructions to change a particular parameter (e.g., the angle of an ultrasound probe or the depth of CPR chest compressions), or it may an include image-based display that may make the needed correction immediately visually clear to the care provider (e.g., a display of the actual angle or depth along with an overlaid display of an ideal angle or depth). Additionally the corrective feedback may be continually provided, the care provider can, if needed, gradually and continually make small adjustments and immediately obtain further corrective feedback, such as instructions to change the angle or depth slightly more or less, or the care provider may see the visual display that shows, for example, the depth or angle getting closer to an ideal depth or angle, or may see that the depth and angle are getting further away from an ideal depth or angle, if that is the case.

Although FIGS. 33 and 34 relate to corrective feedback for ultrasound probe positioning, similar techniques may be applied for various other uses. For example, positioning tracking and related corrective feedback may be provided in other medical care uses for other instruments or devices that may be pressed, moved and positioned along the surface of a patient's body. Additionally, in some embodiments, similar techniques may be used with regard to positioning of a portion of a care provider's body, such as positioning of the care providers fingers or hand(s) on the patient, such as during the providing of CPR chest compressions, for example.

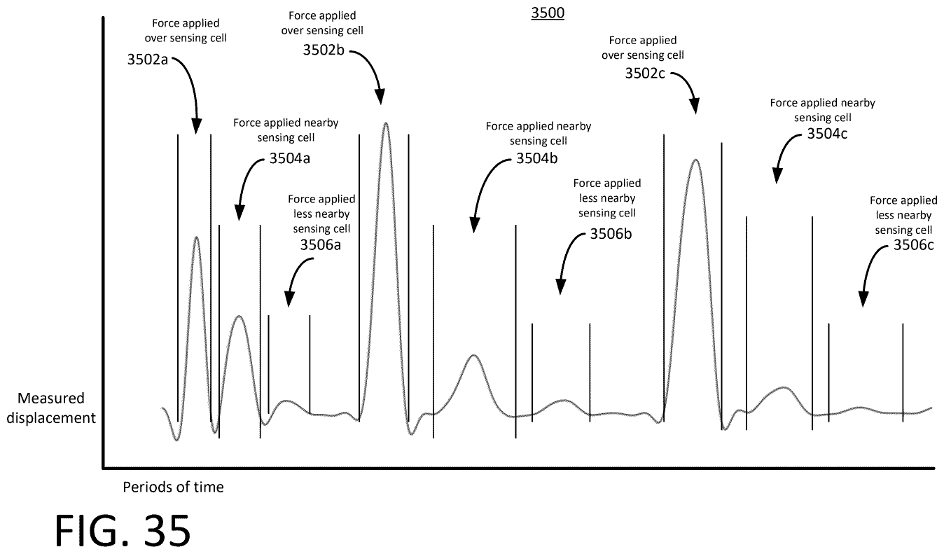

FIGS. 35 and 39-44 illustrate plots relating to various embodiments that demonstrate the ability to measure key parameters related to emergency medical treatment. It is to be understood that these plots are included to show actual data that illustrate applications, which may be useful for calibration, or other adjustment in various ways.

FIG. 35 illustrates a plot 3500 relating to multi-cell detection of a deformation. As described previously herein, application of, e.g., a deforming force to a flexible structure may cause the most deformation, and resulting change in capacitance, to a capacitive cell or cells most proximate to the location of application of the force (e.g., directly under the location). Other nearby cells may also be deformed, but may be deformed to a diminishing extent, which may be at least in part proportional to their distance from the location. In some embodiments, one or more mathematical, machine learning or artificial intelligence algorithms or models may utilize a set of such capacitive cell data or measurements in a combined way, e.g., to increase the accuracy of the associated surface deformation detection or shape reconstruction. As such, in some embodiments, using, e.g., a trained machine learning model, measurements from groups of cells can be used, e.g., in a synergistic way, to determine surface deformations, shape changes and deformed shapes more accurately than would be possible without use of data from multiple cells and such a model. This may include, e.g., using data regarding measurements from one or more of a group of cells to increase or correct the accuracy of measurements from individual cells, using data from one or more of a group of cells to increase the accuracy of the overall determinations made by data from the group of cells, or in other ways.

For example, as shown in FIG. 35, each of sets of peaks 3502, 3504 and 3506 relate to displacement measured by first capacitive cell of a multicell flexible structure during application CPR chest compressions on a test subject, where the flexible structure was positioned on the chest area of the test subject. The vertical axis represents measured sensor displacement, and distances along the horizontal axis correspond with periods of time associated with particular deformations.

In particular, peaks 3502a-c relate to a deforming force applied directly above the first capacitive cell, peaks 3504a-c relate to a deforming force applied directly above a second cell (adjacent to the first cell), and peaks 3406a-c relate to a deforming force applied to a third cell (adjacent to the second cell and more distant from the first cell than the second cell).

As can be seen, the highest set of peaks 3502a-c relate to the force applied directly above the first cell, the second highest set of peaks 3504a-c relate to the force applied above the second cell, and the third highest set of peaks relate to the force applied above the third cell. This is logical, since the deforming force deforms the surface of the flexible structure most at the location of application, with the amount of deformation diminishing as the distance from the location increases. As such, the highest set of peaks 3502a-c occur when the deforming force is applied above the first cell, the second set of peaks 3504a-c occur when the deforming force is more distant from the first cell, and the third highest set of peaks 3506a-c occur when the deforming force is still more distant from the first cell.

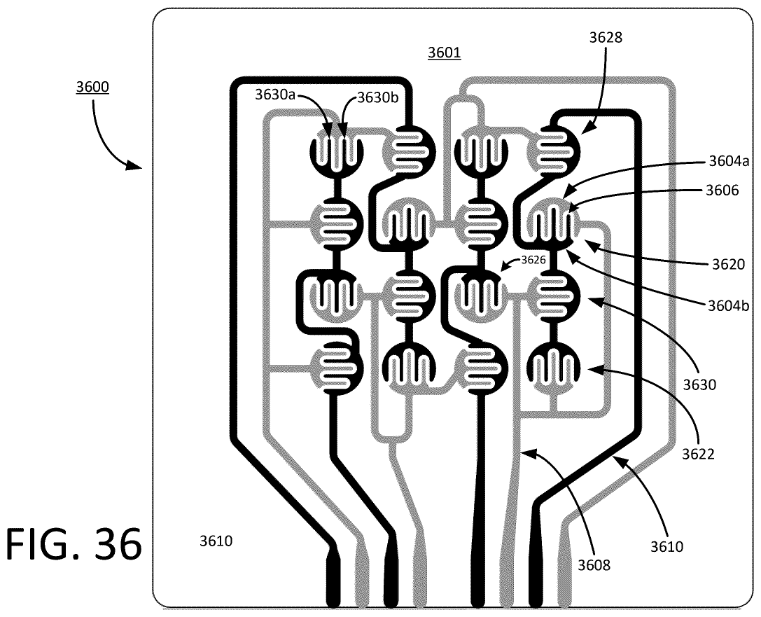

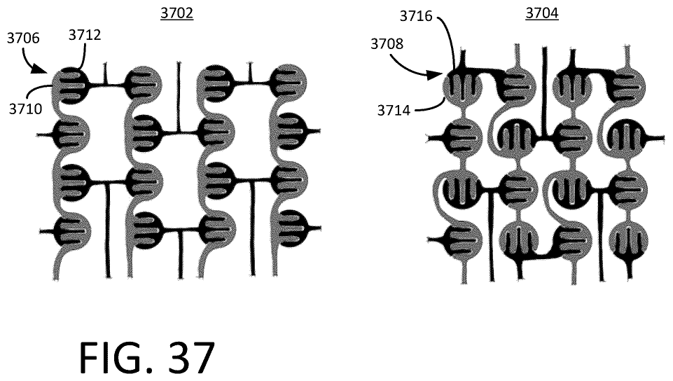

FIG. 36 illustrates an example capacitive cell network 3601 of a flexible structure 3600, which network 3601 utilizes a single horizontal conductive layer implementation (examples of horizontal and vertical, with regard to a flexible structure, is provided with reference to FIG. 13). Each cell (e.g., cell 3620) of the network 3601, rather than including, for example, vertically spaced conductive portions (relative to a vertical thickness of the flexible structure, as described herein) instead includes only a single horizontal conductive layer including two conductive portions (or plates) that are slightly spaced apart horizontally, instead of vertically, and are separated by a small space (e.g., space 3606) occupied by a dielectric material (e.g., silicone or air). The conductive portions (e.g., 3604a,b) of each roughly circular cell are illustrated in gray and black color, respectively. In various embodiments, single horizontal conductive layer implementations, as well as multi-cell network implementations, may be used with single cell and multi-cell network flexible structure implementations, including cells of various sizes and shapes.

As illustrated, the network 3601 includes electrical connections (e.g., 3608, 3610) that interconnect groups of cells, which groups may be, e.g., analogous to strips (e.g., rows and columns) of interconnected cells as shown in the embodiment illustrated in FIG. 8. For example, as depicted, branched electrical connection 3608 interconnects gray-colored capacitive portions of cells 3620, 3622, 3626 and 3630, and branched electrical connection 3610 interconnects black-colored capacitive portions of cells 3620, 3622, 3630 and 3628. As described herein, in some embodiments, single horizontal conductive layer capacitive cell networks may allow for a vertically thinner flexible structure. Relative to some embodiments with vertical conductive layers, such embodiments may, in some cases, allow for simpler or less expensive manufacturing, may have lower total or per cell capacitance, and may be more sensitive to smaller deformations, but may also make measurements closer to a noise floor. In some embodiments, interconnections between groups or strips of cells may be simpler in vertical layered networks

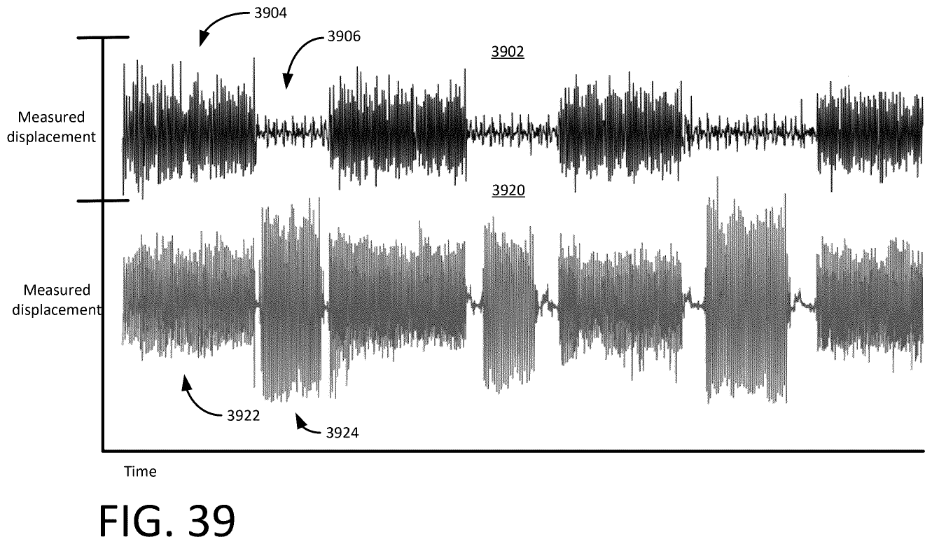

FIG. 39 illustrates two plots 3902, 3920 comparing displacements measured by a cell of a flexible structure incorporating aspects of the present disclosure as compared with displacements measured by an accelerometer (or a system of one or more accelerometers) during compressions performed on a test subject, which may be reflective of CPR chest compression metrics, e.g., compression depth, rate, release velocity, or other metrics, such as complete release from the patient's chest, some of which metrics may not be measurable, or may not be as easily or accurately measureable, without use of a flexible structure. More specifically, plot 3902 shows displacements measured using a flexible structure positioned on the chest area of the test subject and plot 3920 shows displacements measured using an accelerometer positioned on the chest area of the test subject.

Plot portions 3904 and 3922 correspond with time periods during application of chest compressions to the test subject, with no overall movement of the entire test subject, i.e., without substantial noise motion which may be indicative of noise during emergency transport. Plot 3906 and 3924 correspond with time periods during which no chest compressions are applied, but during which the test subject is provided with rapid, short vertical movements (e.g., vertical shaking type movement indicative of noise during transport), which simulates rapid, small overall movements that may be associated with, for example, transportation, e.g., driving in an ambulance or in a helicopter, movement on a crash cart, or other overall movement of the patient, such as from background vibrations from equipment or the environment, pushing or shoving of the patient in a crowded, emergency situation, etc.

Plot portions 3904 and 3922 show similar and accurate measurement of displacements associated with the providing of the chest compressions. However, plot portion 3924 shows accelerometer measurement that also reflects the substantial noise motion of the test subject which would otherwise confound measurements of CPR quality (e.g., compression depth and rate signals) due to the presence of noise motion, whereas plot portion 3906 accurately and correctly reflects the displacement of the portion of the chest of the patient, despite the presence of substantial noise motion. As such, plot portion 3924, measured by the accelerometer, appears to show rapid, large chest deformations when none are present, since the substantial noise motion represents a measurement, and displacement or movement, artifact relative to the displacement that is desired to be measured, which is only the displacement of the portion of the chest of the test subject and not overall movement of the test subject associated with the substantial noise motion. However, plot portion 3906, measured by the flexible structure, shows only very slight displacement of the chest of the patient, despite the presence of substantial noise motion. As such, it can be seen that measurement of chest compression quality parameters using the flexible structure may be similarly accurate to measurement using the accelerometer system when no potential artifact motion is present, but is able to filter out noise artifact due to substantial external motion more readily than the accelerometer system by itself.

As such, these plots provide data that clearly demonstrates an advantage of embodiments of the present disclosure that may be present in many different applications. Specifically, as described herein, displacements (and associated shape change and shape determinations) measured by a flexible structure incorporating aspects of the present disclosure inherently avoid being affected by overall noise artifact related movement of the flexible structure, or the object (e.g., the patient) on which the flexible structure is applied as well as the flexible structure, such as rotational or translational movement, even including rapid such movement and accelerations and changes in such movement (that is, artifact movement, which can include artifact displacement, of the patient or object is not captured, e.g., in deformation (which can include displacement) sensing, deformation, measurements, shape determination, or shape tracking, for example. As such, various other measurement techniques may have the disadvantage of being affected by such artifact movement, or may require correction to attempt to remove it, which may, in some cases, add complexity and reduce accuracy. By contrast, embodiments using a flexible structure inherently avoid being affected by such potential artifact movement. As such, flexible structures as described herein allow measurement of the desired parameters that allows for noise artifact movement to be filtered out or otherwise removed in the first instance, and does not require after the fact correction to attempt to remove it, potentially improving accuracy of measurement, increasing simplicity, and reducing cost. As such, embodiments described herein provide simple, accurate and efficient solutions to problems created by effects of potential artifact movement on measurements, and problems that may be created by a need to remove such effects.

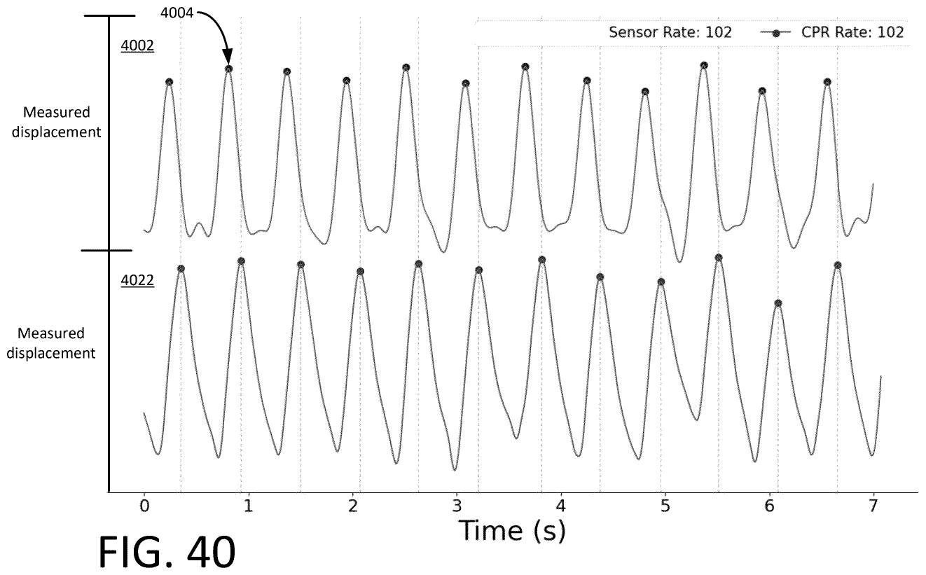

FIG. 40 illustrates two plots 4002, 4022 showing measured displacements using a flexible structure incorporating aspects of the present disclosure during the application of chest compressions to a test subject, with the overall experimental set up as in FIG. 39. Specifically, plot 4002 represents measured displacement of the portion of the chest using a flexible structure, and plot 4022 represents measured displacement of the portion of the chest using an accelerometer. Each of the illustrated peaks 4004 represent the point at which displacement changes direction, so that compression rate can be determined based on the number of peaks over time. As illustrated, both plots show similar data, and both result in an identical and accurate compression rate measurement (of 102 compressions per minute). Such data demonstrates that flexible structures incorporating aspects of the present disclosure are readily able to measure compression rate with comparable accuracy to that of accelerometer arrangements.

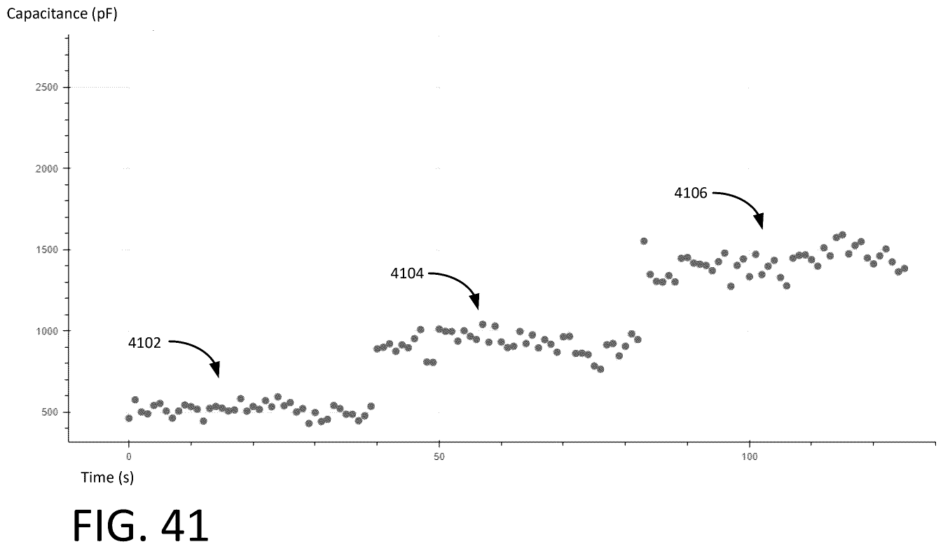

FIG. 41 illustrates a plot showing CPR chest compression depths as measured using a flexible structure, with the overall experimental set up as in FIGS. 39 and 40. Each of the clusters 4102, 4104, 4106 show correct measurement of three different target depths (targeting one 1 inch, 1.5 inches and 2 inches, respectively), illustrating the accuracy of a flexible structure in measuring chest compression metrics such as compression depth. Such data demonstrates that flexible structures incorporating aspects of the present disclosure may be able to measure compression depth with comparable accuracy to that of accelerometer arrangements.

As described herein, in various embodiments, a flexible structure may be used with manual or mechanical CPR chest compressions. In some embodiments, a flexible structure may be used along with the providing of ACD compressions.

During conventional manually applied chest compressions (without the use of an ACD device or ITD), during a positive phase of a compression cycle, when pressure is applied, positive pressure generated during a compression may help circulate blood forward to peripheral tissues of the body. During a negative phase, the natural recoil of the chest may generate a vacuum, or negative pressure, that helps draw blood back to refill, or more quickly or completely refill, the heart. This may be called preload of the heart, and may be associated with effective CPR chest compressions. An ACD device may be used to increase negative pressure during the decompression phase of a compression cycle, which may increase or speed preload and lead to more effective CPR chest compressions.

CPR chest compressions with an ACD device may be performed, for example, using a handheld device including a suction cup that adheres to the chest of a patient, which can be pulled up by the user. During the negative or decompression phase, instead of relying only on the natural recoil of the chest, the ACD device actively lifts the chest, enhancing chest wall expansion, increasing vacuum and negative pressure, thereby enhancing preload of the heart, and may thereby enhance the effectiveness of CPR chest compressions.

In some embodiments, a flexible structure may be used to detect metrics, and provide feedback or guidance, relating to ACD chest compressions and/or chest compressions performed. For example, in ACD chest compressions, the increased negative pressure may result in a more rapidly lifting chest during the release phases of a chest compressions. In some embodiments, a flexible structure may be used to track deformations that correspond with these increased chest lift rates and increased negative pressures due to decompressions. As such, the flexible structure may be used in identifying whether ACD CPR is in the positive pressure compression phase or the negative pressure decompression phase.

Additionally, in some cases, the providing of ACD can result in an unnoticed shifting of the patient, causing subsequent ACD compressions to be performed at an incorrect location on the patient's chest. A flexible structure may be used in detecting this shifting, via the detected location of the associated deformation, and in determining and providing guidance or feedback accordingly. Additionally, in some embodiments, determination or confirmation of whether a positive or negative compression phase is occurring may also be used. For example, if either a positive or negative compression phase is expected to be occurring but is determined to not be occurring, this may suggest, or further suggest, that ACD compressions are not occurring properly, or that an ACD compression system is not functioning properly. Feedback to a care provider may be determined and provided accordingly, such as a message to the care provider suggesting that the care provider check to confirm that the system is positioned or aligned correctly.

In some embodiments, a flexible structure (e.g., which may around the patient's torso, or be placed on the patient's chest and/or abdomen) incorporating aspects of the present disclosure may be used along with a band (or belt) based CPR chest compression system, where a compression band placed around the torso of the patient may be tightened to provide chest compressions. In such systems, problems may arise, which a flexible structure may be of use in detecting, so that corrective guidance can be given or correction actions taken. For example, in some instances, the compression band may be improperly positioned on the patient so that, during the providing of compressions, the band does not apply as much pressure as anticipated and desired. A flexible structure placed on the chest of the patient may be used to detect the depth of compressions, and, if the depth is less than expected, this may suggest this problem, and appropriate guidance may be determined and provided (e.g., the compression band may need to be tightened or shortened more in order to apply the correct amount of pressure). More generally, the deformations measured by a flexible structure may be used in determining both the shape and the location of the compression band, and to determine and provide guidance or feedback accordingly.

Additionally, in some cases, a compression band may become misshapen, such as too thin, which may lead to application of uneven or suboptimal pressure to the patient's chest, or may lead to application of the pressure to too small an area of the patient's chest. This may result in deformations that may be detected by a flexible structure, such as a deformation area that is smaller than expected, or deformation related edges that are sharper than expected, which may suggest these problems. Still further, in some instances, a compression band may, during the providing chest compressions, slip in an inferior direction, such that compressions are applied too far toward the patient's abdomen. A flexible structure may be used to detect such slippage, since the flexible structure can detect the location of the deformation on the patient's torso. Furthermore, in some cases, a compression band may break or slip completely off of the patient, which may result in deformation patterns, or lack thereof, that may be detected using a flexible structure.

In some embodiments, a flexible structure may be used along with a mechanical piston based CPR chest compression system. In some such embodiments, a flexible structure may be used in determining the position and movement of the piston, based on the associated deformations caused by the compressions. This may be used in correction of piston position, or feedback or guidance on such correction, if it becomes out of position relative to the patient's chest, or to provide corrections in depth of compressions. In some embodiments, signals from the flexible structure may be provided to a controller for use in closed loop control of the piston movement, for example.

In some embodiments, a flexible structure may be used along with a ramp up CPR chest compression procedure, in which the depth of chest compressions is gradually increased over a period of a number of compressions, which may result in less trauma or risk of trauma to the patient from the compressions. For example, a flexible structure may be used in determining the depth of each compression to ensure that the ramp up is accomplished correctly, or to provide guidance if otherwise.

It is to be noted that, in various embodiments, a flexible structure, or several, may be used in instead of, in addition to, or in combination with other measurement systems, such as one or several motion sensors or accelerometers, flow and pressure sensors, SpO2 sensors, or others.

As described herein, in some embodiments, a flexible structure (or several) incorporating aspects of the present disclosure may be used in detecting a patient's pulse rate based on slight body surface deformations due to pulsing blood flow, and may also be used in detecting patient conditions such as PEA and ROSC. In various embodiments, a flexible structure may be used in addition to, in combination with, or instead of, e.g., pulse oximeter/SpO2 based pulse rate detection. For example, in some embodiments, a system may utilize a flexible structure in pulse detection, and, if a pulse is detected, the system may provide feedback to a care provider to check pulse rate. Furthermore, in some embodiments, the system detect that there is cardiac electrical activity/signal, but the flexible structure may be used in determining that no pulse is detected, which conditions may indicate that PEA is present, and feedback or a suggestion may be provided to the care provider to continue providing chest compressions, for example.

In various embodiments, single cell flexible structures, or multi-cell flexible structures, may be used for various applications, including, for example, determination or tracking of CPR chest compression metrics such as rate or depth, ventilation rate and pulse or pulse waveform, among others, which may include determination or tracking of a 3D deformation, shape change or shape, or a displacement in a direction, e.g., relating to a 3D space, for example.

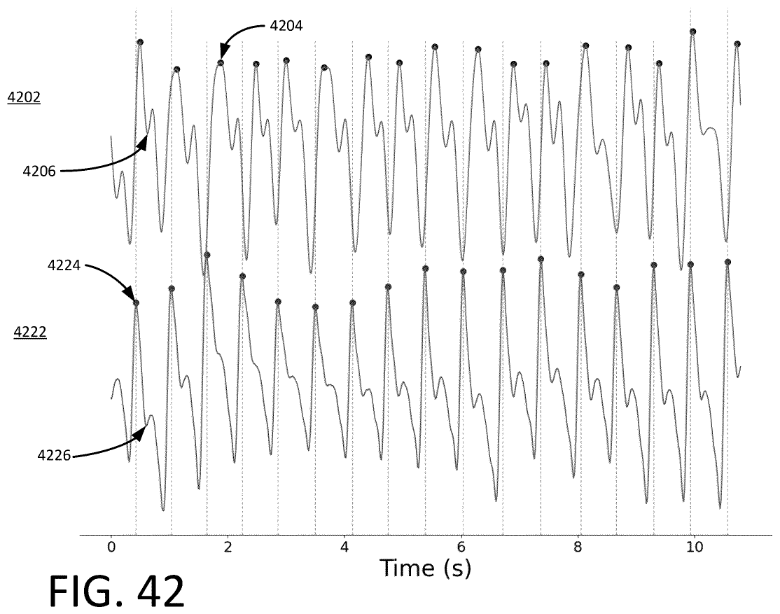

FIG. 42 illustrates two plots associated with waveforms 4202, 4222, with waveform 4202 representing measured deformations at the brachial pulse in the antecubital fossa by a flexible structure wrapped around the arm of the person in the conducted experiment, and waveform 4222 showing a pulse waveform as simultaneously measured by an SpO2 sensor placed on the tip of the person's index finger of the same limb. As can be seen, both waveforms 4202, 4222 exhibit a similar morphology and provide an identical count of heartbeats, where peaks (e.g. peaks 4204, 4224) correspond with heartbeats, and provide accurate measurement of pulse rate. Furthermore, in both waveforms, 4202, 4222, details can be seen that include dicrotic notches (e.g., dicrotic notches 4206, 4226). FIG. 42 illustrates that a flexible structure can be used to measure pulse rate and pulse waveform, e.g., as an alternative or replacement to use of pulse oximetry/photoplethysmograph/SpO2, in any number of environments and applications (e.g., hospital, out of hospital, transport, military or field environments, or others). In some embodiments, measured deformations or displacements used to determine or track pulse or pulse waveform may be in ranges, in mm, of, e.g., 0-0.01, 0.01-0.1, 0.1-0.2, 0.2-0.5, 0.5-1.0, 1.0-2.0 or 2.0-3.0.

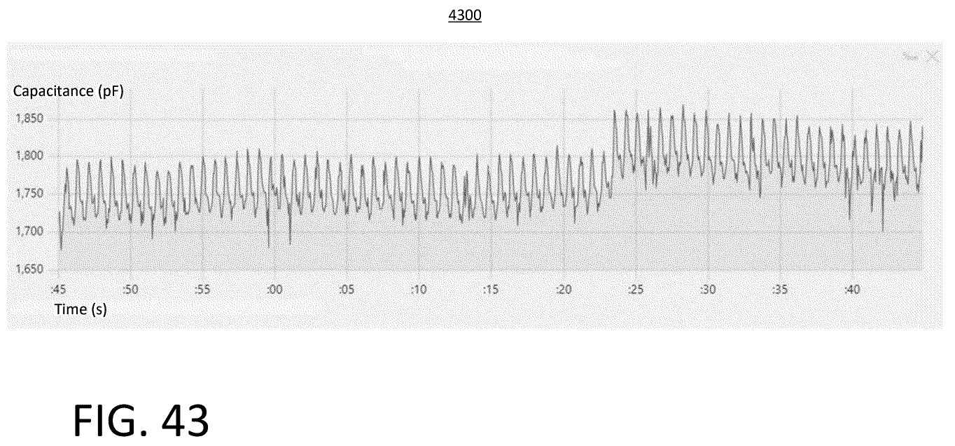

FIG. 43 illustrates another waveform 4300 associated with measurements made using the flexible structure as described in FIG. 42, providing capacitance measurements that provide accurate determination of pulse waveform. As such, FIG. 43 provides additional data showing use of a flexible structure for accurate measurement of pulse rate and pulse waveform.

As described herein, some embodiments, a flexible structure may be used during providing of mechanical or manual ventilation of a patient. As described, this may include use of one or several flexible structures, or respiratory band, that may wrap around the patient's chest, abdomen, or both, which may be used to detect ventilation rate by detecting inspiratory period (e.g., when the chest rises) and expiratory periods (e.g., when the chest falls), and may, in some embodiments, be used in addition to other methods of detection (e.g., flow sensor based detection). In some embodiments, measured chest rises or falls used in determination of ventilation rate may be in ranges including, in cm, e.g., 0.1-0.5 cm, 0.5-1.0 cm, 1.0-2.0 or 2.0-3.0 cm.

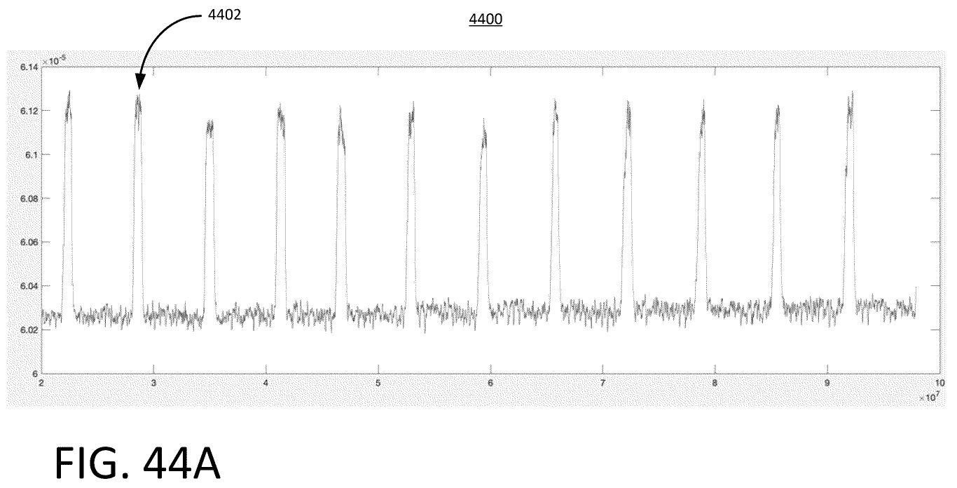

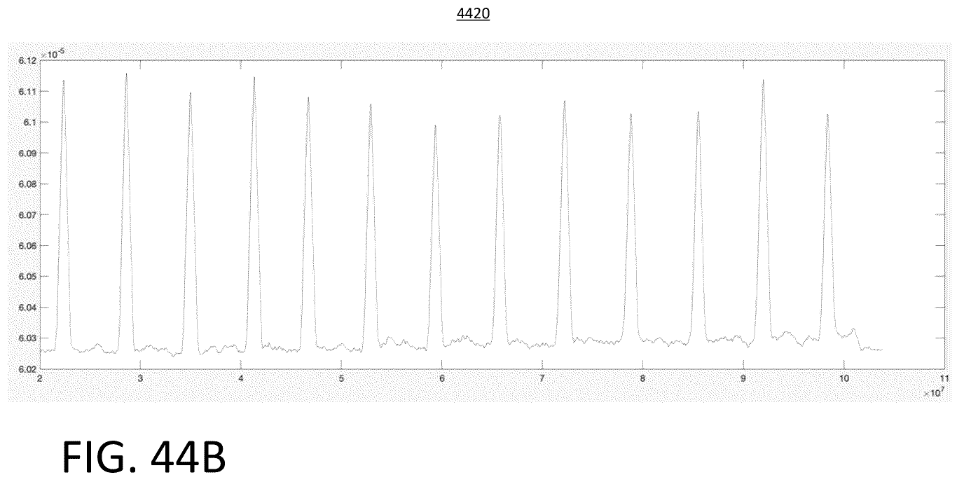

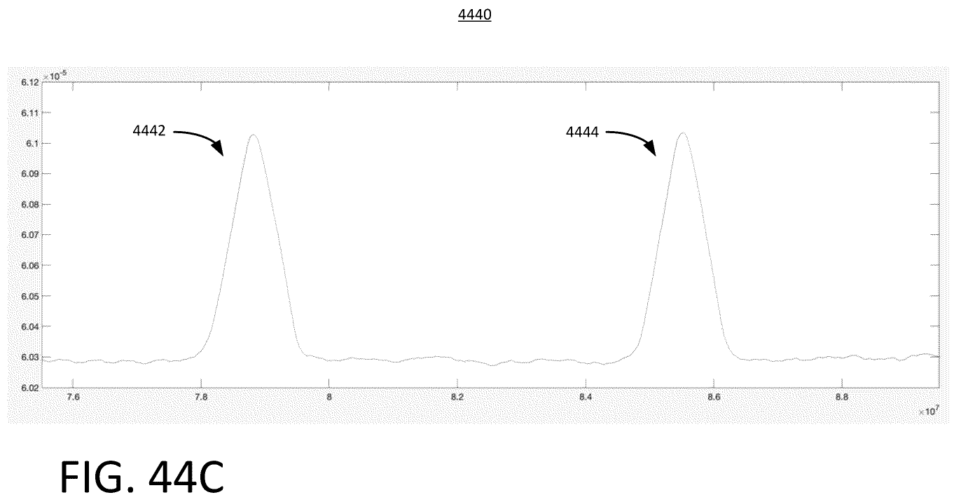

FIGS. 44A-C illustrate waveforms, determined using a flexible structure, associated with ventilations performed on a pediatric test subject. Specifically, FIG. 44A illustrates a waveform 4400 showing measured capacitances reflecting deformations) from a flexible structure during bag-valve-mask (BVM) ventilations performed on the pediatric test subject, where each peak (e.g., peak 4402) corresponds with chest lift associated with a provided breath. The flexible structure used in the experiment was a single cell flexible structure similar to the flexible structure 3802 as depicted in FIG. 38, with the flexible structure positioned such that the rectangular cell was placed left to right across the chest of the patient, FIG. 44B illustrates a waveform 4420 showing a similar waveform as that of FIG. 44A, but after algorithmic data smoothing has been applied to smooth the waveform. FIG. 44C illustrates a waveform 4440 which is a zoomed portion of waveform 4420 of FIG. 44B, zoomed in to show a time period including two particular provided breaths 4442, 4444.

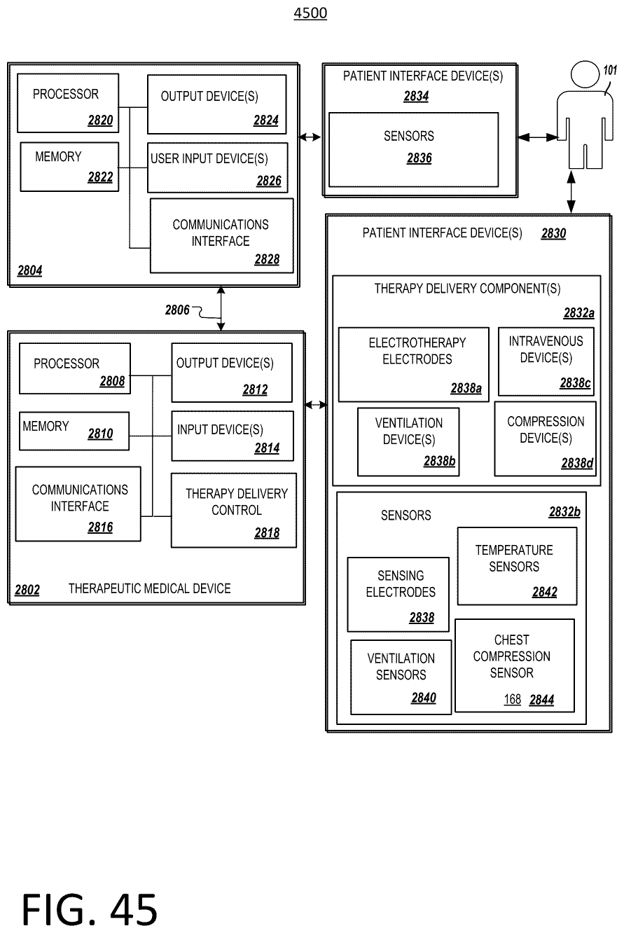

FIG. 45 provides an illustration 4500 of an example of components of various devices that can be used in accordance with embodiments of the present disclosure. The components 2808, 2810, 2812, 2814, 2816, and 2818 are communicatively coupled (directly and/or indirectly) to each other for bi-directional communication. Similarly, the components 2820, 2822, 2824, 2826, and 2828 are communicatively coupled (directly and/or indirectly) to each other for bi-directional communication.

In some implementations, the components 2808, 2810, 2816, and/or 2818 of the therapeutic medical device 2802 may be combined into one or more discrete components and components 2816 and/or 2818 may be part of the processor 2808. The processor 2808 and the memory 2810 may include and/or be coupled to associated circuitry in order to perform the functions described herein. Additionally, the components 2820, 2822, and 2828 of companion device 2804 may be combined into one or more discrete components and component 2828 may be part of the processor 2820. The processor 2820 and the memory 2821 may include and/or be coupled to associated circuitry in order to perform the functions described herein.

In some implementations, the therapeutic medical device 2802 may include the therapy delivery control module 2818. For example, the therapy delivery control module 2818 may be an electrotherapy delivery circuit that includes one or more high-voltage capacitors configured to store electrical energy for a pacing pulse or a defibrillating pulse. The electrotherapy delivery circuit may further include resistors, additional capacitors, relays and/or switches, electrical bridges such as an H-bridge (e.g., including a plurality of insulated gate bipolar transistors or IGBTs), voltage measuring components, and/or current measuring components. As another example, the therapy delivery control module 2818 may be a compression device electro-mechanical controller configured to control a mechanical compression device. As a further example, the therapy delivery control module 2818 may be an electro-mechanical controller configured to control drug delivery, temperature management, ventilation, and/or other type of therapy delivery.

The therapeutic medical device 2802 may incorporate and/or be configured to couple to one or more patient interface devices 2830. The patient interface devices 2830 may include one or more therapy delivery component(s) 2832a and one or more sensor(s) 2832b. Similarly, the companion device 2804 may be adapted for medical use and may incorporate and/or be configured to couple to one or more patient interface device(s) 2834. The patient interface device(s) 2834 may include one or more sensors 2836. The sensor(s) 2836 may be substantially as described herein with regard to the sensor(s) 2832b.

The sensor(s) 2832b and 2836 may include sensing electrodes (e.g., the sensing electrodes 2838), ventilation and/or respiration sensors (e.g., the ventilation and/or respiration sensors 2830), temperature sensors (e.g., the temperature sensor 2842), chest compression sensors (e.g., the chest compression sensor 2844), etc. In some implementations, the information obtained from the sensors 2832b and 2836 can be used to generate information displayed at the therapeutic medical device 2802 and simultaneously at the display views at companion device 2804 and described above. In one example, the sensing electrodes 2838 may include cardiac sensing electrodes. The cardiac sensing electrodes may be conductive and/or capacitive electrodes configured to measure changes in a patient's electrophysiology to measure the patient's ECG information. The sensing electrodes 2838 may further measure the transthoracic impedance and/or a heart rate of the patient. The ventilation and/or respiration sensors 2830 may include spirometry sensors, flow sensors, pressure sensors, oxygen and/or carbon dioxide sensors such as, for example, one or more of pulse oximetry sensors, oxygenation sensors (e.g., muscle oxygenation/pH), 02 gas sensors and capnography sensors, impedance sensors, and combinations thereof. The temperature sensors 2842 may include an infrared thermometer, a contact thermometer, a remote thermometer, a liquid crystal thermometer, a thermocouple, a thermistor, etc. and may measure patient temperature internally and/or externally. The chest compression sensor 2844 may include one or more motion sensors including, for example, one or more accelerometers, one or more force sensors (such as, e.g., to detect start and end of a chest compression), one or more magnetic sensors, one or more velocity sensors, one or more displacement sensors, etc. The chest compression sensor 2844 may provide one or more signals indicative of the chest motion to the therapeutic medical device 2802 via a wired and/or wireless connection. The chest compression sensor 2844 may be, for example, but not limited to, a compression puck, a smart-phone, a hand-held device, a wearable device, etc. The chest compression sensor 2844 may be configured to detect chest motion imparted by a rescuer and/or an automated chest compression device (e.g., a belt system, a piston system, etc.). The chest compression sensor 2844 may provide signals indicative of chest compression data including displacement data, velocity data, release velocity data, acceleration data, force data, compression rate data, dwell time data, hold time data, blood flow data, blood pressure data, etc. In an implementation, the defibrillation and/or pacing electrodes may include or be configured to couple to the chest compression sensor 2844.

In various implementations, the sensors 2832b and 2836 may include one or more sensor devices configured to provide sensor data that includes, for example, but not limited to ECG, blood pressure, heart rate, respiration rate, heart sounds, lung sounds, respiration sounds, end tidal CO₂, saturation of muscle oxygen (SMO₂), oxygen saturation (e.g., SpO2 and/or PaO₂), cerebral blood flow, point of care laboratory measurements (e.g., lactate, glucose, etc.), temperature, electroencephalogram (EEG) signals, brain oxygen level, tissue pH, tissue fluid levels, images and/or videos via ultrasound, laryngoscopy, and/or other medical imaging techniques, near-infrared spectroscopy, pneumography, cardiography, and/or patient movement. Images and/or videos may be two-dimensional or three-dimensional, such a various forms of ultrasound imaging.

The one or more therapy delivery components 2832a may include electrotherapy electrodes (e.g., the electrotherapy electrodes 2838a), ventilation device(s) (e.g., the ventilation devices 2838b), intravenous device(s) (e.g., the intravenous devices 2838c), compression device(s) (e.g., the compression devices 2838d), etc. For example, the electrotherapy electrodes 2838a may include defibrillation electrodes, pacing electrodes, and combinations thereof. The ventilation devices 2838b may include a tube, a mask, an abdominal and/or chest compressor (e.g., a belt, a cuirass, etc.), etc. and combinations thereof. The intravenous devices 2838c may include drug delivery devices, fluid delivery devices, and combinations thereof. The compression devices 2838d may include mechanical compression devices such as abdominal compressors, chest compressors, belts, pistons, and combinations thereof. In various implementation, the therapy delivery component(s) 2832a may be configured to provide sensor data and/or be coupled to and/or incorporate sensors. For example, the electrotherapy electrodes 2838a may provide sensor data such as transthoracic impedance, ECG, heart rate, etc. Further the electrotherapy electrodes 2838a may include and or be coupled to a chest compression sensor. As another example, the ventilation devices 2838b may be coupled to and/or incorporate flow sensors, gas species sensors (e.g., oxygen sensor, carbon dioxide sensor, etc.), etc. As a further example, the intravenous devices 2838c may be coupled to and/or incorporate temperature sensors, flow sensors, blood pressure sensors, etc. As yet another example, the compression devices 2838d may be coupled to and/or incorporate chest compression sensors, patient position sensors, etc. The therapy delivery control modules 2818 may be configured to couple to and control the therapy delivery component(s) 2832a, respectively.

The one or more sensor(s) 2832b and 2836 and/or the therapy delivery component(s) 2832a may provide sensor data. The patient data provided at the display screens of the therapeutic medical device 2802 and companion device 2804 may display the sensor data. For example, the therapeutic medical device 2802 may process signals received from the sensor(s) 2832b and/or the therapy delivery component(s) 2832a to determine the sensor data. Similarly, the companion device 2804 may process signals received from the sensor(s) 2836 and/or sensor data from the sensors 2832b received via the therapeutic medical device 2802 to determine the sensor data.

While certain embodiments have been described, these embodiments have been presented by way of example only and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

1. A system for use in providing cardiopulmonary resuscitation (CPR) chest compressions to a patient, the system comprising:
a flexible structure comprising a plurality of capacitive cells, the flexible structure configured to be positioned on at least a portion of a torso of the patient during the CPR; and
at least one computerized system, comprising at least one memory and at least one processor, communicatively coupled with the flexible structure and configured to:
receive signals associated with a plurality of capacitance values corresponding to at least a portion of the plurality of capacitive cells;
based at least in part on the received signals, estimate a change in a three dimensional shape of the flexible structure over a period of time during the providing of the CPR chest compressions to the patient; and
based at least in part on the estimated change, provide output, comprising at least one of: visual output and audio output, for use in providing corrective feedback to the care provider relating to the CPR chest compressions, the output relating to at least one parameter associated with the CPR chest compressions.

2-4. (canceled)

5. The system of claim 1, wherein some of the plurality of capacitive cells are located at a different level along a thickness of the flexible structure than other of the plurality of capacitive cells.

6. The system of claim 1, wherein the at least one computerized system is configured to estimate the change over time in the three dimensional shape of the flexible structure, wherein the change is caused at least in part by a deformation of the flexible structure.

7. (canceled)

8. The system of claim 1, wherein the flexible structure is configured to be at least one of: wrapped around the at least a portion of the torso of the patient, stretched around the at least a portion of the torso of the patient, adhered to a chest of the patient, and adhered to a chest of the patient using an adhesive.

9-16. (canceled)

17. The system of claim 1, wherein at least one computational model is used in estimating the three dimensional shape.

18. The system of claim 17, wherein the at least one computational model comprises at least one machine learning model.

19. The system of claim 18, wherein the machine learning model utilizes training data relating to the flexible structure in a plurality of deformed states, the training data comprising a set of data corresponding to each of a plurality of particular times, wherein a three dimensional shape of the flexible structure is different for each of the plurality of particular times, the set of data comprising:
capacitance values corresponding to each of at least a portion of the plurality of capacitive cells at the particular time; and
data corresponding to an actual three dimensional shape of the flexible structure at the particular time.

20-24. (canceled)

25. The system of claim 1, wherein the at least one computerized system is configured to:
obtain calibration data comprising capacitance values corresponding to the at least a portion of the plurality of capacitive cells of the flexible structure prior to the change; and
utilize the calibration data in estimating the change.

26-55. (canceled)

56. An apparatus, applicable to a portion of a surface of a patient's body, for use in providing assistance to a care provider with a medical treatment provided to the patient, the apparatus comprising:
a flexible structure configured to be applied to the portion of the surface of the patient's body; and
a plurality of capacitive cells, disposed on, or forming part of, the flexible structure, each of the plurality of capacitive cells comprising a plurality of layers, the plurality of layers comprising:
a first conductive layer;
a dielectric layer disposed over the first conductive layer; and
a second conductive layer disposed over the dielectric layer;
wherein the plurality of capacitive cells is configured for use in sending signals to be received by at least one computerized system for allowing the at least one computerized system to:
based at least in part on the received signals, estimate a change in a three dimensional shape of the flexible structure over a period of time during the medical treatment provided to the patient; and
based at least in part on the estimated change, determine, and store in the at least one memory, data for use in providing the assistance with the medical treatment.

57-60. (canceled)

61. The apparatus of claim 56, wherein at least one of: each of the first conductive layer and the second conductive layer comprises silicone and graphite, and each of the first conductive layer and the second conductive layer comprises silicone and carbon.

62. (canceled)

63. The apparatus of claim 56, wherein the flexible structure comprises a first protective layer and a second protective layer, wherein the first conductive layer is disposed over the first protective layer and wherein the second protective layer is disposed over the second conductive layer.

64. The apparatus of claim 63, wherein at least one of: each of the first protective layer and the second protective layer is a capacitive cell exterior layer, each of the first protective layer and the second protective layer is dielectric, and each of the first protective layer and the second protective layer comprises silicone.

65-66. (canceled)

67. The apparatus of claim 63, wherein at least one of: each of the first protective layer and the second protective layer comprises silicone rubber, and each of the first protective layer and the second protective layer is configured to have a greater thickness than any of the first conductive layer, the dielectric layer and the second conductive layer.

68. (canceled)

69. The apparatus of claim 63, wherein at least one of the first protective layer and the second protective layer is configured to reduce touch-based capacitance changes.

70. The apparatus of claim 56, wherein the plurality of capacitive cells forms at least one of: a geometric pattern, and a polygon based pattern.

71. The apparatus of claim 56, wherein at least one of: each of the capacitive cells has a thickness of between 0.3 and 0.7 millimeters, each of the first conductive layer and the second conductive layer has a thickness of between 30 and 70 micrometers, each of the first protective layer and the second protective layer has a thickness of between 150 and 200 micrometers, and the dielectric layer has a thickness of between 60 and 120 micrometers.

72-74. (canceled)

75. The apparatus of claim 56, wherein the plurality of capacitive cells is configured for use in sending signals to be received by at least one computerized system for allowing the at least one computerized system to:
obtain calibration data comprising capacitance values corresponding to the at least a portion of the capacitive cells of the flexible structure prior to the change; and
utilize the calibration data in estimating the change.

76. The apparatus of claim 75, wherein the calibration data is used in data noise rejection.

77. The apparatus of claim 56, wherein the plurality of capacitive cells is configured for use in sending signals to be received by at least one computerized system for allowing the at least one computerized system to:
based at least in part on the data, provide output, comprising at least one of: visual and audio output, for providing the assistance to a care provider.

78. The apparatus of claim 77, wherein the plurality of capacitive cells is configured for use in sending signals to be received by at least one computerized system for allowing the at least one computerized system to:
based at least in part on the data, provide output, comprising at least one of: visual and audio output, for providing the assistance to a care provider, wherein providing the assistance comprises providing instructions to the care provider relating to the medical treatment provided to the patient.

79. A system for use in providing assistance to a care provider with a medical treatment provided to a patient, the system comprising:
a flexible structure comprising a plurality of capacitive cells, the flexible structure configured to be positioned on a surface of a body of the patient during the medical treatment; and
at least one computerized system, comprising at least one memory and at least one processor, communicatively coupled with the flexible structure and configured to:
for each of a set of different deformed shapes of the flexible structure occurring during the medical treatment, receive signals associated with a plurality of capacitance values corresponding to at least a portion of the plurality of capacitive cells;
based at least in part on the received signals, track a three dimensional shape of the flexible structure; and
based at least in part on the tracked three dimensional shape of the flexible structure, provide output, comprising at least one of: visual output and audio output, for use in providing the assistance to the care provider with the medical treatment.

80-98. (canceled)

99. The system of claim 79, wherein the at least one computerized system is configured to:
based at least in part on the tracked three dimensional shape of the flexible structure, track a three dimensional shape of at least a portion of the surface of the body of the patient.

100-102. (canceled)

103. The system of claim 99, wherein the output relates to providing of ACD chest compressions.

104. The system of claim 99, wherein the output relates to providing of ACD chest compressions comprising use of an ITD.

105. The system of claim 99, wherein the output relates to the providing of chest compressions using at least one of: a band based chest compression system, and a piston based chest compression system.

106. The system of claim 99, wherein the output relates to a ramp up chest compression procedure.

107. (canceled)

108. The system of claim 99, wherein the at least one computerized system is configured to:
based at least in part on the tracked three dimensional shape of the flexible structure, determine that the patient is or may be in PEA.

109. The system of claim 99, wherein the at least one computerized system is configured to:
based at least in part on the tracked three dimensional shape of the flexible structure, determine that the patient is or may be in ROSC.

110. The system of claim 99, wherein the at least one computerized system is configured to track the three dimensional shape of the flexible structure such that movement of the entire flexible structure does not affect tracking of the three dimensional shape of the flexible structure.

111. The system of claim 79, wherein the at least one computerized system is configured to, based at least in part on the tracked three dimensional shape of the at least a portion of the surface of the body of the patient, provide the output, and wherein the at least one computerized system is configured to track the three dimensional shape of the at least a portion of the body of the patient such that movement of the entire flexible structure does not affect tracking of the three dimensional shape of the at least a portion of the body of the patient.

112. The system of claim 99, wherein the at least one computerized system is configured to:
based at least in part on the tracked three dimensional shape of the flexible structure, determine a pulse rate of the patient.

113. The system of claim 79, wherein the at least one computerized system is configured to, based at least in part on the tracked three dimensional shape of the at least a portion of the surface of the body of the patient, provide the output, and wherein the at least one computerized system is configured to:
based at least in part on the tracked three dimensional shape of the flexible structure, determine a pulse waveform of the patient.

114. The system of claim 99, wherein the at least one computerized system is configured to:
based at least in part on the tracked three dimensional shape of the flexible structure, determine a ventilation rate of ventilations being delivered to the patient.

115. The system of claim 99, wherein the at least one computerized system is configured to:
based at least in part on the tracked three dimensional shape of the flexible structure, determine whether an endotracheal tube that has been connected to the patient is or may be dislodged or disconnected.

116. The system of claim 99, wherein the medical treatment comprises application of a tourniquet to a portion of the body of the patient, and wherein the output relates to the application of the tourniquet.

117-147. (canceled)
